(19) United States
(12) Patent Application Publication
(10) Pub. No.: US 2014/0050999 A1
(43) Pub. Date: Feb. 20, 2014

(54) Flow Battery And Regeneration System

(71) Applicant: Ftorion, Inc., Boston, MA (US)

(72) Inventor: Yuriy Viacheslavovich Tolmachev, Boston, MA (US)

(73) Assignee: Ftorion, Inc., Boston, MA (US)

(21) Appl. No.: 13/969,597

(22) Filed: Aug. 18, 2013

Related U.S. Application Data
(60) Provisional application No. 61/684,805, filed on Aug. 19, 2012.

(51) Int. Cl. H01M 8/06

(52) U.S. Cl. CPC H01M 8/0656
USPC 429/418; 429/452

(57) ABSTRACT

Methods for generating electric power and a discharge fluid from an oxidant and a reducer using a discharge system, and regenerating an oxidant and/or the reducer from the discharge fluid using a regeneration system are provided. A discharge unit of the discharge system generates electric power and the discharge fluid by transferring electrons from a positive electrode of a 5-layer electrolyte-electrode assembly (5EEA) to an aqueous multi-electron oxidant (AMO) and from a reducer to a negative electrode of the 5EEA. The regeneration system neutralizes the discharge fluid to produce a salt form of the discharge fluid. The regeneration system electrolyzes the salt form of the discharge fluid into an intermediate oxidant in an electrolysis-disproportionation reactor and releases the reducer, while producing the AMO by disproportionating the intermediate oxidant. The regeneration system converts a salt form of the AMO into an acid form of the AMO in an ion exchange reactor.

### CROSS REFERENCE TO RELATED APPLICATIONS

This application claims the benefit of provisional patent application No. 61/684,805 titled “Fluid Battery With Water-compatible Oxidants”, filed in the United States Patent and Trademark Office on Aug. 19, 2012.

The specification of the above referenced patent application is incorporated herein by reference in its entirety.

### BACKGROUND

The first widely commercialized automobiles at the dawn of the last century were electric and powered by lead acid batteries. Lead acid batteries are currently used in cars for starting, lighting, and ignition purposes. Lead acid batteries cost, for example, about 170 dollars/kilowatt hour (kWh) and are cheaper than many other rechargeable batteries known. However, the energy content of lead acid batteries is rather low. The specific energy of lead acid batteries is, for example, about 35 watt hour (Wh)/kilogram (Kg) or about 20% of their theoretical value. This is notably reflected in the short driving range provided by the lead acid batteries, for example, of about 30 km in fully electric vehicles. A long recharge time, for example, of about 2 hours required for lead acid batteries necessitates in many applications, a cumbersome mechanical swap of a discharged battery by a charged battery.

By the year 1910, improvements in the performance of an internal combustion engine, the development of mechanical transmission, combined with a wide availability of liquid hydrocarbon fossils, resulted in the displacement of electric vehicles by gasoline vehicles in the terrestrial transportation market. Gasoline power systems provide high energy content, for example, about 4,000 Wh/kg at wheels, that is, about 500 kilometres driving range, and a quick mechanical refill. This provided gasoline power systems an advantage over batteries with solid electroactive materials (SEAM). Gasoline cars were widely used even through the oil crises of the 1970s. The oil crisis provoked a concern about the availability of hydrocarbon resources and promoted a short lasting interest in electric battery and hydrogen vehicles.

The current interest in electric cars started in 1990 with the passage of the zero-emissions vehicle mandate by the California Air Resources Board. Nickel-metal hydride batteries, commercialized around this time, were considered briefly for automotive applications. Although nickel-metal hydride batteries provided better performance than the lead acid batteries, for example, a driving range of about 60 km, a specific energy of about 60 Wh/Kg to about 90 Wh/Kg, an energy density of about 200 Wh/L−300 Wh/L, a specific power of about 200 W/kg, and an electric recharge of about 3 hours, albeit at a higher cost of about $1,000/kWh, the nickel-metal hydride batteries were as good as gasoline from the customer's perspective. Also, by the year 1990, hydrogen fuelled polymer electrolyte membrane fuel cells (PEMFCs), which were originally developed within American and Soviet space exploration programs, became the leading contender among power sources for electric vehicles. The interest in PEMFCs was due to the following factors: the perceived availability of hydrogen fuel, a high specific energy, for example, of about 33.39 kWh/Kg for the low heating value of hydrogen (H₂), and specific power of PEMFCs, for example, about 0.7 W/cm² at about 60% efficiency, about 0.35 kW/Kg and about 0.35 kW/L, a competitive system energy density, for example, about 1,000 Wh/L for a 700 bar gas, and about 1200 Wh/L for 1 atmospheric pressure (atm) liquid H₂ allowing for a 600 km driving range, as well as a good energy efficiency, for example, about 60% for PEMFCs versus about 13% for an internal combustion engine.

In the following 20 years, the idea of hydrogen economy and automotive fuel cells received a significant political and economic impetus. This political and economic impetus was justified by the concerns with the rising atmospheric carbon dioxide (CO₂) levels and an unstable supply of liquid hydrocarbons. Despite the dedicated work of many scientists and engineers worldwide, the hydrogen fuelled polymer electrolyte membrane fuel cell (PEMFC) technology did not result in a market success of electric vehicles. The reasons are as follows: to achieve practically useful power density on the positive electrode, high platinum (Pt) loading is required which increases the cost of the PEMFCs; the dissolution of a Pt catalyst at positive potentials makes the positive electrode less durable; the lack of an inexpensive, sustainable, and a clean hydrogen source; and the lack of a hydrogen manufacturing and distribution infrastructure. Hence, there is a need for a technology that avoids the macro scale infrastructure required for hydrogen production and distribution and also reduces the amount of Pt required for on-board electricity generation.

Several revolutionary developments also occurred in the field of batteries with solid electroactive materials (SEAM). The advantages of a lithium (Li) metal anode, for example, a low equivalent weight, very negative redox potential, and a small cation size, allowing for an easy intercalation into cathode materials, were realized in the early 1970s. However, the first lithium batteries had a poor cycle life since the electronically insulating surface film formed on metallic lithium leads to dendritic Li plating during recharge. In 1981, researchers from Sony Corporation demonstrated a rechargeable lithium ion battery (LIB) with a graphite intercalation cathode. This lead to the commercialization of lithium batteries with a carbon anode in portable applications, within one decade. Since LIBs have a high energy density when compared to other commercialized room temperature batteries, LIBs have been used in commercial electric vehicles since the year 2010 despite a somewhat high cost, for example, of about $400/kW.

However, fully electric vehicles, unlike plug-in hybrids, based on lithium ion batteries (LIBs) did not achieve a widespread commercial success, primarily due to a low energy content, a low driving range, and a high total cost of ownership of the batteries. For example, Nissan Leaf® of Nissan Jidosha Kabushiki Kaisha DBA Nissan Motor Co. Ltd., has a battery that weighs about 20% of the total car weight with about 200 Wh/Kg, that is, about 53% of the theoretical value, and about 230 Wh/L, and provides about 60 Km to about 100 Km driving range depending on whether the air conditioner is on or off. A larger sport utility vehicle (SUV), for example, Toyota RAV4® EV of Toyota Jidosha Kabushiki Kaisha TA Toyota Motor Corporation, also shows a similar performance. The often quoted statistics, that is, 60% of daily car trips in the United States are less than 60 Km, are also not helping sales of electric cars as most drivers need the capability to make longer trips. Apart from the low driving range, the LIBs also have a low electric recharge rate, for example, the Nissan Leaf® takes about 30 minutes for a charge of about 80% of full capacity, and the construction of a large scale battery swapping infrastructure is not justified due to the lack of a sizable LIB electric vehicle market. Also, the capital cost of the LIBs needs to be reduced in the long term, for example, from about $500/kWh to $125/kWh and from about $30/kW to $8/kW at 250 Wh/kg, 400 Wh/L, and 2 kW/kg.

According to Takeshi Uchiyamada, Toyota's Vice Chairman, “the current capabilities of electric vehicles do not meet society's needs, whether it may be the distance the cars can run, or the costs, or the long time to charge. Because of its shortcomings, that is, driving range, cost, and recharging time, the battery or fuel cell electric vehicle is not a viable replacement for most conventional cars. We need something entirely new”. The scientists at General Motors (GM) arrived at the same conclusion, that is, the battery electric vehicles based on current and targeted Li ion battery technology will be limited to small vehicle, low mileage, per-day applications due to relatively low specific energy and long recharge time constraints, and it is possible that fundamental physical limitations may prevent pure Li ion based battery electric vehicles (BEVs) from delivering the freedom of providing long trips, with intermittent quick refills, that consumers currently receive from their cars. Thus, neither fuel cells nor lithium ion batteries (LIBs) are able to provide a source of electrical energy for use in fully electric vehicles which would allow them to compete commercially with conventional gasoline internal combustion engine cars. There is a need for a solution that departs from the currently available technology and differs from others under investigation in the electric vehicle battery field. Hence, there is a need for a power source for electric vehicles that provides a longer driving range, lower total cost of ownership, and allows for a quick recharge or refill.

The history of technology teaches that if the show stopping part in any device is identified and replaced with another part, then this may change the device from a non-functional device to a functional device, though the performance in one or more parameters may have to be sacrificed. In the case of lithium batteries, the aforementioned abandonment of the metallic lithium electrode in favor of lithium intercalated into graphite resulted in about 30% decrease in the theoretical energy density but created a marketable battery with a long cycle life. Flow systems such as fuel cells (FCs) and redox flow batteries (RFBs) allow an independent scaling on energy and power, and are thus better suited for transportation than batteries with solid electroactive materials (SEAMs). Other advantages of fuel cells when compared to SEAM batteries are a higher system energy density, if the reactants are not too dilute, a quick refill time, an intrinsic fluid heat management, and a simple cell balancing. The advantages of redox flow batteries over fuel cells are: electric regeneration that does not require a construction of a new fuel distribution infrastructure, for example, a hydrogen distribution infrastructure, higher efficiency, and potentially lower cost. Conventional redox flow batteries such as vanadium redox flow batteries have a low energy density that translates into a short driving range, because the components have low solubilities and a large amount of an otherwise useless solvent which has to be carried on-board to keep the components in the fluid state. For this reason, flow batteries have been considered mostly for stationary storage applications rather than for electric vehicles.

A Massachusetts based start-up, 24M, retains the advantages of flow batteries while overcoming drawbacks of traditional solution chemistry, by developing a slurry flow battery based on the C₆—LiFePO₄ chemistry used by A123 Systems for batteries with solid electroactive materials (SEAM) or SEAM batteries. However, such a battery in an electric vehicle such as the Nissan Leaf® or the Toyota RAV4® would provide only about 90 Km to about 150 Km driving range, with and without an air conditioner, respectively, even if the battery reaches, for example, about 80% of its theoretical energy density. In other batteries, for example, binder free SEAM batteries with a soluble mediator or a soluble redox couple or metal containing ionic liquid flow batteries, and aqueous oxidant and/or protected Li metal batteries, the intrinsic energy densities of battery chemistries are also not sufficiently high for fully electric vehicle applications. Also, the cost of such batteries is likely to stay above the mid-term target of about $100/kWh and about $30/kW, or about $2,250/car with about 100 horsepower. Hence, there is an unmet need for flow batteries with higher energy content and a lower cost in order to gain market acceptance of fully electric vehicles.

Polymer electrolyte membrane (PEM) fuel cells have high power and energy density as well as a flow design which makes the PEM fuel cells well suited for automotive applications. The fundamental problems related to the slow kinetics of the oxygen electrode result in high cost and poor durability due to the necessity of high Pt loading in the case of near ambient temperature fuel cells. Hence, there is a need for a discharge flow battery that ensures a high energy density, high energy efficiency, and generates a high electric power by replacing the free oxygen from air with a high energy density and kinetically fast on-board fluid oxidant.

Flow batteries use an electrochemical power cell similar to fuel cells. Flow batteries also use fluid reactants, for example, liquid, gaseous, or suspended reactants to store energy and to generate electric power. However, instead of oxygen or air, a different oxidant or a solution of an oxidant can be employed. Due to the carrying of an on-board oxidant, the flow battery typically entails a lower system energy density than a fuel cell. The reasons for using the on-board oxidant method comprise, for example, increasing the efficiency of energy conversion, reduction in the amount of precious metal catalysts, potential to change the operating temperature of the electrochemical power cell, improved heat management, etc. When compared with batteries with solid electroactive materials (SEAM) or SEAM batteries, for example, lithium ion batteries, flow batteries offer an independent scaling of energy and power, a higher ratio of practical to theoretical energy density for systems with a sufficiently long discharge time, a possibility of quick mechanical recharge, intrinsic liquid cooling, etc. Commercialized redox flow batteries have low energy densities because of the use of redox couples with low solubilities.

For hydrogen-halogen flow batteries, in the series from fluorine (F₂) to iodine (I₂), the theoretical energy density decreases while the efficiency, cathode power, and exchange current increases. As a result, F₂ has a poor cycle efficiency, in addition to material compatibility issues, whereas I₂ has a low energy density in addition to solubility problems. Hence, only bromine (Br₂) and chlorine (Cl₂) may be of interest for transportation applications. However, the chorine cells use an expensive ruthenium (Ru) containing catalyst and provide poor energy efficiency.

The theoretical energy density of hydrogen-bromine cells is only marginally better than that of lithium-ion batteries. The theoretical energy density is lower if bromine is used as an aqueous solution with hydrogen bromide (HBr) to reduce the oxidant's cross over through membrane via the formation of Br₃⁻ anions. Hydrogen-bromine cells are therefore considered at present mostly for grid storage rather than for electric vehicles. There is a need for resolving the aforementioned TRIZ contradiction between energy density and efficiency, for example, by introducing a new dimension to the choice of oxidants, for example, by adding a second dimension of oxocompounds such as oxides and oxoacids to the one dimensional space of elements such as halogens. Although hydrogen-oxoacid flow batteries such as H₂—HNO₃ have been considered in the past, these flow batteries have poor discharge efficiency and lack the ability of electrical recharge or regeneration of the reagents. The direct electroreduction of halogen oxoacids is highly irreversible under the polymer electrolyte membrane fuel cell (PEMFC) conditions. There is a need to overcome this problem, for example, by performing a slow reduction of an oxoanion in a solution, that is, in three dimensions rather than on an electrode, that is, two dimensional.

A typical behavior associated with the electroreduction of oxoacids of halogens is the slow kinetics of an initial electrochemical reduction step of compounds with a high oxidation state of the central atom, for example, a halate into a corresponding halide, that is followed by a fast homogeneous reaction as indicated by the equations below:

XO₃⁻+6e⁻+6H⁺=X⁻+3H₂O on the electrode, slow. (1)

XO₃⁻+5X⁻+6H⁺=3X₂+3H₂O in solution, fast. (2)

X₂+2e⁻=2X⁻ on the electrode, fast. (3)

where X=Cl, Br, I.

The reverse process of oxidation of halides is generally believed to follow the same pathway. The oxidation of the iodide is much faster in an alkaline solution than in an acid and clearly shows that the reverse chemical reaction indicated by equation (2) occurs through the formation of an intermediate hypohalate via a homogeneous disproportionation:

2X₂+2OH⁻=2HXO+2X⁻ (4)

followed by another homogeneous disproportionation:

5HOX(hypohalous acid)=2X₂+XO₃⁻+H⁺+2H₂O⁻

or (4) and (5) combined

3X₂+6OH⁻=XO₃⁻+5X⁻+3H₂O

The occurrence of homogeneous disproportionation reactions (4), (5), (6) and a comproportionation reaction (2) facilitates regeneration and discharge processes in the energy cycle. The occurrence of these reactions allows for a high power, high efficiency operation based on a fast electrode reaction (X₂+2e⁻=2X⁻) while performing slower steps such as reduction of the oxoanion with the electro-generated halide in the three dimensional bulk of the solution which can accommodate a higher reaction rate than the two dimensional electrode surface. Although the use of a mediator leads in theory to reduced energy efficiency compared to a direct electrode reaction, this thermodynamic loss of energy efficiency is smaller than the kinetic loss associated with electrode over-voltage at the same power using oxidants such as oxygen or using direct electroreduction of the oxoanions.

The chemical methods of producing halogen oxoacids are used on an industrial scale. In the case of bromic acid, this chemical method consists of solution-phase disproportionation of bromine in Ba(OH)₂, followed by Ba²⁺ precipitation with sulfuric acid and by evaporation of the excess water. However, this process irreversibly consumes Ba(OH)₂, H₂SO₄ and generates BaSO₄ waste. Also, this process does not co-produce a stoichiometric amount of hydrogen, which is required for the complete energy cycle of discharge and regeneration. Thus, this precipitation route does not meet the application requirements. An alternative method for preparing 40%-50% bromic acid via the electrooxidation of aqueous bromine solutions uses a lead dioxide anode at the current density of 10-20 mA/cm² and a potential of +2.1 to +2.2 V versus a normal hydrogen electrode. Although this method is chemical and waste free, this method has a poor energy efficiency and a low throughput.

Hence, there is a long felt but unresolved need for a mechanically refillable, low cost, electrochemical flow battery that provides for a long driving range, a high energy density, and a high energy efficiency, generates high electric power at a low operational and manufacturing cost, and requires a short refill time. Moreover, there is a need for a method and a system that regenerates an oxidant and a fuel simultaneously from a discharge fluid, in stoichiometric amounts, without consumption of extra chemicals and without generating chemical waste.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The method and the discharge system disclosed herein address the above stated needs for a mechanically refillable, electrochemical flow battery that provides a high energy density and a high energy efficiency, generates high electric power at a low cost, and requires a short refill time. The method and the discharge system disclosed herein produce electric power from two chemicals, that is, a reducer fluid also referred to as a “fuel”, and an oxidant fluid comprising an aqueous multi-electron oxidant (AMO), and release one or more discharge fluids. The oxidant is an element or a compound in a reduction-oxidation reaction that receives one or more electrons from another species or from an electrode. The aqueous multi-electron oxidant (AMO) is an oxidant that, in at least one of its forms such as an acid form, has a high solubility in water, for example, over 0.5 M, and that transfers in a solution-phase redox reaction or in an electrochemical reaction more than 1 mole of electrons per 1 mole of AMO. The reducer is an element or a compound in a reduction-oxidation reaction that donates one or more electrons to another species or to an electrode. The methods and the systems disclosed herein use an aqueous multi-electron oxidant selected from oxides and oxoacids of non-metals such as halogens, for example, chlorine, bromine, and iodine. In an embodiment, the systems and the methods disclosed herein use an aqueous multi-electron oxidant selected from oxides and oxoacids of non-metals such as chacolgens, and nitrogen, in the form of gases, liquids, melts, low melting point solids, solutions or suspensions.

Moreover, the method and the regeneration system disclosed herein regenerate an aqueous multi-electron oxidant and a reducer simultaneously from a discharge fluid, in stoichiometric amounts, without consumption of extra chemicals and without generating chemical waste. As used herein, the term “discharge fluid” refers to an exhaust fluid obtained as a result of an electrochemical discharge process. In an embodiment, the method and the regeneration system disclosed herein regenerate an aqueous multi-electron oxidant and a reducer simultaneously from a discharge fluid, for example, by electrolysis, pH manipulating performed by means of an ion exchange via an orthogonal ion migration across laminar flow (OIMALF) process, and concentration performed by evaporation or reverse osmosis. As used herein, the term “laminar flow” refers to a type of fluid flow in which directions and magnitudes of fluid velocity vectors in different points within a fluid do not change randomly in time and in space. Also, as used herein, the term, “migration” refers to a movement of an electrically charged object such as an ion due to the action of an external electric field. In the OIMALF process, the vectors of the laminar flow velocity and of the electric field are not parallel and not anti-parallel. Furthermore, the methods and the systems disclosed herein facilitate halogen oxoanion/halide conversion in both directions by means of electrochemical reactions and pH-dependent homogeneous reactions. Disclosed herein is also a complete energy cycle comprising a method for generating electric power and a discharge fluid from an aqueous multi-electron oxidant and a reducer using the discharge system, and a regeneration of the aqueous multi-electron oxidant and the reducer from the discharge fluid using the regeneration system. In the methods and systems disclosed herein, redox couples that to do not involve solid reagents or products are used to overcome low energy densities of the flow batteries.

Disclosed herein is a discharge system comprising an oxidant fluid stored in an oxidant tank, a reducer fluid stored in a reducer tank, and a discharge unit. The discharge unit is also referred to as a “flow battery”. The oxidant fluid is a chemical or a mixture of chemicals that accepts electrons during a discharge process in a discharge mode of operation of the discharge unit. As used herein, the term “the discharge mode of operation” refers to a process of releasing charge or energy stored in the discharge unit in the form of electricity. The oxidant fluid comprises one or more of an aqueous multi-electron oxidant (AMO), water, other solvents, and a buffer in acid form. The other solvent is, for example, a liquid other than water. The AMO is one or a combination of an oxide of an element such as a halogen, an oxoacid of an element such as a halogen, etc. The buffer in the acid form is, for example, one or more of phosphoric acid, a dihydrogen phosphate of lithium, a dihydrogen phosphate of another cation, buffering agents described as Good's buffers, and any combination thereof, capable of maintaining pH of the oxidant fluid at a value greater than 4. In an embodiment, the buffer is in acid form during discharge with a pH≦7. The AMO can be pre-mixed with the buffer in the oxidant fluid. In an embodiment, the AMO is an oxide or an oxoacid of an element, for example, nitrogen, xenon, sulfur, etc. In another embodiment, the AMO is selected from a group consisting of a halogen compound such as a halogen oxide, a halogen oxoacid, etc., an interhalogen compound, a nitrogen compound, an oxide of nitrogen, a nitrogen oxoacid, an oxide of xenon, an oxoacid of xenon, an oxide of a chalcogen such as an oxide of sulfur, an oxide of nitrogen or another pnictogen, an oxoacid of nitrogen or another pnictogen, a volatile oxide of an element, a fluid oxide of an element, a soluble oxide of an element, a volatile oxoacid of an element, a fluid oxoacid of an element, a soluble oxoacid of an element, etc., any combination thereof.

The methods and the systems disclosed herein expand the choice of oxidants from one dimensional series of elements into a multidimensional matrix of compounds, and more specifically, into oxides of and oxoacids of a halogen, nitrogen and other pnictogens, sulfur and other chalcogens, and xenon. That is, the methods and the systems disclosed herein expand the one dimensional series of elements such as halogens into a multidimensional matrix of oxocompounds such as oxides and oxoacids. The oxide is a compound containing oxygen and another element. The halogen oxoacid is a compound having a formula HₚX_{q}Oᵣ, where X is one of multiple halogens, O is oxygen, and 1≦p, q, r≦6, for example, HBrO₃. The reagents, products, and intermediates of the halogen oxoacid reduction are either gases or liquids or are soluble in water. If the reagents and products are anions, their cross over through a cation exchange membrane is minimal. In an embodiment, the oxoacid is a compound having a formula HₚXOᵣ, where X is a halogen, 1≦p≦6, and 1≦r≦6.

In an embodiment, the aqueous multi-electron oxidant (AMO) is a nitrogen oxide having a formula NₓOₙ, where x=1 or 2 and 1≦n≦5. In another embodiment, the AMO is a nitrogen oxoacid having a formula HₖNₗOₘ, where 1≦k, l, m≦3. In another embodiment, the nitrogen oxoacid is a compound having a formula HNOₙ, where 1≦n≦3. In an embodiment, the oxoacid is a compound having a formula HₚX_{q}Oᵣ, where X is one of multiple halogens, nitrogen, other pnictogens, chalcogens, xenon, or other element, and where 1≦p, q, r≦6. In an embodiment, the AMO is chloric acid which forms an aqueous room temperature solution, for example, up to about 40% w/w. In an embodiment, the AMO is bromic acid which forms an aqueous room temperature solution, for example, up to about 55% w/w. In another embodiment, the AMO is iodic acid which forms an aqueous room temperature solution, for example, up to about 74% w/w. In another embodiment, the AMO is perchloric acid which forms an atmospheric aqueous azeotrope, for example, about 72.5% w/w. In another embodiment, the AMO is nitric acid which forms an atmospheric aqueous azeotrope with, for example, about 68.4% w/w.

The reducer fluid, also referred herein as a “fuel”, is a chemical that donates electrons during the discharge process. The reducer is, for example, hydrogen. In an embodiment, the reducer is selected from a group consisting of ammonia, hydrazine, hydroxylamine, phosphine, methane, a hydrocarbon, an alcohol such as methanol, ethanol, etc., an aldehyde, a carbohydrate, a hydride, an oxide, a sulfide, another organic and inorganic compound, or any combination thereof with each other, with water, or with another solvent. Only a hydrogen reducer can be regenerated.

The discharge unit of the discharge system comprises a stack of multiple electrolytic cells also referred to as an “electrolytic cell stack”. Each electrolytic cell comprises a 5-layer electrolyte-electrode assembly and half of a bipolar plate/1 endplate. The 5-layer electrolyte-electrode assembly is flanked on each side by a bipolar plate or an endplate. The 5-layer electrolyte-electrode assembly comprises a 3-layer electrolyte-electrode assembly flanked by a negative diffusion layer on the negative electrode side and a positive diffusion layer on the positive electrode side. The 3-layer electrolyte-electrode assembly comprises an electrolyte layer interposed between or flanked by a positive electrode layer and a negative electrode layer. The 3-layer electrolyte-electrode assembly and/or the 5-layer electrolyte-electrode assembly are herein referred to as an “electrolyte-electrode assembly”.

In an embodiment, the electrolytic cell stack is configured as a planar cell stack comprising planar electrolytic cells. The planar electrolytic cells in the planar cell stack are connected electrically in series so that the voltage of the electrolytic cell stack is the sum of the voltages of the electrolytic cells. Each planar electrolytic cell shares one bipolar plate with an adjacent planar electrolytic cell. One side of a bipolar plate contacts a positive side of one planar electrolytic cell and another side of the bipolar plate contacts a negative side of the adjacent planar electrolytic cell. The bipolar plates and the endplates are equipped with channels for delivering reagents, that is, the oxidant fluid and the reducer fluid to the electrolyte-electrode assemblies in the electrolytic cell stack and for removing the products, that is, one or more discharge fluids. The planar cell stack is further flanked by a pair of endplates. The endplates are further equipped with ports for the oxidant fluid, the reducer fluid, and the discharge fluid, and electric connections.

In an embodiment, the electrolyte layer of the electrolyte-electrode assembly is composed of a material capable of ionic conduction, for example, protonic conduction but not of electronic conduction. In another embodiment, the electrolyte layer of the electrolyte-electrode assembly is composed of an ionomer, a solid ion conductor, a solid proton conductor, or a liquid under laminar flow. The electrolyte is compatible with water, the aqueous multi-electron oxidant (AMO), the reducer, and the products. In another embodiment, the electrolyte layer of the electrolyte-electrode assembly is composed of a material selected from a group consisting of one or more proton donor groups or proton acceptor groups. In an embodiment, the electrolyte material is a cation-conductive polymer, for example, a polyperfluorosulfonic acid such as Nafion® of E. I. du Pont de Nemours and Company Corporation, Hyflon Ion of Ausimont S.R.L. Corporation, etc. In another embodiment, the electrolyte layer in the electrolyte-electrode assembly is an ionically conducting liquid retained in the pores of a solid matrix. In another embodiment, the electrolyte layer of the electrolyte-electrode assembly is composed of a material with a cationic conduction exceeding an anionic conduction of the material.

In the discharge unit, the positive electrodes of the electrolyte-electrode assemblies are supplied with the oxidant fluid containing the aqueous multi-electron oxidant and the negative electrodes of the electrolyte-electrode assemblies are supplied with the reducer fluid containing the reducer during the discharge mode of operation. The bipolar plate provides an electron pathway from one electrolytic cell in the electrolytic cell stack to the next electrolytic cell. The bipolar plates also supply reactants to the electrolyte-electrode assembly and remove the products. The endplates flank the electrolytic cell stack. The inner sides of the endplates operate in a manner similar to the bipolar plates. The endplates comprise inlet ports for adding reagents, outlet ports for removing products, and electric connections to an external electric circuit. The endplates provide electric connections and flow connections from the electrolytic cell stack to the other components of the discharge system.

During the discharge mode of operation, the reagents, that is, the oxidant fluid and the reducer fluid in the discharge system are converted into products to produce electric current through the electrolytic cell stack and through the external electric circuit. More specifically, the oxidant fluid and the reducer fluid are converted into products to produce an electric current through the external circuit and through the bipolar plates and an ionic current through the electrolyte layers. The oxidant fluid and the reducer fluid are supplied from their respective tanks which are periodically filled from an external source, for example, the regeneration system. The discharge system disclosed herein operates with an external electric circuit operably connected to the electrolytic cell stack of the discharge unit. During the discharge mode of operation, the external electric circuit connected to the discharge unit consumes the electric power generated by the discharge unit. In the discharge unit, the reducer is configured to donate the electrons to the negative electrodes, and the aqueous multi-electron oxidant (AMO) is configured to accept the electrons at the positive electrodes for producing an electric current in the external electric circuit that connects the positive endplate and the negative endplate, and for simultaneously producing an ionic current through the electrolyte layer of an electrolytic cell or the electrolyte layers of the electrolytic cells of the electrolytic cell stack of the discharge unit. In an embodiment, a solution-phase reaction facilitates one or more discharge reactions on the positive electrode of the electrolyte-electrode assembly. In an embodiment, the solution-phase reaction disclosed herein is, for example, a pH-dependent solution-phase comproportionation, a solution-phase redox catalysis, etc. As used herein, the term “comproportionation” is a redox reaction in which an element, free or in compounds, with oxidation states A and C, is converted into another substance or substances in which the element's oxidation states are B, such that A>B>C. In an embodiment, the rate of the solution-phase comproportionation depends on the pH of the solution.

The solution-phase reaction may benefit from a catalyst, a dissolved mediator, etc., to facilitate a charge transfer between the electrodes of the electrolyte-electrode assembly and the aqueous multi-electron oxidant (AMO) and the reducer. In an embodiment, a halide mediator, for example, a bromide mediator or a chloride mediator facilitates one or more discharge reactions on the positive electrode of the electrolyte-electrode assembly. For example, a redox mediator such as a halogen/halide couple facilitates a charge transfer between the positive electrode of the electrolyte-electrode assembly and the AMO. In another embodiment, multiple immobilized heterogeneous mediators, immobilized heterogeneous catalysts, homogeneous mediators, or homogeneous catalysts facilitate a charge transfer between the positive electrode of the electrolyte-electrode assembly and the AMO. In another embodiment, a catalyst selected from a group consisting of a homogeneous catalyst, a heterogeneous catalyst, a redox mediator catalyst, or any combination thereof, facilitates one or more discharge reactions on the positive electrode of the electrolyte-electrode assembly. In another embodiment, a reduced form of a homogeneous solution-phase mediator, a product of an electrode reaction, or any combination thereof accelerates a rate of discharge of the AMO during one or more discharge reactions via a solution-phase reaction. In an embodiment, a product of the discharge reaction facilitates the discharge reaction via comproportionation. In another embodiment, a catalyst, for example, ruthenium oxide (RuO₂), lead oxide, or a platinoid electrocatalyst facilitates one or more discharge reactions on the positive electrode of the electrolyte-electrode assembly. In another embodiment, a platinoid electrocatalyst facilitates one or more discharge reactions on the negative electrode of the electrolyte-electrode assembly. The discharge system stores energy in reducer and oxidant tanks or containers and produces electric power on demand using the discharge unit, for stationary, mobile, and portable devices that require electrical power.

In an embodiment, the discharge system disclosed herein operates in a regenerative mode or as a secondary flow battery. In the regenerative mode of operation, the reagents are regenerated or partially regenerated within the discharge unit, by applying a voltage of the polarity opposite to the polarity observed during the discharge mode of operation to the terminals of the external electric circuit. For example, a partial oxidant such as bromine can be regenerated from hydrobromic acid present in the discharge fluid using the discharge unit, if the discharge unit is operated under reverse polarity.

Also, disclosed herein is a regeneration system configured to regenerate the aqueous multi-electron oxidant (AMO) and the reducer in stoichiometric amounts from the discharge fluid produced by the discharge unit using electric power. The regeneration system comprises, for example, a neutralization reactor, an electrolysis-disproportionation (ED) reactor, an ion exchange reactor such as an orthogonal ion migration across laminar flow (OIMALF) reactor, two or more separation reactors, a concentrating reactor, and storage tanks such as a regenerated oxidant tank and a regenerated reducer tank for storing the regenerated oxidant fluid and the regenerated reducer fluid respectively. In an embodiment, the neutralization reactor comprises a mixing reactor. In an embodiment, the regeneration system further comprises three-way valves. In another embodiment, the regeneration system does not include three-way valves. In an embodiment, the regeneration system comprises a series of ED reactors. The ED reactor performs either electrolysis or electrolysis and a solution phase reaction, for example, disproportionation, in one or more sub-reactors. Disproportionation is a redox reaction in which an element, free or in a compound, is reduced and oxidized in the same reaction to form different products. For example, an element with an oxidation state A, not necessarily A=0, on disproportionation, is distributed between several species with different oxidation states B, C, etc., which differ from the element's initial oxidation state A, so that B>A>C.

The sub-reactors of the electrolysis-disproportionation (ED) reactor comprise, for example, an electrolysis unit or an electrolyzer and a disproportionation unit. The configuration of the electrolyzer is similar to that of an electrolytic cell or of the electrolytic cell stack of the discharge unit. The separation reactors of the regeneration system are gas-liquid separators and are used to separate gases from the liquids during a regeneration process. The ED reactor can be operated in a cyclic mode. The series of ED reactors can be operated in a cascade mode. In the cascade mode, one or a mixture of a regenerated solution and the discharge fluid passes through a cascade or a series of alternating reactors, that is, the mixing reactor and one or more positive electrodes of the ED reactor, that is, from a first mixing reactor to a first ED reactor to a second mixing reactor to a second ED reactor, and so on. The reducer and the base generated at the negative electrode of each of the ED reactors are separated in the separation reactor, where the base is returned into the mixing reactor preceding this ED reactor and the reducer is collected in a reducer container. In the cyclic mode, a regenerated solution or the discharge fluid is cycled between the mixing reactor and the ED reactor until the desired degree of conversion is achieved. An ED reactor configured for the cyclic mode has a lower capital cost but requires a longer regeneration time. The ED reactor(s) configured for the cascade mode has a higher capital cost but is capable of a faster regeneration. Multiple combinations of cyclic and cascade modes are implemented for a hardware combination that involves more than one series of neutralization reactors, ED reactors, and separation reactors of one series connected to the neutralization reactor of the same or the next series. The concentrating reactor concentrates the acid form of the aqueous multi-electron oxidant (AMO) to remove water or other solvents from a dilute fluid that enters the concentrating reactor and releases a concentrated fluid and water or another solvent.

Also, disclosed herein is a method for producing electric power from the aqueous multi-electron oxidant (AMO) and the reducer and for simultaneously generating the discharge fluid. The method disclosed herein provides the discharge system comprising the AMO, the reducer, and the discharge unit. The method for producing electric power facilitates electrochemical reactions in the discharge unit. Discharge occurs by transferring electrons from the positive electrode of the 5-layer electrolyte-electrode assembly to the AMO and from the reducer to the negative electrode of the 5-layer electrolyte-electrode assembly to produce electric power, that is, a sustainable electric current and a sustainable electric voltage in the external electric circuit connected to the terminals of the discharge unit and electric current of ions through the electrolyte layer. The discharge is facilitated on the positive electrode of the 5-layer electrolyte-electrode assembly, for example, by one or more of an electron transfer, electrolysis, electrocatalysis, a solution-phase chemical reaction, a solution-phase comproportionation, a solution-phase redox catalysis, an acid-base catalysis, and any combination thereof.

The discharge unit consumes the aqueous multi-electron oxidant (AMO) and the reducer to produce electric power and to generate the discharge fluid. The discharge fluid comprises, for example, one or more of water, an acid form of the buffer, a base form of the buffer, a halogen, a hydrogen halide, a halogen oxoacid, or any combination thereof. Since the discharge fluid coming out of the discharge unit is not water or not only water, the discharge fluid is not disposed into the surrounding environment but collected in a discharge container to be regenerated later into the reducer and the AMO.

Also, disclosed herein is a method for regenerating the aqueous multi-electron oxidant (AMO) and the reducer in stoichiometric amounts from the discharge fluid using electric power. The method disclosed herein reuses all the required chemicals in the complete discharge-regeneration cycle, does not consume stoichiometric amounts of external chemicals, and does not generate stoichiometric amounts of chemical waste. The regeneration system is capable of performing the required electrochemical and chemical reactions for the conversion of the discharge fluid from the discharge unit into the original oxidant fluid and the original reducer fluid. The regeneration system neutralizes the discharge fluid with an excess of a base form of a buffer in the neutralization reactor to produce a solution of a salt form of the discharge fluid. The regeneration system electrolyzes the solution of the salt form of the discharge fluid into an intermediate oxidant at a positive electrode in the electrolysis-disproportionation (ED) reactor. The regeneration system performs electrolytic decomposition of the discharge fluid, for example, HBr into a reducer such as H₂ and an intermediate oxidant such as Br₂. The electrolysis process releases the reducer and a base such as hydroxide MOH of the buffer's cation M⁺ at the negative electrode of the ED reactor. The reducer and the base are separated in the separation reactor. The base is sent to the first mixing reactor or the neutralization reactor to neutralize the incoming discharge fluid to produce a neutralized discharge fluid. At the positive electrode of the ED reactor, the electrolysis process releases an intermediate oxidant such as Br₂, which reacts with the excess of the base to produce the salt form of the AMO such as MBrO₃. The conversion of the intermediate oxidant, for example, bromine into the original aqueous multi-electron oxidant (AMO) in the salt form such as bromate at the positive electrode of the ED reactor can be facilitated not only by disproportionation but also by a mediated oxidation using a solution phase mediator such as a chlorine/chloride couple, or electrocatalysts such as those comprising one or more of the following: lead dioxide, ruthenium dioxide, dimensionally stable anode materials, perovskites, a conductive diamond, etc. All these methods of facilitation can be used together. In an embodiment, a certain amount of the intermediate oxidant is regenerated in the discharge unit from the discharge fluid by reversing a polarity of an electric current flowing through the discharge unit during discharge of the discharge unit.

The regeneration system further converts the AMO in the salt form such as LiBrO₃ into the AMO in the acid form such as HBrO₃ in the ion exchange reactor with a simultaneous release of stoichiometric amount of the base form of the buffer for neutralization while, in an embodiment, recycling the reducer evolved at the negative electrode and consumed at the positive electrode. The conversion of the salt form of the AMO produced at the positive electrode into the acid form of the AMO is performed via an ion exchange, for example, an electric field driven orthogonal ion migration across laminar flow (OIMALF) process in the ion exchange reactor. The OIMALF process is substantially similar to eluent suppression of ion chromatography. The conversion of the salt form of the AMO produced at the positive electrode into the acid form of the AMO is accompanied by a conversion of the base form of the buffer into an acid form of the buffer. The AMO is regenerated via an electron transfer to the positive electrode and the reducer is regenerated via an electron transfer from the negative electrode of the electrolysis-disproportionation (ED) reactor. The buffer maintains the pH of the discharge fluid in the optimal range, for example, between pH 7 and 9 for disproportionation. The buffer in the base form is selected, for example, from a group comprising an alkali metal hydroxide, an alkali metal hydrogen phosphate, an alkali metal salt of one or more of Good's buffers, phosphoric acid, a hydrogen phosphate of lithium, a lithium salt of one or more of Good's buffers, and any combination thereof.

In an embodiment, the regeneration of the aqueous multi-electron oxidant (AMO) and/or the reducer is facilitated, for example, by an electrocatalyst, a solution-phase redox mediator, a pH-dependent solution-phase disproportionation, etc., or any combination thereof. The conversion of the salt form of the AMO into the acid form of the AMO in the ion exchange reactor is facilitated by an acid, a buffer or any combination thereof. In an embodiment, a mediator such as chlorine facilitates regeneration of the AMO from the neutralized discharge fluid in the electrolysis-disproportionation (ED) reactor. The ED reactor or the ED reactors are configured to operate in one of multiple modes comprising, for example, a batch mode, a single pass mode, and a cyclic mode. If an orthogonal ion migration across laminar flow (OIMALF) reactor is used as ion exchange reactor, the regeneration system is configured to support the operation of the OIMALF reactor in a flow through mode, for example, using additional storage tanks. The OIMALF reactor is operated only in a single pass flow through mode or a cyclic flow through mode but not in the batch mode.

In other embodiments, the aqueous multi-electron oxidant (AMO) and/or the reducer are regenerated, for example, using electrolysis, an ion exchange on solids, an ion exchange in a liquid, ion exchange in the discharge fluid or in an intermediate regenerated solution, pH-dependent solution-phase disproportionation, or any combination thereof. Ion exchange in a liquid such as water with a dissolved salt form of the AMO and the dissolved salt form of the buffer is performed, for example, by an electric field driven orthogonal ion migration across laminar flow (OIMALF) process which is substantially similar to eluent suppression in anion chromatography. The ion exchange process occurs after and outside of any series of the neutralization-electrolysis-disproportionation loops. The regeneration of the AMO from the discharge fluid or from the intermediate regenerated solution comprises neutralizing an acid of the discharge fluid or the intermediate regenerated solution with a base to obtain a neutralized discharge fluid. The required base is produced, for example, at the negative electrode(s) of one or many electrolysis-disproportionation (ED) reactors. The regeneration system then converts the neutralized discharge fluid to the oxidant fluid, that is, a liquid comprising water, the AMO, and the acid form of the buffer, for example, via electrolysis, pH dependent solution phase disproportionation and orthogonal ion migration across laminar flow processes.

The reducer, for example, hydrogen, is co-produced in a stoichiometric amount with the salt form of the aqueous multi-electron oxidant (AMO) in the electrolysis-disproportionation (ED) reactor. The conversion of the salt form of the AMO into the acid form of the AMO occurs within the ion exchange reactor. In case of the ion exchange reactor being an orthogonal ion migration across laminar flow (OIMALF) reactor, the conversion by consuming electric power and by recycling the hydrogen released on the negative electrode of the ion exchange reactor and electrooxidized on the positive electrode of the ion exchange reactor. In an embodiment, the hydrogen produced in an ED reactor is flown through the flow field of the positive electrode of one or many OIMALF reactors and combined with the hydrogen produced at a negative electrode of one or many OIMALF reactors either before or after one or many OIMALF reactors. The regeneration of the reducer and the oxidant fluid by the ED-OIMALF method occurs by using an external energy input and without consumption or generation of external chemicals. Also, disclosed herein is the use of the pH-dependence of the spontaneous homogeneous disproportionation of a halogen and comproportionation of a halide and a halogen oxoanion in order to facilitate the electrode reactions on the positive electrodes during regeneration and discharge. The method disclosed herein facilitates the halogen oxoanion/halide conversion and other electrode processes involving oxoanions via pH-dependent homogeneous reactions.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1 illustrates a system for generating an electric power and a discharge fluid from an oxidant fluid and a reducer fluid using a discharge system and for regenerating an oxidant and/or a reducer from the discharge fluid using a regeneration system.

FIG. 2 exemplarily illustrates a perspective view of a dissembled single electrolytic cell of an electrolytic cell stack of a discharge unit of the discharge system and of an electrolyzer of an electrolysis-disproportionation reactor of the regeneration system.

FIG. 3 exemplarily illustrates a perspective view of a planar cell stack of the discharge unit, showing three multi-layered electrolyte-electrode assemblies, two bipolar plates, and two endplates.

FIG. 4 exemplarily illustrates a discharge and regeneration cycle, showing the discharge unit with hydrogen as an example of a reducer, an aqueous HXOₙ as an example of an aqueous multi-electron oxidant, and a regeneration system using MZ as an example of a buffer in a base form.

FIGS. 5A-5B exemplarily illustrate a table showing different reactions for electrochemical energy storage and energy conversion.

FIG. 6 exemplarily illustrates mass flows in a single electrolytic cell of an electrolytic cell stack of the discharge unit during discharge.

FIG. 7 illustrates a method for producing electric power from an aqueous multi-electron oxidant and a reducer and for simultaneously generating a discharge fluid.

FIG. 8 illustrates a method for regenerating an aqueous multi-electron oxidant and a reducer in stoichiometric amounts from a discharge fluid using electric power.

FIG. 9 exemplarily illustrates a negative-ion electrospray ionization-mass spectrometry spectrum of a 0.5M sodium phosphate pH 7.0 buffer solution with 50 mM of Br₂ added.

FIGS. 10A-10B exemplary illustrate an electrolysis-disproportionation-orthogonal ion migration across laminar flow method for regenerating an aqueous multi-electron oxidant (HXO₃) and a reducer (H₂) from a discharge fluid (HX+H₂O) with MOH as a base.

FIGS. 11A-11B exemplary illustrate a cyclic operation of an electrolysis-disproportionation reactor with bromic acid as an aqueous multi-electron oxidant and lithium hydrogen phosphate as a base form of a buffer.

FIG. 12 exemplarily illustrates calculated and experimentally measured limiting currents on a rotating disk electrode, showing an electroreduction of bromine generated from bromate and bromide in aqueous solutions of bromic acid of various concentrations.

FIG. 13 exemplary illustrates a graphical representation of a power-voltage curve calculated for a H₂-50% w/w HBrO₃ discharge flow battery and measured with a glassy carbon rotating disk electrode, with a platinum gauze electrode and a corresponding curve for a commercial proton exchange membrane fuel cell running on hydrogen and air.

FIGS. 14A-14G exemplarily illustrate graphical representations showing a comparison of three on-board power sources at a nominal power of 130 kW: a gasoline-internal combustion engine, a lithium ion battery, and an H₂-aqueous multi-electron oxidant discharge unit as well as the targets of the Advanced Research Projects Agency-Energy.

### DETAILED DESCRIPTION OF THE INVENTION

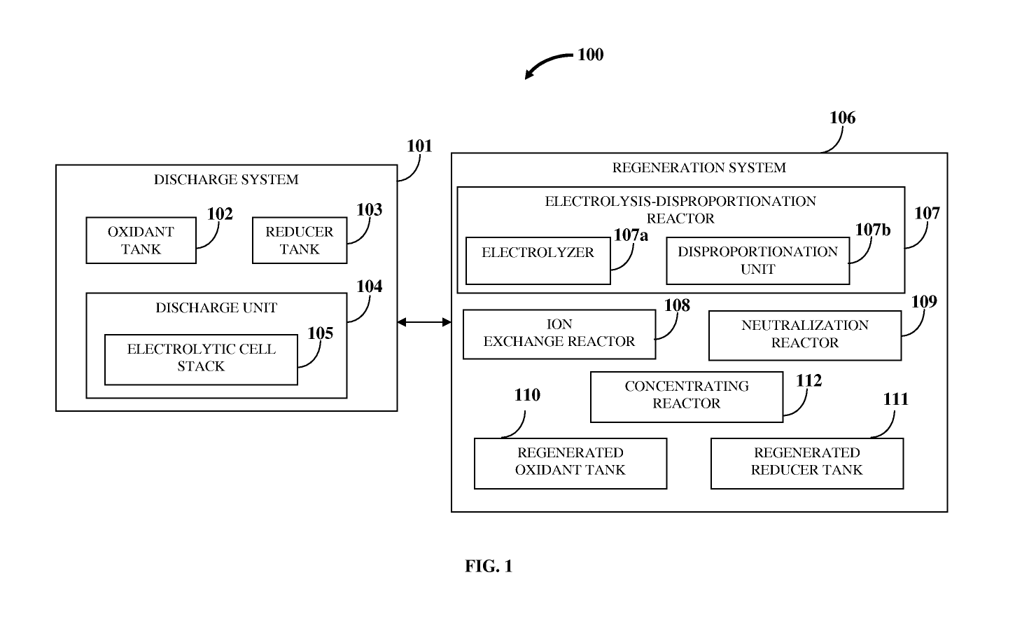

FIG. 1 illustrates a system 100 for generating an electric power and a discharge fluid from an oxidant fluid and a reducer fluid using a discharge system 101 and for regenerating an oxidant and/or a reducer from the discharge fluid using a regeneration system 106. The oxidant fluid is a chemical or a mixture of chemicals that accepts electrons during a discharge process in a discharge mode of operation of a discharge unit 104 of the discharge system 101. As used herein, the term “the discharge mode of operation” refers to a process of releasing charge or energy stored in the discharge unit 104 in the form of electricity. The discharge unit 104 disclosed herein is also referred to as a “flow battery”. The oxidant fluid comprises one or more of an aqueous multi-electron oxidant (AMO), water, other solvents, and a buffer in acid form. The other solvent is, for example, a liquid other than water. The reducer fluid, also referred herein as a “fuel”, is a chemical that donates electrons during the discharge process. The discharge fluid is an exhaust fluid obtained as a result of an electrochemical discharge process.

The system 100 disclosed herein comprises the discharge system 101 and the regeneration system 106. The discharge system 101 disclosed herein comprises an oxidant tank 102 containing an aqueous multi-electron oxidant (AMO), a reducer tank 103 containing a reducer, and a discharge unit 104. The AMO is a chemical that accepts electrons from an electrode during the electrochemical discharge process and acts as an oxidizing agent. The reducer is a chemical that donates electrons to an electrode during the electrochemical discharge process and acts as a reducing agent. The discharge system, 101 disclosed herein is similar to a fuel cell system. Unlike conventional fuel cell systems that carry only a reducer, the discharge system 101 disclosed herein carries both the reducer and the AMO in reducer tanks 103 and oxidant tanks 102 respectively. The discharge unit 104 disclosed herein is also referred to as a “flow battery” and is similar to a redox flow battery. Unlike conventional redox flow batteries, the discharge system 101 disclosed herein carries a minimal amount of a solvent and thus provides a higher energy density. The AMO and the reducer are stored in reagent containers or supplied via multiple oxidant tanks 102 and reducer tanks 103 respectively.

The aqueous multi-electron oxidant (AMO) is an oxidant that, in at least one of its forms such as an acid form, has a high solubility in water, for example, over 0.5 M, and that transfers in a solution-phase redox reaction or in an electrochemical reaction more than 1 mole of electrons per 1 mole of the AMO. The AMO comprises one or more of halogens, halogen oxoacids, water, and an acid form of a buffer. The AMO is one or more of an oxide of an element such as a halogen, an oxoacid of an element such as a halogen oxoacid. The halogen is, for example, one or more of chlorine, bromine, and iodine. In the energy cycle disclosed herein, the AMO is present in the charged oxidant fluid along with water and a buffer in an acid form. The base form of the buffer in the acid form is used to maintain pH of the AMO at a value greater than 7, while providing sufficient solubility that is >0.1M for the salt form of the AMO. The buffer is chemically compatible with the AMO, the intermediate oxidant, the discharge fluid, etc. The buffer in the base form is, for example, one or more of water with an OH⁻ base, a dihydrogen phosphate of a cation, one of a buffering agent described as Good's buffers in lithium or other forms, etc. Good's buffers are twenty buffering agents for biochemical and biological research selected and described by Norman Good et al. The cation is one or more of lithium (Li⁺), other alkali metals, organic nitrogen bases, quaternary nitrogen cations, quaternary phosphorous cations, etc. The AMO can be pre-mixed with the buffer. In an embodiment, the AMO is an oxide or an oxoacid of an element, for example, nitrogen, xenon, sulfur, etc. In another embodiment, the AMO is selected from a group consisting of, for example, a nitrogen compound, a halogen compound such as a halogen oxide, a halogen oxoacid, etc., an interhalogen compound, an oxide of nitrogen, a nitrogen oxoacid, an oxide of xenon, an oxoacid of xenon, an oxide of sulfur, an oxoacid of sulfur, an oxide of a chalcogen, an oxoacid of a chalcogen, an oxide of a pnictogen, an oxoacid of a pnictogen, a volatile oxide of an element, a fluid oxide of an element, a soluble oxide of an element, a volatile oxoacid of an element, a fluid oxoacid of an element, a soluble oxoacid of an element, and any combination thereof.

The oxide is a compound having a formula XₘOₙ, where X is one or more chemical elements, and where O is oxygen, and 1≦m≦2 and 1≦n≦7. For example, the aqueous multi-electron oxidant (AMO) is a halogen oxide having a formula XₘOₙ, where X is one of multiple halogens, O is oxygen, and 1≦m≦2, and 1≦n≦7. The oxoacid is a compound having a formula HₚX_{q}Oᵣ, where X is one of multiple halogens, nitrogen, chalcogens, xenon, or other element, and 1≦p, q, r≦6. In an example, the halogen oxoacid is a compound having a formula HₚX_{q}Oᵣ, where X is one of multiple halogens, O is oxygen, and 1≦p, q, r≦6 such as HBrO₃. The reagents, products, and intermediaries of the halogen oxoacid reduction are either gases, liquids or are soluble in water. If the reagents and products are anions, their cross over through a cation exchange membrane is minimal. In an embodiment, the oxoacid is a compound having a formula HₚXOᵣ, where X is a halogen, H is hydrogen, O is oxygen, 1<p<6, and 1<r<6. In an embodiment, the AMO is a nitrogen oxide having a formula N_{X}Oₙ, where x=1 or 2 and 1≦n≦5. In another embodiment, the AMO is a nitrogen oxoacid having a formula HₖNₗOₘ, where H is hydrogen, N is nitrogen, O is oxygen, and 1≦k, l, m≦3. In another embodiment, the AMO is a nitrogen oxoacid having a formula HNOₙ, where H is hydrogen, N is nitrogen, O is oxygen, and 1<n<3. In another embodiment, the AMO is chloric acid which forms a stable aqueous room temperature solution, for example, up to about 40% w/w. Chloric acid can be used, for example, for military and aerospace applications. In another embodiment, the AMO is bromic acid (HBrO₃) which forms a stable aqueous room temperature solution, for example, up to about 55% w/w. Bromic acid is used for a regenerative cycle, for example, in automotive applications. In another embodiment, the AMO is iodic acid which forms a stable aqueous room temperature solution, for example, up to about 74% w/w. In another embodiment, the AMO is nitric acid which forms an atmospheric aqueous azeotrope with, for example, about 68.4% w/w. The AMO can be used as an aqueous or non-aqueous solution. Other examples of the AMO are hypochlorous acid, hypobromous acid, perchloric acid, perbromic acid, periodic acid, etc.

In an embodiment, alternative high energy oxidants rather than oxygen or air are used with the discharge unit 104. The oxygen from air used in fuel cells is replaced with a high energy density and kinetically fast fluid oxidant which is stored in the oxidant container or the oxidant tank 102. The reducer is, for example, hydrogen. Only a hydrogen reducer can be regenerated. In an embodiment, the reducer is selected from a group consisting of, for example, ammonia, hydrazine, hydroxylamine, phosphine, methane, a hydrocarbon, an alcohol such as methanol, ethanol, etc., an aldehyde, a carbohydrate, a hydride, an oxide, a chalcogenide, another organic and inorganic compound and any combination thereof. The oxide is, for example, carbon monoxide (CO), nitrous oxide (N₂O), nitric oxide (NO), sulfur dioxide (SO₂), etc.

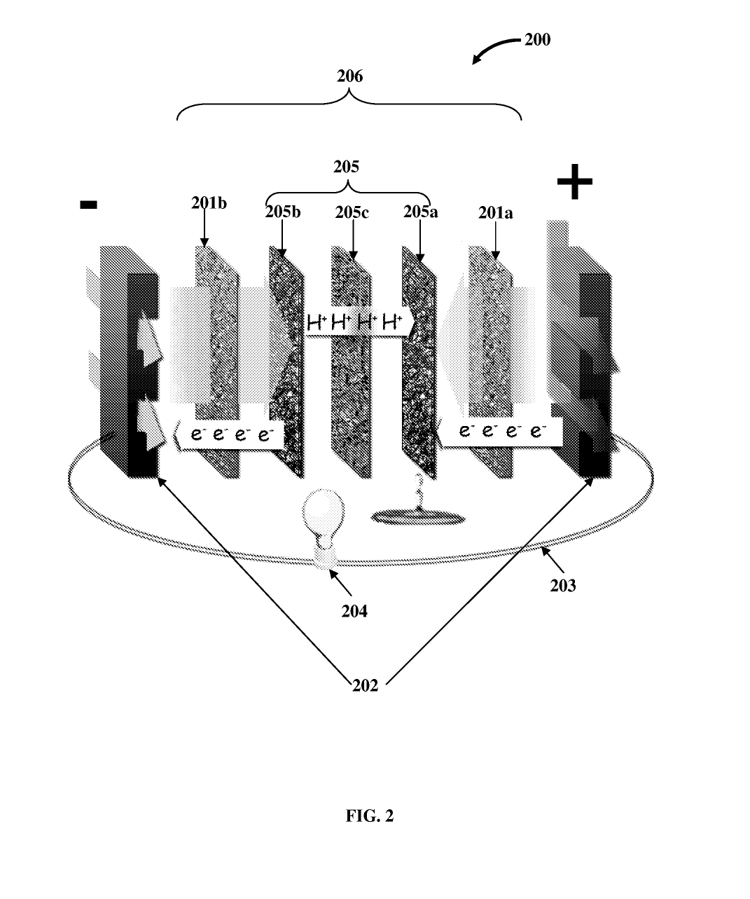

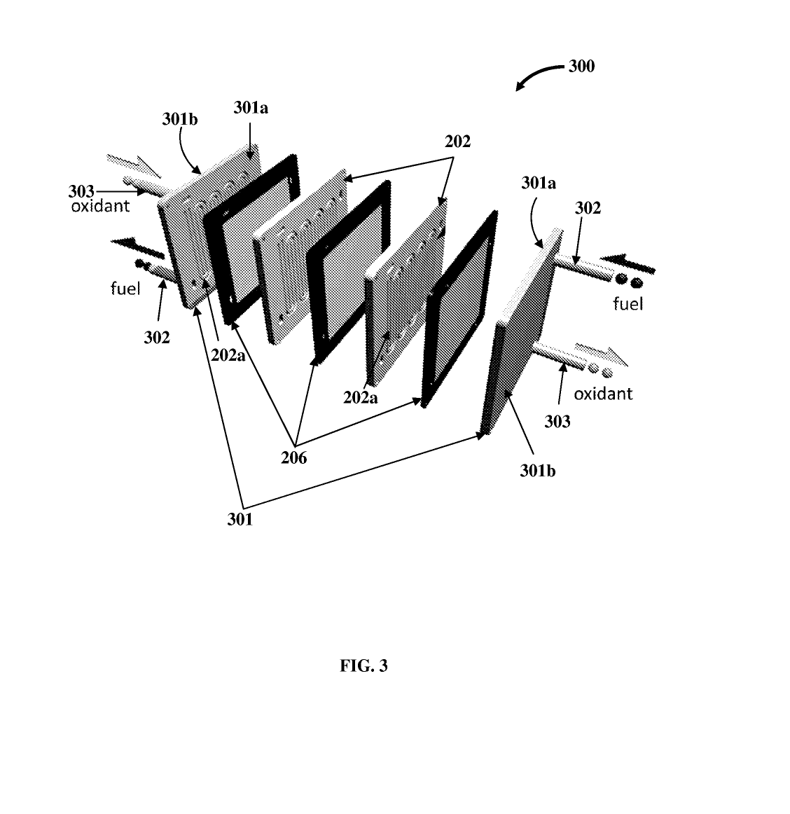

The discharge unit 104 of the discharge system 101 comprises an electrolytic cell stack 105. The electrolytic cell stack 105 comprises multiple electrolytic cells. Each electrolytic cell 200 comprises a 5-layer electrolyte-electrode assembly 206 exemplarily illustrated in FIG. 2. The 5-layer electrolyte-electrode assembly 206 comprises a 3-layer electrolyte-electrode assembly 205 flanked by two diffusion layers 201a and 201b exemplarily illustrated in FIG. 2. The 3-layer electrolyte-electrode assembly 205 comprises a positive electrode 205a, a negative electrode 205b, and an electrolyte layer 205c interposed between the positive electrode 205a and the negative electrode 205b. The positive electrode 205a and the negative electrode 205b are herein collectively referred to as “electrodes”. The term “electrode” refers to an electronic conductor or a mixed electron-ion conductor, the surface of which is in contact with an ionically conducting medium. The 3-layer electrolyte-electrode assembly 205 is flanked on each side by a positive diffusion layer 201a on the positive side and a negative diffusion layer 201b on the negative side forming the 5-layer electrolyte-electrode assembly 206. The 5-layer electrolyte-electrode assembly 206 is flanked on each side by a bipolar plate 202 or an endplate 301, exemplarily illustrated in FIG. 3. The electrolytic cell stack 105 with the oxidant tank 102, the reducer tank 103, a discharge fluid tank (not shown), and connecting lines form the discharge unit 104. In an embodiment, the discharge unit 104 comprises the electrolytic cell stack 105, an enclosure, electric leads, gas hoses and/or liquid hoses, and storage tanks. In an embodiment, the electrolytic cell stack 105 is configured as a planar cell stack 300 exemplarily illustrated in FIG. 3, comprising electrolytic cells 200 exemplarily illustrated in FIG. 2.

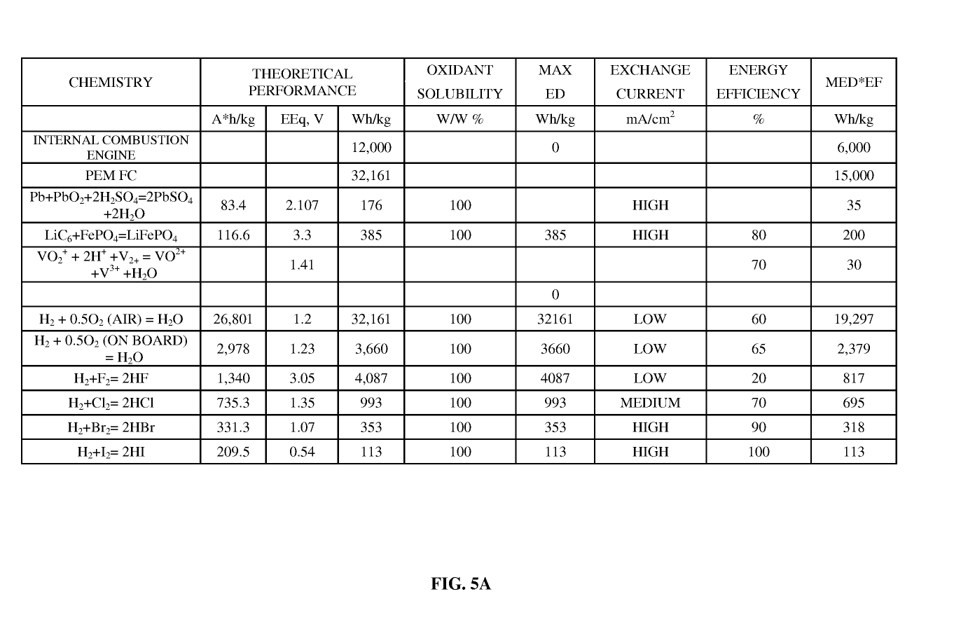

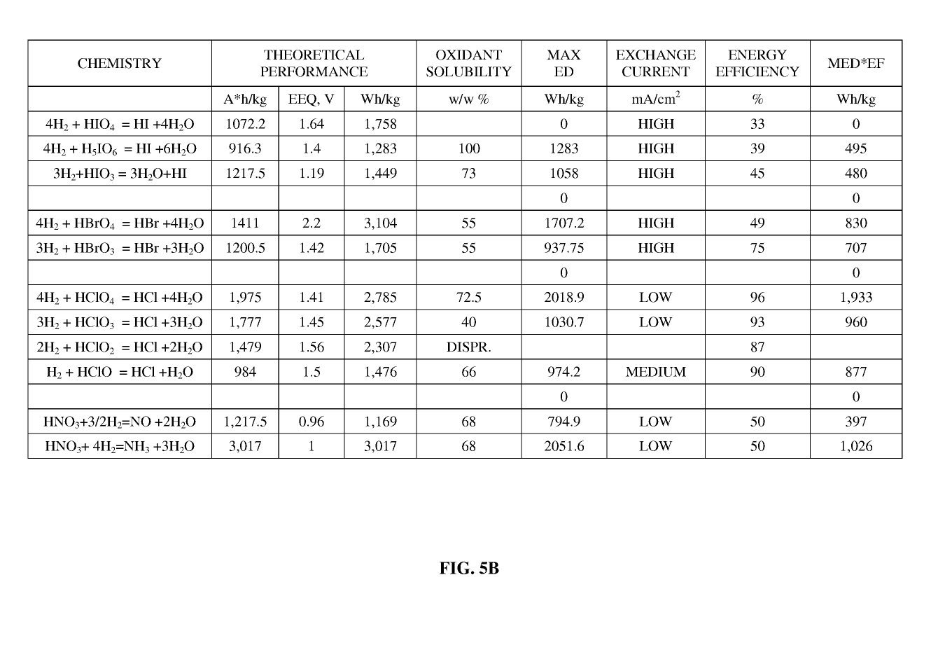

The theoretical single cell voltages and tanks' energy densities of the discharge unit 104 using various combinations of reducers and aqueous multi-electron oxidants are exemplarily illustrated in FIGS. 5A-5B. The halogens, the halogen oxoacids, and discharge products, for example, hydrogen halides and water are present as liquids, gases, or liquid solutions, thereby simplifying mass transport processes in the discharge system 101 and the regeneration system 106.

The chemistry of the oxides and oxoacids of halogens, of chalcogens, and of pnictogens may pose problems such as disproportionation of lower oxides and oxoacids, and precipitation of solid phases. Disproportionation is a redox reaction in which an element, free or in a compound, is reduced and oxidized in the same reaction to form different products. For example, an element with an oxidation state A, not necessarily A=0, on disproportionation is distributed between several species with different oxidation states B, C, etc., which differ from the element's initial oxidation state A, so that B>A>C. For example, the formation of I₂ may result in phase-segregation such as pore blocking and manifold blocking, when the temperature (T) is low, for example, for iodine below its melting point of about 114° C. To keep all the compounds, for example, I₂, in a fluid state, T>120° C. may be desired. The high temperature also benefits ionic conductivity, reaction kinetics, and the rate of heat rejection. However, other factors, for example, startup time, materials corrosion, and pressure limits of the seals may favor a lower temperature for operation, for example, about 60° C. Since the discharge system 101 disclosed herein comprising the oxidant tank 102 and the reducer tank 103, and a power unit with the electrolytic cell stack 105 can be enclosed, the operation of the discharge unit 104 at such elevated temperatures and/or pressures is relatively easier than in the case of regular fuel cells that use O₂ from air.

The fast kinetics on the positive electrode 205a such as bromine-bromide reactions, assures high power density and efficiency of the discharge unit 104 as well as the possibility of electric recharge which conventional fuel cells lack. Aqueous multi-electron oxidants (AMOs) with high energy content, for example, above 400 watt-hour (Wh)/kilogram (kg) and above 200 Wh/litre (L) are used to ensure a driving range of about 200-300 kilometres or more. Although the required energy densities can be achieved with many highly soluble or fluid in the pure state and multi-electron redox couples, for example, nitric acid, the requirements for fast reversible kinetics and high faradaic efficiency of both electroreduction and electrooxidation on the positive electrode 205a rules out most of such oxidants. The required AMOs must assure that the reagents, products, and intermediates of the reduction of the AMOs are gases, liquids, or are highly soluble and compatible with the entire group consisting of water electrolyte layer materials, electrode materials, and all other materials that come in contact with the oxidant fluid, the discharge fluid, and the reducer. Also, the reagents and the products of the process of reduction or electroreduction of the AMOs can be anions which provide an additional benefit of a reduced crossover if a cation exchange membrane is used as the electrolyte layer 205c.

In an embodiment, the discharge unit 104 disclosed herein operates in the discharge mode. In the discharge mode of operation, the discharge unit 104 produces the electric power in an external electric circuit 203, exemplarily illustrated in FIG. 2, when supplied with the reducer and the aqueous multi-electron oxidant (AMO) from external reducer tanks 103 and oxidant tanks 102 respectively, that can be periodically refilled by pumping the reducer and the AMO from a refueling station or multiple reagent sources into their respective reagent containers or tanks 103 and 102.

In an embodiment, the discharge unit 104 operates in a regenerative mode. In the regenerative mode of operation, the discharge unit 104 produces an intermediate reducer and an intermediate oxidant which may or may not be the same as the reducer and the aqueous multi-electron oxidant (AMO) used during the discharge. The discharge unit 104 operating in the regenerative mode, also referred to as an electric charge mode or an electric recharge mode produces an oxidant, for example, a halogen or a halogen compound, and the reducer, for example, hydrogen by producing a sustainable electric current in an external load 204, exemplarily illustrated in FIG. 2, and the discharge products in the discharge fluid, for example, hydrogen halides. The method of regeneration uses, in combination with other steps or by itself, electrolysis, that is, with a consumption of electric power. In the regenerative mode or the electric charge mode of operation of the discharge unit 104, the reducer or the intermediate reducer is produced on the negative electrode 205b, and the AMO or the intermediate oxidant is generated on the positive electrode 205a, when the electric current is forced through the electrodes 205a and 205b of the discharge unit 104 in a direction opposite to the direction of the electric current during the discharge mode of operation, provided that proper chemicals, for example, the discharge products are supplied to the respective electrodes 205a and 205b.

In an embodiment, a solution-phase reaction facilitates one or more discharge reactions on the positive electrode 205a of the electrolyte-electrode assembly 205. In an embodiment, the solution-phase reaction disclosed herein is, for example, a pH-dependent solution-phase comproportionation, a solution-phase redox catalysis, etc. Comproportionation is a redox reaction in which an element, free or in compounds, with oxidation states A and C is converted into another substance or substances in which the element's oxidation states are B, such that A>B>C. In an embodiment, the rate of the solution-phase comproportionation depends on the pH of the solution. The solution-phase reaction requires a catalyst such as an electrocatalyst, a dissolved mediator, etc., to facilitate a charge transfer between the electrodes 205a and 205b of the electrolyte-electrode assembly 205 and the aqueous multi-electron oxidant (AMO) and the reducer.

In an embodiment, a dissolved mediator facilitates a charge transfer between the positive electrodes 205a of the electrolyte-electrode assemblies 205 and the aqueous multi-electron oxidant (AMO). In another embodiment, a redox mediator facilitates a charge transfer between the positive electrodes 205a of the electrolyte-electrode assemblies 205 and the AMO. The redox mediator is a halogen/halide couple, for example, Cl₂/Cl⁻. In another embodiment, a chloride mediator facilitates one or more discharge or regeneration reactions on the positive electrode 205a of the electrolyte-electrode assembly 205. In another embodiment, one or more of multiple immobilized heterogeneous mediators, immobilized heterogeneous catalysts, homogeneous mediators, or homogeneous catalysts facilitate a charge transfer between the positive electrodes 205a of the electrolyte-electrode assemblies 205 and the oxidant fluid. In another embodiment, a catalyst selected from a group consisting of, for example, a homogeneous catalyst, a heterogeneous catalyst, a redox mediator catalyst, or a combination thereof, facilitates one or more discharge or charge reactions on the positive electrodes 205a of the electrolyte-electrode assemblies 205. In another embodiment, a reduced form of a homogeneous solution-phase mediator, a product of an electrode reaction, or any combination thereof, accelerates a rate of discharge during one or more discharge reactions via a solution-phase comproportionation, which may or may not be pH-dependent. For example, pH-dependent solution-phase comproportionation of the AMO with a final product of a reduction of the AMO accelerates the rate of discharge of the discharge unit 104. In another embodiment, a catalyst, for example, lead oxide, ruthenium oxide (RuO₂), or a platinoid electrocatalyst facilitates one or more discharge reactions on the positive electrode 205a of the electrolyte-electrode assembly 205. In another embodiment, a platinoid electrocatalyst facilitates one or more discharge reactions on the negative electrode 205b of the electrolyte-electrode assembly 205.

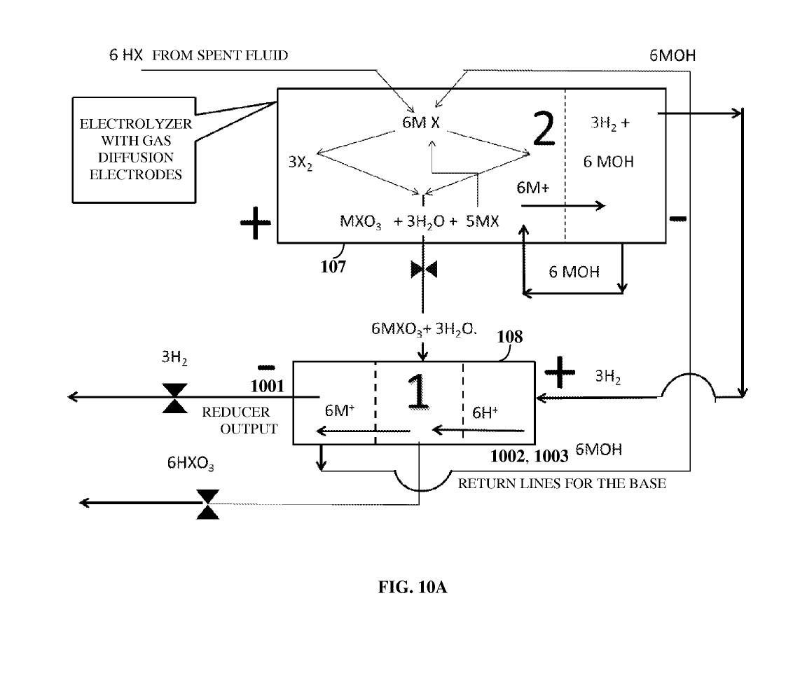

The regeneration system 106 of the system 100 disclosed herein is configured to regenerate the aqueous multi-electron oxidant (AMO) and the reducer from the discharge fluid produced by the discharge unit 104. The regeneration system 106 comprises, for example, an electrolysis-disproportionation (ED) reactor 107, an ion exchange reactor 108 such as an orthogonal ion migration across laminar flow (OIMALF) reactor, a neutralization reactor 109, a concentrating reactor 112, multiple separation reactors 1006 and 1007 exemplarily illustrated in FIG. 10B, storage tanks such as a regenerated oxidant tank 110 and a regenerated reducer tank 111. The ED reactor 107 comprises sub-reactors, for example, an electrolysis unit or an electrolyzer 107a and a disproportionation unit 107b which can be configured in one ED reactor 107. The configuration of the electrolyzer 107a of the ED reactor 107 is similar to that of an electrolytic cell 200 of the electrolytic cell stack 105 of the discharge unit 104 exemplarily illustrated in FIG. 2. In an embodiment, the electrolyzer 107a and the disproportionation unit 107b as well as the neutralization reactor 109 are physically combined in the same hardware.

The neutralization reactor 109 is configured to neutralize the discharge fluid, for example, hydrogen halide produced by the discharge unit 104 with an excess of a base form of a buffer to produce a solution of a salt form of the discharge fluid. In an embodiment, the neutralization reactor 109 comprises a mixing reactor. The electrolysis-disproportionation (ED) reactor 107 is configured to electrolyze the solution of the salt form of the discharge fluid into an intermediate oxidant such as a halogen at a positive electrode of the ED reactor 107 accompanied by a release of the reducer such as hydrogen and a base form of the buffer at a negative electrode of the ED reactor 107, while producing a salt form of the aqueous multi-electron oxidant (AMO) at the positive electrode via disproportionation of the intermediate oxidant evolving at the positive electrode with an excess of the base form of the buffer, and simultaneously releasing a stoichiometric amount of the reducer and the base form of the buffer for neutralization. The ED reactor 107 can be configured to operate, for example, in a batch mode, as exemplarily illustrated in FIG. 10A, a single pass flow-through cascade mode, and in a multi-pass cyclic mode, as exemplarily illustrated in FIG. 10B.

The ED reactor 107 is used in series with the ion exchange reactor 108. The ion exchange reactor 108 is configured to convert the aqueous multi-electron oxidant (AMO) in a salt form such as halate into an acid form of the AMO such as a halic acid. The storage tanks, for example, the regenerated oxidant tank 110, the regenerated reducer tank 111, and a buffer tank (not shown) are used to store the regenerated oxidant, the regenerated reducer, and the buffer respectively. The separation reactors 1006 and 1007, exemplarily illustrated in FIG. 10B, are gas-liquid separators and are used to separate gases from the liquids during the regeneration process.

The electrolysis-disproportionation (ED) reactor 107 can be operated in a cyclic mode or in a cascade mode. In the cyclic mode, the regenerated solution or the discharge fluid is cycled between a mixing reactor of the neutralization reactor 109, a three-way valve 1004, and another three-way valve 1005 exemplarily illustrated in FIG. 10B, through the ED reactor 107. In the cascade mode, the regenerated solution flows through a cascade (not shown) of functionally identical mixing reactors of the neutralization reactor 109 and ED reactors 107, and three-way valves 1004 and 1005. An ED reactor 107 configured for the cyclic mode has a lower upfront cost but requires a longer regeneration time. The ED reactor 107 configured for the cascade mode has a higher upfront cost but is capable of a faster regeneration.

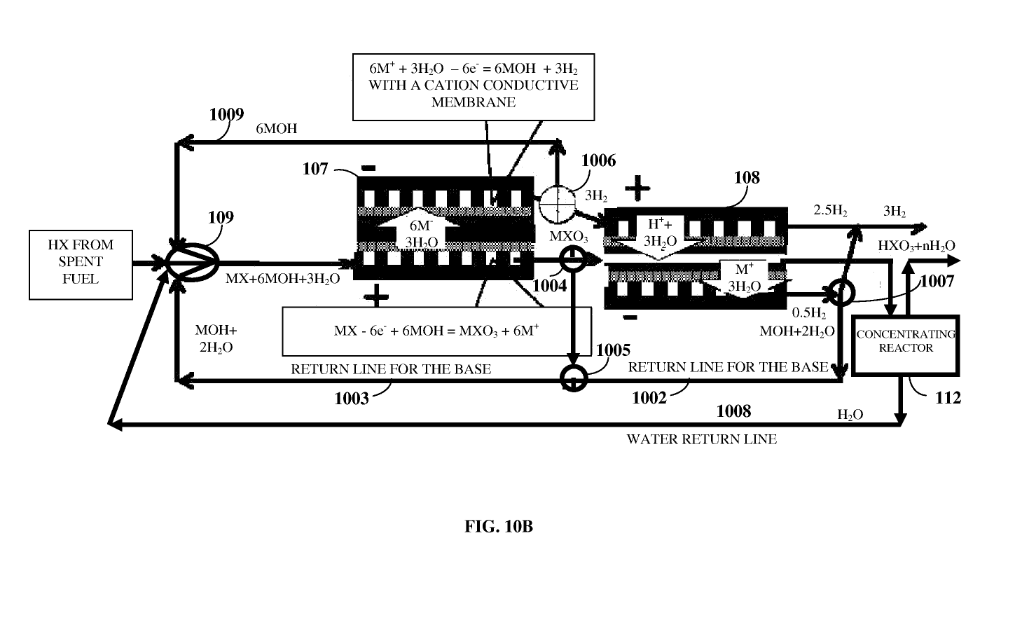

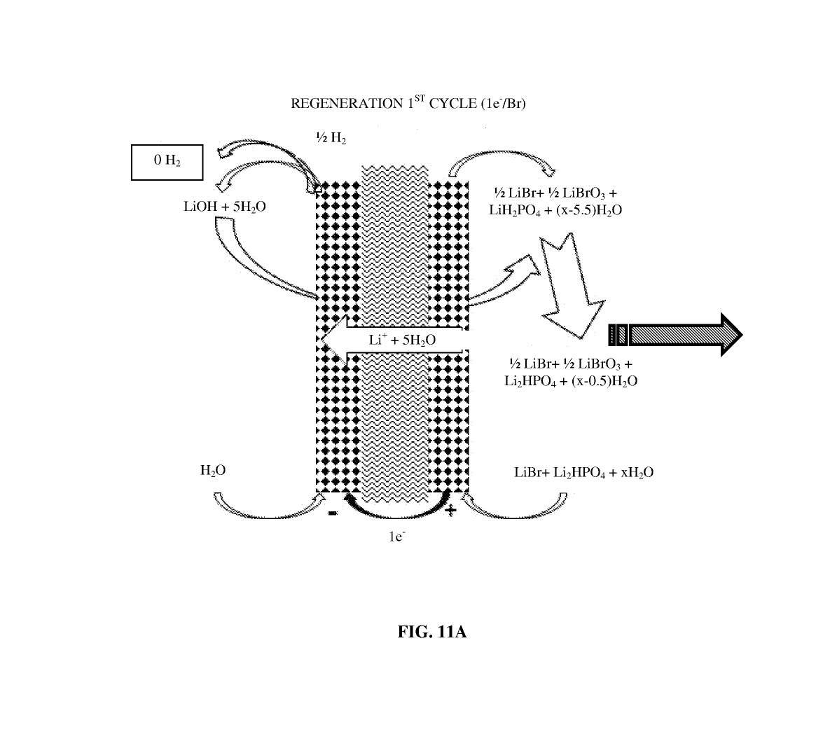

An exemplary operation of the electrolysis-disproportionation (ED) reactor 107 in the cyclic mode is disclosed in the detailed description of FIGS. 11A-11B. A loop within the ED step including the ED reactor 107, the ion exchange reactor 108 such as the orthogonal ion migration across laminar flow (OIMALF) reactor, and the mixing reactor of the neutralization reactor 109 is disclosed in the detailed description of FIG. 10B. As used herein, the term “laminar flow” refers to a type of fluid flow, for example, a liquid flow or a gas flow, in which directions and magnitudes of fluid velocity vectors in different points within a fluid do not change randomly in time and in space. Also, as used herein, the term “migration” refers to a movement of an electrically charged object such as an ion due to the action of an external electric field. In the OIMALF process, the vectors of the laminar flow velocity and the electric field are not parallel and not anti-parallel. The concentrating reactor 112 concentrates the acid form of the aqueous multi-electron oxidant (AMO) to remove water produced on the positive electrode 205a during the discharge and to remove water introduced with the buffer during electrolysis-disproportionation. The concentrating reactor 112 removes water or other solvents from a dilute fluid that enters the concentrating reactor 112 and releases a concentrated fluid and water or another solvent. The concentrating reactor 112 performs concentration, for example, by evaporation or reverse osmosis.

The discharge system 101 and the regeneration system 106 can be used together in a complete energy cycle that recycles all the chemicals and does not generate chemical waste. The complete energy cycle employs the regeneration system 106 in addition to the discharge system 101. The discharge products produced in the discharge unit 104 of the discharge system 101 are converted back to intermediates such as Br₂, or intermediate forms such as LiBrO and LiBrO₃ of the reactants in the ED reactor 107, and to the final form such as HBrO₃ in the ion exchange reactor 108, for example, the orthogonal ion migration across laminar flow (OIMALF) reactor.

The reverse transformation of the cathodic discharge product, for example, HBr, into the aqueous multi-electron oxidant (AMO), for example, HBrO₃ in the regeneration system 106 is accompanied by the release of the reducer, for example, hydrogen in a stoichiometric amount. As a result, the regeneration system 106 can produce simultaneously both the AMO and hydrogen, in stoichiometric amounts, which can be used again as reactants during the direct mode of operation of the discharge unit 104 of the discharge system 101. In an embodiment, the regeneration of the AMO from the spent discharge fluid or from the intermediate oxidant is catalyzed by a homogeneous catalyst such as chlorine, polyvalent metal ions, etc., or by a heterogeneous electrocatalyst such as ruthenium dioxide, lead dioxide, and their derivatives. The energy cycle based on the discharge unit 104 and the process of regeneration disclosed herein eliminates the need for a macro scale infrastructure for the production, transportation and storage of the reducer, for example, hydrogen in contrast to applications based on fuel cells.

The discharge unit 104 disclosed herein is implemented with aqueous multi-electron oxidants (AMOs) compatible with water and with cation-exchange membranes such as commercially available polyperfluorosulfonic acids. The aqueous multi-electron oxidants are, for example, halogens, oxides, and oxoacids of halogens, of chalcogens, of pnictogens, of xenon, etc. The listed compounds can assure a higher theoretical energy density than the elemental halogens and batteries with solid electroactive materials such as lithium ion batteries, but at the expense of lower energy efficiency and lower power density and a higher cost as an expensive catalyst may be required. In this embodiment, homogeneous reactions near the positive electrode 205a are utilized in order to achieve a higher power from the positive electrode 205a. The discharge system 101 disclosed herein circumvents the drawback of lower energy efficiency and power density and of higher cost by using a solution-phase redox mediator. The solution-phase redox mediator is an Ox_{med}/Red_{med} couple which is subject to a rapid and reversible transformation at an electrode and is capable of a quick homogeneous redox reaction with the aqueous multi-electron oxidant. A solution-phase redox mediator is a redox couple dissolved in a solution, for example, the oxidant fluid that is capable of relatively fast electron transfer reactions both at the electrode and with a primary aqueous multi-electron oxidant (AMO), for example, bromine/bromide couple. At the same time, the reduced form of the Ox_{med}/Red_{med} couple participates in a rapid redox reaction with the high energy but electrochemically inactive AMO:

AMO+Red_{med}→Red+Ox_{med}

Ox_{med}+n_{med}e=Red_{med}

The solution-phase redox mediators help to realize the electrochemical process at a low over-voltage on the electrodes 205a with or without a low amount of platinum (Pt) and other catalyst. The solution-phase redox mediator is stable with respect to side reactions and hence allows the discharge unit 104 to be used for many days or cycles. The solution-phase redox mediator can be present only within the positive electrode space of the discharge unit 104 with minimal cross-over to the negative electrode space. The solution-phase redox-mediator helps to realize a high rate of transformation of the principal aqueous multi-electron oxidant (AMO). The reduced form of the solution-phase redox mediator (Red_{med}) causes a rapid solution-phase chemical reaction during discharge and can be regenerated from the oxidized form of the solution-phase redox mediator (Ox_{med}). In an embodiment, to mediate AMO reduction in the discharge unit 104, a solution-phase mediator, for example, polyoxometallates is used to facilitate the electrode reaction on the positive electrode 205a. In this embodiment, the regenerating couple is suspended or immobilized polyoxometallates which do not cross the membrane and do not discharge at the negative electrode 205b due to their large size, negative charge or a combination thereof. In an embodiment, the regeneration process is based on the redox-mediated catalysis by the redox couple:

AMO+Red_{med}->Discharge Product+Ox_{med}Red_{med}⇄Ox_{med}+n_{med}e

In a reduction of aqueous multi-electron oxidants (AMOs), a large number of protons are consumed. The discharge unit 104 disclosed herein produces protons at the negative electrode 205b and transfers the protons to the positive electrode 205a across the electrolyte layer 205c. The hydrogen reducer is automatically co-regenerated with the aqueous multi-electron oxidant (AMO), or an intermediate, Ox_{med}, during this chemical process. Thus, the regeneration system 106 restores back both the components of the oxidant fluid, that is, the AMO, Ox, or the oxidized intermediate, Ox_{med}; and the fuel or the reducer such as H₂. The discharge unit 104 disclosed herein uses AMOs. A homogeneous redox mediator is added to or generated within the discharge unit 104 to perform the reduction of the AMO during the discharge process in the bulk of the solution rather than on the surface of the electrode 205a where the number of active sites is lower. The homogeneous redox mediators allow for the use of AMOs in electrochemical power sources and resolve the issue of the slow and irreversible direct electrode reactions of the AMO.

The discharge unit 104 disclosed herein therefore provides a long driving range, a high energy density, a high power, and a high energy efficiency at a lower cost. The discharge unit 104 requires a short refill time and can be operationally combined with the regeneration system 106 to enable an electric energy cycle. The discharge unit 104 disclosed herein avoids the need for a large amount of platinum or other expensive metals for the electroreduction of oxygen. Since the discharge unit 104 does not consume oxygen, the discharge system 101 can be used in enclosed environments such as submarines, space ships, etc.

The discharge unit 104 disclosed herein takes advantage of the homogeneous comproportionation between an oxoanion and a free halide, leading to an electrochemically active halogen on discharge in an ignition type cycle. In the case of bromic acid (HBrO₃):

In the catholyte 5HBr+HBrO₃=3H₂O+3Br₂@pH<4, fast

On the cathode 3Br₂+6e⁻=6Br⁻, fast

On the anode 3H₂−6e⁻=6H⁺, fast

The discharge unit 104 allows for a fast reversible reaction on the surface of an inexpensive electrode while performing the slower comproportionation step utilizing the actual energy storing species, for example, the aqueous multi-electron oxidant (AMO) such as bromate or other halogen oxoanion, in the bulk of the solution where a higher reaction rate can be sustained. The reagent and the product of the discharge are anions which result in their low crossover to the negative electrode 205b. Among the bromine oxoacids HBrOₙ, 1≦n≦4, bromic acid (HBrO₃) presents a useful compromise between the energy density and the energy efficiency. The theoretical efficiency of a H₂—HBrO₃ discharge unit 104 on discharge can be estimated as the ratio of the standard equilibrium potential of the bromine/bromide couple, for example, about 1.07V and the standard equilibrium potential of the bromate/bromide couple, for example, at about 1.42V, measured with respect to the hydrogen electrode and is equal to about 75%, which is acceptable for transportation applications.

The method and the system 100 disclosed herein uses halic acids or halate anions as the aqueous multi-electron oxidant (AMO) among halogen oxoacids due to a number of reasons and/or factors. One of the factors is, for example: perhalates are inert kinetically, both in direct reduction on an electrode 205a or 205b and in homogeneous comproportionation, whereas halites and hypohalites have lower energy densities. Another factor is, for example: during the discharge, both the efficiency of the halogen electrode kinetics, that is, the halogen/halide exchange current and the ratio of the standard electrode potentials of halogen/halide to oxohalate/halide are considered in the overall cycle energy efficiency. Due to the first factor, bromine oxoacids are used instead of chlorine oxoacids and due to the second factor, bromine oxoacids are used instead of iodine oxoacids. The discharge system 101 can be used on-board, for example, a vehicle. The regeneration system 106 can be used on-board or off-board. The structures of the discharge unit 104 or the electrolytic cell stack 105 are based on the corresponding structures in proton exchange membrane fuel cells (PEMFCs). The bromate/bromide direct electrode reaction is slower than the iodate reaction. At pH 10, the difference between the onset potentials of bromate reduction to bromide and bromide oxidation to bromate amounts to 0.4 V. In an acidic solution, the reduction of bromate follows the same pathway as the reduction of iodate, that is, via a homogeneous comproportionation to bromine.

In an embodiment, the reagent containers, for example, the oxidant tanks 102 and the reducer tanks 103 exemplarily illustrated in FIG. 1, are refilled by pumping the aqueous multi-electron oxidant (AMO) and the reducer from their respective stationary storage facilities such as an off-road fueling station into their respective reagent containers, for example, 102 and 103. In an embodiment, the reagent containers, for example, 102 and 103 are located outside the discharge unit 104 and are connected to the electrolytic cell stack 105 via the ports 302 and 303. In another embodiment, the reagent containers, for example, 102 and 103 are refilled by regenerating or partially regenerating the intermediate oxidant and the reducer, for example, by electrolysis, by applying an electric current of a polarity opposite to the polarity of the electric current that the discharge unit 104 generates during the discharge mode of operation, etc. This partially regenerated AMO is useful for regenerative braking while driving an electric vehicle, load leveling, etc.

FIG. 2 exemplarily illustrates a perspective view of a dissembled single electrolytic cell 200 of an electrolytic cell stack 105 of the discharge unit 104 of the discharge system 101 and of the electrolyzer 107a of the electrolysis-disproportionation (ED) reactor 107 of the regeneration system 106 exemplarily illustrated in FIG. 1. Each electrolytic cell 200 comprises the 3-layer electrolyte-electrode assembly 205. The 3-layer electrolyte-electrode assembly 205 of the electrolytic cell stack 105 is flanked by pair of diffusion layers 201a and 201b, where the pair of diffusion layers 201a and 201b is flanked by a pair of bipolar plates 202. The diffusion layers 201a and 201b are electronically conducting and porous. The diffusion layers 201a and 201b are sheets capable of gas transport or liquid transport through pores of the diffusion layers 201a and 201b or though the bulk of the diffusion layers 201a and 201b. Moreover, the diffusion layers 201a and 201b are capable of electronic conductivity through their bulk. The diffusion layers 201a and 201b are positioned on either side of the 3-layer electrolyte-electrode assembly 205 in order to facilitate a uniform distribution of the reactants and removal of the discharge products over the areas of the electrodes 205a and 205b. The 3-layer electrolyte-electrode assembly 205 flanked by a negative diffusion layer 201b on the negative electrode side and a positive diffusion layer 201a on the positive electrode side forms a 5-layer electrolyte-electrode assembly 206. The 5-layer electrolyte-electrode assembly 206 flanked by two bipolar plates 202 or a bipolar plate 202 and an endplate 301, exemplarily illustrated in FIG. 3, forms a single electrolytic cell 200. Multiple electrolytic cells 200 connected electrically in series and flanked by endplates 301 form the electrolytic cell stack 105 so that any two adjacent electrolytic cells 200 share a common bipolar plate 202.

The diffusion layers 201a and 201b are made of, for example, porous carbon, composites containing carbon particles and fibers, and carbon cloths such as those used for hydrogen-air proton exchange membrane fuel cells (PEMFCs) and for redox flow batteries. The bipolar plates 202 comprise flow channels 202a exemplarily illustrated in FIG. 3, for supplying the reducer and the aqueous multi-electron oxidant (AMO) from the storage tanks 103 and 102 respectively, into the electrolytic cell stack 105 and for removing the discharge products from the electrolytic cell stack 105. The bipolar plates 202 are made of, for example, graphite, other carbonaceous materials, carbon-polymer composites, metals, alloys, or electrically conductive ceramic. The 3-layer electrolyte-electrode assembly 205 and/or the 5-layer electrolyte-electrode assembly 206 are hereafter referred to as “electrolyte-electrode assembly”.

The electrolyte-electrode assembly 205 comprises the electrolyte layer 205c flanked by the positive electrode layer 205a and the negative electrode layer 205b as disclosed in the detailed description of FIG. 2. The positive electrode 205a is supplied with the oxidant fluid comprising the aqueous multi-electron oxidant (AMO) and the negative electrode 205b is supplied with the reducer fluid during the discharge mode of operation of the discharge unit 104. The positive electrode 205a produces the intermediate oxidant such as Br₂ and the negative electrode 205b produces the reducer such as H₂ on partial recharge, that is, when electric current is forced through the discharge unit 104 in a direction opposite to the direction of the electric current during discharge. A certain amount of the intermediate oxidant in the discharge unit 104 is regenerated from the discharge fluid by reversing a polarity of the electric current flowing through the discharge unit 104 during discharge. In an embodiment, the electrodes 205a and 205b are multiphase systems comprising an electron conducting phase, an ion conducting phase, an electrocatalyst phase that can be functionally combined with an electron conductor, and a reactant/product-transporting porous phase that can be functionally combined with an ion conductor. The discharge unit 104 is a device that converts chemical energy of the reducer and the AMO into electrical energy by means of electrochemical reactions on the two electrodes 205a and 205b and an ion transport through the electrolyte layer 205c.

The electrolyte layer 205c of the electrolyte-electrode assembly 205 in the discharge unit 104 acts as an ion conductor, as well as an electronically non-conducting mechanical barrier separating the negative electrode 205b and the positive electrode 205a of the electrolytic cells 200, thereby precluding an internal electrical and chemical short circuit from being established between the positive electrode 205a and the negative electrode 205b as well as between the aqueous multi-electron oxidant (AMO) and the reducer. In an embodiment, the electrolyte layer 205c of the electrolyte-electrode assembly 205 is composed of a material, for example, a solid, a gel, a liquid, or a combination thereof, that is capable of protonic conduction or, more generally, of ionic conduction but not electronic conduction, a polymer, an ionomer, a solid ion conductor, or a solid proton conductor. The electrolyte layer 205c conducts ions but not electrons. The electrolyte layer 205c is compatible with water, with the AMO, with the reducer, with the buffer, and with the discharge products. Furthermore, since durable proton-conducting fuel cell membranes are available commercially, the discharge unit 104 disclosed herein uses acidic polymer electrolytes. In another embodiment, the electrolyte layer 205c of the electrolyte-electrode assembly 205 is composed of a material with a cationic conduction exceeding an anionic conduction of the material. In an embodiment, the electrolyte layer 205c is composed of a material that contains one or more proton donor groups or proton acceptor groups, for example, sulfonic, phosphonic, boronic or nitrogen-base groups. In an embodiment, the electrolyte layer 205c is a solid in which hydrogen ions are mobile. In another embodiment, the electrolyte layer 205c is a liquid or a gel in which hydrogen ions are mobile.

Examples of the electrolytes 205c used in the electrolyte-electrode assembly 205 disclosed herein comprise polymers such as Nafion® of E. I. du Pont de Nemours and Company Corporation, Flemion® series of polymers of Asahi Glass Company, Aciplex® of Asahi Kasei Chemicals Corporation, short-chained trifluorovyniloxy polymers from Dow Chemicals, Hyflon®-Ion of Solvay Specialty Polymers, Aquivion® of Solvay SA Corporation, a polymer with —O—(CF₂)₄—SO₃H pendant groups developed by 3M Company, BAM membrane from Ballard Advances Materials Corp., sulfonamide based polymers developed by DesMarteau, reinforced membranes from W. L. Gore & Associates, Inc., polybenzimidazole, and other polymers with acidic groups, basic groups or a combination thereof. The acidic groups comprise, for example, sulfonic, phosphonic, boronic, and carboxylic groups. In an embodiment, the electrolyte 205c is a polymer capable of anionic conduction, for example, polymers with quaternary nitrogen and phosphorus groups such as polymers employed in alkaline membrane fuel cells. Another example of an electrolyte 205c employed in the electrolyte-electrode assembly 205 disclosed herein is an ionically conducting liquid retained in the pores of a solid matrix. Examples of such ionically conducting liquid electrolytes comprise phosphoric acid in a silicon carbide (SiC) matrix, hydroxide melts, and electrolyte solutions comprising, for example, solid oxide matrices, polymer matrices, and a combination thereof. Another example of an electrolyte 205c employed in the electrolyte-electrode assembly 205 disclosed herein is a solid proton conductor such as CsH₂PO₄, CsHSO₄, and related materials, alkaline-earth cerate- and zirconate-based perovskite materials such as doped SrCeO₃, BaCeO₃, and BaZrO₃, as well as rare-earth niobates, tantalates, and tungstates.

In an embodiment, the electrolyte layer 205c is a porous solid matrix imbibed with a liquid or gel or solid ion conducting material. That is, the electrolyte layer 205c is a composite material comprising an ion conducting liquid or gel or solid within pores of the porous solid matrix. The liquid in the electrolyte layer 205c is, for example, phosphoric acid or an aqueous solution of phosphoric acid, a hydroxide or an aqueous solution of a hydroxide, molten carbonates, molten hydroxides, a molten salt, etc. The conducting ion in the electrolyte layer 205c is, for example, H⁺, OH⁻, F⁻, Cl⁻, Br⁻, I⁻, or a combination thereof. The porous solid matrix is, for example, polytetrafluoroethylene (PTFE), polyvinylidene fluoride (PVDF), a dielectric such as silicon carbide, silicon dioxide, a silicate, other ceramic materials, other polymer materials, etc. The ion conducting liquid is, for example, water, an acid, a base, a salt, a molten electrolyte, an organic solvent, or a combination thereof.

In another embodiment, the electrolyte layer 205c of the electrolyte-electrode assembly 205 is composed of a material, for example, a solid membrane, capable of protonic conduction. The solid membrane is, for example, Nafion® of E. I. du Pont de Nemours and Company Corporation and related sulfonic acid polymers, a sulfonamide polymer, acid doped polybenzimidazole, alkali hydrogen sulfates, phosphates such as cesium hydrogen sulfate (CsHSO₄), other solid proton conductors, etc. In an example, the material used as the electrolyte layer 205c is CsH₂PO₄, other solid proton conductors, etc., when the reducer used in the discharge unit 104 is hydrogen or a hydride. Although selective ionic conduction of the electrolyte layer 205c is not required, an H⁺ conducting membrane confers the benefit of a more complete reduction of the aqueous multi-electron oxidant, and higher solubility of the discharge products, that is, of a larger energy density of the discharge unit 104 and the regeneration system 106. In another embodiment, the electrolyte layer 205c is a liquid under laminar flow.

In an embodiment, the electrolyte-electrode assembly 205 of the discharge unit 104 further comprises electrodes or electrode layers 205a and 205b disposed on each of the electrolyte layers 205c. The electrode layers 205a and 205b comprise, for example, catalysts, carbon particles, a binder, a pore-forming agent, etc. In an embodiment, the catalyst in the electrode layer disposed on the negative hydrogen electrode 205b is platinum (Pt) and Pt nanoparticles on carbon microparticles or carbon microfibers. In an embodiment, the catalyst in the electrode layer disposed on the positive electrode 205a is one or more carbonaceous materials with or without metals, metal oxides, other metallic and non-metallic materials, etc.

The discharge unit 104 disclosed herein produces, in the discharge mode, an electric power, that is, electrical current and/or electric voltage via an electrochemical reaction using two reactants: the reducer and the aqueous multi-electron oxidant (AMO) on spatially separated electrodes 205a and 205b. During the discharge mode of operation of the discharge unit 104, the negative electrodes 205b are supplied with the reducer and the positive electrodes 205a are supplied with the AMO resulting in a sustainable voltage difference and sustainable electric current between the electrodes 205a and 205b. The discharge mode of operation of the discharge unit 104 is also known as a power generating mode of operation or a direct mode of operation. The discharge unit 104 produces electric potential difference between the electrodes 205a and 205b, which in turn produces an electric potential difference between the diffusion layers 201a and 201b and between the bipolar plates 202, when the reactants are supplied to their respective electrodes 205a and 205b. The reducer donates electrons to the negative electrode 205b and produces ions. The external electric circuit 203 conducts or transfers electrons from the negative electrode 205b to the positive electrode 205a. The aqueous multi-electron oxidant accepts the electrons at the positive electrode 205a for producing the electric current in the external electric circuit 203. The electrolyte layer 205c provides for a movement of the ions between the negative electrode 205b and the positive electrode 205a, thereby maintaining electroneutrality of the electrolyte layer 205c and conservation of charge in the discharge unit 104, and producing a sustainable current and sustainable voltage between the electrodes 205a and 205b and between the bipolar plates 202.

When a load 204, for example, a light bulb is attached between the terminals of the electrolytic cell 200 or between the endplate terminals of the discharge unit 104, the electric current flows for as long as the reactants are supplied to the electrodes 205a and 205b and the discharge products of the redox reaction are removed from the electrodes 205a and 205b. In the discharge mode of operation, the discharge unit 104 consumes the reducer and the aqueous multi-electron oxidant that is produced, for example, electrochemically regenerated from the discharge fluid outside the discharge unit 104 or fully or partially regenerated inside the discharge unit 104.

FIG. 3 exemplarily illustrates a perspective view of a planar cell stack 300 of the discharge unit 104 exemplarily illustrated in FIG. 1, showing three 5-layer electrolyte-electrode assemblies 206, two bipolar plates 202, and two endplates 301. The planar cell stack 300 comprises multiple electrolytic cells 200 combined electrically in a series combination for delivering more electric power than a single electrolytic cell 200 exemplarily illustrated in FIG. 2. When individual electrolytic cells 200 are connected electrically in series, the planar cell stack 300 produces more electric power via a large voltage with about the same current, than the electric power produced by a single electrolytic cell 200. In an embodiment, each 5-layer electrolyte-electrode assembly 206 of the planar cell stack 300 comprises a 3-layer electrolyte-electrode assembly 205 flanked by the diffusion layers 201a and 201b. Each stack in the planar cell stack 300 comprises the 5-layer electrolyte-electrode assembly 206 positioned between two bipolar plates 202 or between a bipolar plate 202 and an endplate 301 that conduct electrons.

The bipolar plates 202 in the planar cell stack 300 comprise flow channels 202a. The flow channels 202a are grooves which allow the reactants to be delivered to the electrodes 205b and 205a and for the discharge products of the electrochemical reaction from the electrodes 205b and 205a through the diffusion layers 201b and 201a to be removed. The flow channels 202a of the bipolar plates 202 allow transport of the reagents and products to and from the electrodes 205b and 205a and to and from the endplates 301. The planar cell stack 300 terminates with the endplates 301. The endplates 301 are similar in structure to the bipolar plates 202 but do not comprise the flow channels 202a on the outer surfaces 301b of the endplates 301. The endplates 301 comprise the flow channels 202a on the inner surfaces 301a of the endplates 301. Moreover, the endplates 301 comprise connecting ports 302 and 303, for example, inlet ports and outlet ports on the outer surfaces 301b of the endplates 301 for facilitating movement of the reducer and the aqueous multi-electron oxidant (AMO) into the planar cell stack 300 and for the discharge products to be moved out of the planar cell stack 300. Furthermore, the endplates 301 comprise electric contacts on the outer surfaces 301b of the endplates 301.

Each electrolytic cell 200 shares one or two bipolar plates 202 with an adjacent electrolytic cell 200. One side of each bipolar plate 202 contacts a positive side of one electrolytic cell 200 and another side of each bipolar plate 202 contacts a negative side of the adjacent electrolytic cell 200. The electrolytic cells 200 in the planar cell stack 300 are stacked electrically in series such that each bipolar plate 202 faces a diffusion layer 201a of the positive electrode 205a of one electrolytic cell 200 on one side and the diffusion layer 201b of the negative electrode 205b of another electrolytic cell 200 on the other side. The individual electrolytic cells 200 are stacked together such that each bipolar plate 202 contacts the negative side of the electrolytic cell 200 at the left of the bipolar plate 202 and contacts the positive side of the electrolytic cell 200 at the right of the bipolar plate 202. The electrolytic cells 200 in the planar cell stack 300 are stacked electrically in series such that each bipolar plate 202 serves as the positive side of one electrolytic cell 200 and as the negative side of the next electrolytic cell 200. Moreover, the bipolar plates 202 are equipped with through channels (not shown) that provide for transport of the reducer, the aqueous multi-electron oxidant (AMO) and the discharge products from the electrolytic cell 200 to the next electrolytic cell 200 in the planar cell stack 300 or to the connecting ports 302 and 303. The number of repeat units or electrolytic cells 200 in the planar cell stack 300 can be adjusted according to the desired power or voltage. The endplates 301 and the bipolar plates 202 are made of chemically inert electronically conducting materials, for example, carbon or carbon composite, and are equipped with flow channels 202a for supplying the reactants and removing the products.

The oxidant fluid and the reducer fluid are stored in reagent containers, for example, the oxidant tanks 102 and the reducer tanks 103 exemplarily illustrated in FIG. 1. The reagent containers or tanks 102 and 103 are connected to the endplates 301 of the planar cell stack 300 via pipes 302 and 303. In a small planar cell stack 300, the reagent containers or tanks 102 and 103 can be placed above the planar cell stack 300 for gravity feeding the reactants to the electrolyte-electrode assembly 205. In an embodiment, in order to overcome the friction in the flowing fluids, pressurized reagent containers are used or pumps are inserted into the connecting lines. In a large planar cell stack 300, the reagent containers or tanks 102 and 103 are placed at some distance from the planar cell stack 300 and may include heat transfer loops (not shown) for cooling or heating the reactants and the discharge products. For purposes of illustration, the detailed description refers to a planar electrolytic cell 200 and planar cell stacks 300; however, the scope of the method and the system 100 disclosed herein is not limited to the planar electrolytic cell 200 or planar cell stacks 300 but may be extended to other configurations of flow batteries and fuel cells known in the art.

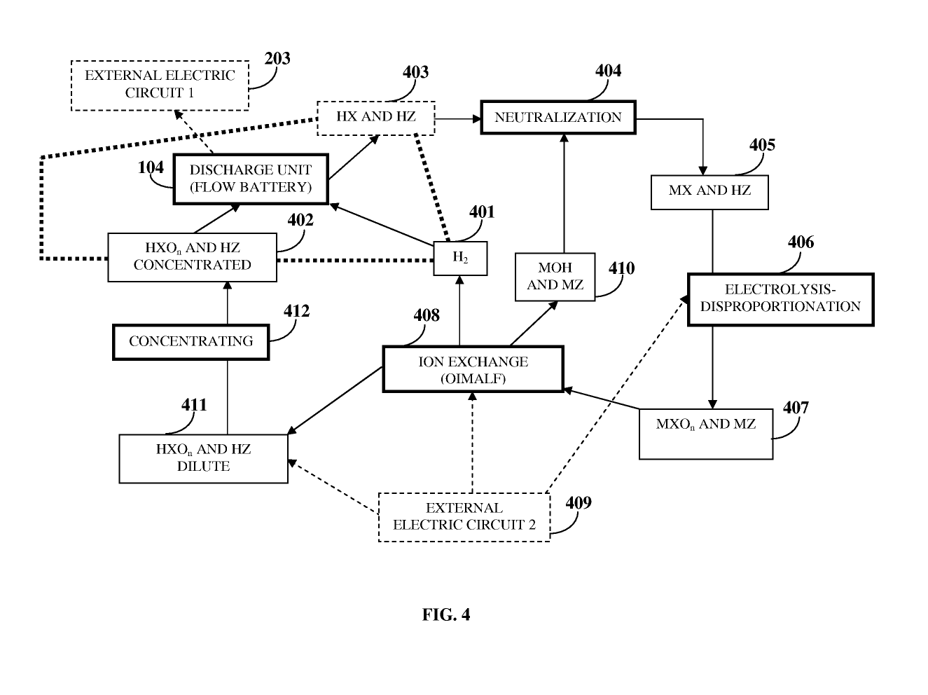

FIG. 4 exemplarily illustrates a discharge and regeneration energy cycle, showing the discharge unit 104 with hydrogen as an example of the reducer 401, an aqueous HXOₙ as an example of an aqueous multi-electron oxidant (AMO), and the regeneration system 106 using MZ as an example of a buffer in a base form. In FIG. 4, HXOₙ refers to the AMO in the acid form, MXOₙ refers to the AMO in the salt form, HZ refers to the buffer in the acid form, and MZ refers to the buffer in the salt form. The flow of materials is represented using solid arrows and the flow of electric power is represented using dotted arrows. Electric power is used during the process of concentrating 412 by reverse osmosis although other sources, for example, heat can also be used, for example, for evaporation.

The discharge unit 104 is similar to the polymer electrolyte membrane fuel cells (PEMFCs), with a low cost porous carbon positive electrode 205a and with the air feed line replaced by an aqueous multi-electron oxidant (AMO) line, for example, a HBrO₃ line. This combination may provide about 1,200 Ah/kg×1.42 V=1,704 Wh/kg theoretical energy density, and about 426 Wh/kg system-level energy density for about 5% w/w compressed H₂, and about 50% w/w aqueous HBrO₃. The pH-driven disproportionation reactions and/or comproportionation reactions allow solution-phase transformation from a high energy bromate to high power bromine, both during discharge with a pH<2 and back with a pH value of about 7<pH<9 during the regeneration.

During the discharge process, the discharge unit 104 is supplied with the reducer 401, for example, H₂, and the aqueous multi-electron oxidant (AMO) HXOₙ 402, for example, HBrO₃, in the oxidant fluid. In an embodiment, the AMO HXOₙ 402 is mixed with a buffer in acid form HZ such as H₃PO₄, carried over from the regeneration step. The reducer 401 donates electrons to the negative electrode 205b, also referred to as an “anode”, and splits into ions. The reaction at the negative electrode 205b is 3H₂-6e⁻=6H⁺. The external electric circuit 203 conducts and transfers electrons from the negative electrode 205b to the positive electrode 205a. The reaction at the positive electrode 205a, also referred to as a “cathode”, is 3Br₂+6 e⁻=6 Br⁻, or when combined with the comproportionation reaction the catholyte, for example, BrO₃⁻+6e⁻+6H⁺=Br⁻+3H₂O. The aqueous multi-electron oxidant accepts the electrons at the positive electrode 205a for producing the electric current in the external electric circuit 1 203. The discharge unit 104 discharges 403 HX, for example, HBr and the buffer HZ in the acidic form, if the buffer HZ is added initially, and generates electric current in the external electric circuit 1 203. The electrolyte layer 205c provides for a movement of the ions between the negative electrode 205b and the positive electrode 205a. At a steady state, the electric current transferred through the discharge unit 104 is equal to the electric current through the external electric circuit 1 203.

The thermodynamics of the H₂—HBrO₃ discharge is as follows: Since bromine reacts on the electrode 205a and bromate is the energy storing species in the oxidant tank 102 exemplarily illustrated in FIG. 1, the fraction of the hydrogen-bromate system energy that can actually be converted into electrical energy is less than 100%. To estimate the fraction of energy, that is, the projected energy efficiency, the standard potentials of the couples of interest are used:

5Br₂+10e⁻=10Br⁻ E°_{A}=+1.0873 V (7)

5Br₂+5H₂=10HBr ΔG°_{A}=10F E°_{A} (8)

and

2BrO₃⁻+12H⁺+10e⁻=Br₂(l)+6H₂O E°_{B}=+1.48 V

2HBrO₃+5H₂=Br₂(l)+6H₂O ΔG°_{B}=10F E°_{B}

The energy stored on-board is given by:

3H₂+HBrO₃=HBr+3H₂O ΔG°_{C}=ΔG°_{A}/5+ΔG°_{B}

The electric power produced by the discharge unit 104 is given by equation (8). The ratio of the electric power produced in the discharge unit 104 to the chemical energy of the reagents in the tanks 102 and 103 exemplarily illustrated in FIG. 1, gives the projected discharge efficiency:

MDE=ΔG°_{A}/ΔG°_{C}=ΔG°_{A}/(ΔG°_{A}/5+ΔG°_{B})=10F E°_{A}/(2F E°_{A}+10F E°_{B})=E°_{A}/(E°_{B}+E°_{A}/5)=1.0873/(1.0873+1.48/5)=78%

For the homogeneous disproportionation and/or comproportionation:

HBrO₃+5HBr=3Br₂+6H₂O

ΔG°_{D}=(ΔG°_{B}−ΔG°_{A})/2=5F(E°_{B}−E°_{A})=5F*0.3927V=379 kJ/mol

K_{C}=[Br₂]³/[H⁺]⁶[BrO₃⁻][Br⁻]⁵=exp(−ΔG°_{D}/RT)=exp(−153)=10^{-66.4}

For RT=2.479 kJ/mol, the critical pH at which [Br₂]³/[H⁺]⁶[BrO₃⁻][Br⁻]⁵=1, is 11. Thus, for the comproportionation reaction to occur the solution pH can be brought below 11; however due to the formation of an intermediate hypobromite, which is stable above the pKa (HBrO)=8.6, a lower pH value such as below 3, is used. In acidic solutions in the discharge unit 104, the comproportionation reaction is strongly favored.

Several embodiments of the method of regeneration of the H₂-AMO chemistry are disclosed herein. For purposes of illustration, the detailed description refers to a method of regeneration using HBrO₃ as the aqueous multi-electron oxidant (AMO), however the scope of the method and the system 100 disclosed herein is not limited to HBrO₃ but can be extended to include other AMOs such as HClO₃, HClO₄, HBrO₄, HIO₃, HIO₄, etc. The regeneration process starts with neutralization 404 of the acid in the discharge fluid with a base, for example, HBr with LiOH or Li₂HPO₄, in the neutralization reactor 109 of the regeneration system 106 exemplarily illustrated in FIG. 1. Neutralization 404 is a chemical reaction in which a base and an acid react to form a salt. The neutralization 404 of the discharge fluid, HX, with the base, MOH, is performed in the neutralization reactor 109. In an embodiment, some process steps of the energy cycle, for example, neutralization 404, and electrolysis and disproportionation 406 can be combined in a single reactor. The base is regenerated in the ion exchange reactor 108 of the regeneration system 106 during an orthogonal ion migration across laminar flow (OIMALF) process 408.

The neutralization 404 of the discharge fluid acid with a base, for example, HBr with LiOH or Li₂HPO₄ produces 405 a solution of a salt MX such as LiBr. The solution of a salt such as LiBr+H₂O is electrolyzed 406 to the intermediate oxidant MXOₙ such as ½Br₂ at the anode and ½H₂+LiOH or ½H₂+Li₂HPO₄ at the cathode. The process of electrolysis 406 is accompanied by the release of the reducer 401, for example, hydrogen in stoichiometric amounts which is used as the reducer 401 in the discharge unit 104. In the case of Br₂, if the pH of the anolyte is maintained near 8, a disproportionation 406 to bromate occurs, for example, with a LiOH base: 3Br₂+6LiOH=5LiBr+LiBrO₃+3H₂O. Electrolysis 406 of the LiBr+H₂O solution and the disproportionation 406 reactions proceed in a cyclic fashion or is a cascade, in batches or continuous modes, till most of the LiBr is converted into LiBrO₃. The residual LiBr may or may not be removed. In the latter case, the product LiBrO₃ will have some LiBr present. In an embodiment, a provision to remove the residual LiBr is provided. In an embodiment, a buffer is used during the cyclic process in order to maintain the pH at a near constant value which is optimal for the disproportionation 406, for example, pH 8. In another embodiment, the buffer comprises hydrogen phosphate and dihydrogen phosphate. In another embodiment, the buffer comprises one or more of Good's buffers. In another embodiment, the buffer comprises a lithium counter-cation.

In the regeneration process, the electrooxidation step or electrolysis 406 is followed by the disproportionation 406 of the intermediate oxidant such as bromine. The disproportionation 406 is the reverse of the comproportionation of the aqueous multi-electron oxidant (AMO) discharge and is favored at a higher pH than the comproportionation of discharge. In the beginning of electrolysis 406 of hydrobromic acid, Br₂ and H₂ are formed in the equal molar amounts:

HBr=½H₂+½Br₂ (9)

If there is no buffer present, the anolyte turns acidic due to hydrolysis:

Br₂+H₂O=HBr+HBrO (10)

In a reactor with a cation-selective membrane, the anolyte compartment turns into a solution of HBrO through the equations (9) to (10) route. A further oxidation of HBrO does not proceed on a carbon electrode at low over-voltages; however, a further disproportionation 406 of HBrO can occur yielding bromate:

3HOBr=2HBr+HBrO₃ (11)

or combined: 3Br₂+6OH—=5Br⁻+BrO₃⁻+3H₂O (12)

The disproportionation 406 of Br₂ to BrO₃⁻ and Br⁻ is strongly favored thermodynamically at pH above 11, which is equivalent to 1 mM of OH⁻, although this reaction has the maximal rate at pH near 8 due to the formation of an intermediate hypobromite which is stable toward further disproportionation 406 at pH>pKa(HBrO)=8.8. However, even if the HBr produced in equation (11) is consumed in equation (9), one proton per BrO₃⁻ will not get electro-reduced due to the lack of an anodic counter-process unless both faradaic and voltage efficiency are sacrificed by running oxygen evolution reactions (OER) or other parasitic process to make O₂ and OH⁻. The resulting pH drop due to the formation of a strong acid HBrO₃ will cause equation (11) to proceed to the left thus ceasing the regeneration when bromine's average oxidation state is around +1. Thus, a disproportionation 406 of Br₂ to Br (+5) requires an introduction of an external base. In the case of an anionic base with a counter cation, this will result in formation of a bromate salt rather than of bromic acid. The hydroxide generated during hydrogen evolution reaction (HER) on the negative counter electrode can be used as the needed base or to make the needed base. Li⁺ can be used as a counter-cation to achieve high solubilities of the salts involved. A pH buffer such as hydrogen phosphate and/or dihydrogen phosphate or LiH₂PO₄+Li₂HPO₄ and one or more of Good's buffers are used to prevent spatial deviations of pH from the value of near 8 within the ion exchange reactor 108. The resulting product, for example, LiBrO₃, 407 needs to be converted to the desired AMO, for example, HBrO₃. This can be accomplished via a solution-phase cation exchange process in the ion exchange reactor 108, for example, the orthogonal ion migration across laminar flow (OIMALF) reactor with a simultaneous conversion of the input discharge fluid into a salt, for example, HBr into LiBr. LiBrO₃ is converted into HBrO₃ using the orthogonal ion migration across laminar flow (OIMALF) or the ion exchange process 408. The buffer is converted from the acid form into a base form simultaneously.

The continuous electrolysis-disproportionation (ED) 406-orthogonal ion migration across laminar flow (OIMALF) process 408 disclosed herein for the regeneration of HBrO₃ from HBr ends with an ion exchange of the base form of the oxidant fluid comprising, for example, LiBrO₃ into the acid form of the oxidant fluid comprising, for example, HBrO₃ in the ion exchange reactor 108 while realizing hydrogen at the negative electrode and consuming hydrogen at the positive electrode as disclosed in the detailed description of FIG. 10B. The principle of OIMALF 408 is identical to ion suppression in anion chromatography. In an embodiment, The OIMALF process 408 generates and consumes H₂ within the OIMALF reactor or the ion exchange reactor 108. The OIMALF process 408 of converting MXOₙ into HXOₙ, for example, LiBrO₃ into HBrO₃ avoids cumbersome chemical separation and ion exchange regeneration steps. The net reaction of the ion exchange or the OIMALF process 408 is: LiBrO₃+HA=HBrO₃+LiA, where HA is a source of protons, for example, water, phosphoric acid, dihydrogen phosphate, one or more of Good's buffers, etc. The regeneration system 106 is connected to an external electric circuit 2 409 which provides electric power for the OIMALF process 408. The base, for example, MOH or LiA 410 generated as a result of the OIMALF process 408 is used during the process of neutralization 404 of the discharge fluid, for example, HBr. In an embodiment, LiBrO₃ is converted into HBrO₃ using ion exchange on resins. This is followed by electrolysis (E) 406 of LiBr into bromine and, in the same ED reactor 107 or another reactor, by disproportionation (D) 406 of the halogen into halate and halide in a suitable buffer, for example, a lithium hydrogen phosphate buffer, one or more of Good's buffers, or any combination thereof, near pH 8. The electrolysis-disproportionation 406 cycle continues in the same flow or batch ED reactor 107 till [bromide]/[bromate] ratio decreases to approximately below 0.05. The resulting solution, for example, approximately 0.5M LiBrO₃ solution, the concentration of which is limited by the solubility of LiBrO₃ at the operating temperature, for example, of about 60° C., then goes back into the ion exchange reactor 108 such as the OIMALF reactor, where Li⁺ in LiBrO₃ is exchanged for H⁺ from the incoming HBr, thus producing approximately 0.5M HBrO₃. The dilute solution 411 of HXOₙ, that is, HBrO₃ formed as a result of the ion exchange process 408 is then concentrated 412, for example, using reverse osmosis or evaporation. The hardware components of the hydrogen-bromate energy cycle disclosed herein comprise analytical chemical detectors (not shown) used for process monitoring and control.

The resulting concentrated HBrO₃ solution is used as the aqueous multi-electron oxidant (AMO) for the discharge unit 104. The net result of regeneration for an exemplary combination of the AMO and the buffer is:

HBr+3H₂O=(electricity in two places, Li₂HPO₄ recycled)=3H₂+HBrO₃.

The electrolysis-disproportionation (ED) 406-orthogonal ion migration across laminar flow (OIMALF) 408 process has a reasonably high projected energy efficiency of about 70%; however the ED 406-OIMALF 408 process requires concentrating 412 the resulting HBrO₃ solution from 6.4% or about 0.5 molal, limited by the solubility of LiBrO₃ to a maximum of 50% w/w or about 7.75M which entails extra energy expenses. The commercial process of concentrating 412 HBrO₃ uses evaporation, with an estimated energy loss of approximately 10-15% if heat exchangers are used. The evaporation is likely to lead to the loss of volatile bromine species and evaporation may be less energy efficient than reverse osmosis (RO). The reverse osmosis process requires overcoming of the osmotic pressure, for example, of 536 bars, which is possible in a cascade mode with commercial supported ion exchange membranes. The minimal energy expense at an infinitely slow filtration rate is 6.6% of the energy content of the product 50% w/w HBrO₃ and 3H₂. Due to a finite flow rate, the regeneration process disclosed herein uses optimization of the unit size, power, and operating pressure in terms of the energy efficiency and capital cost.

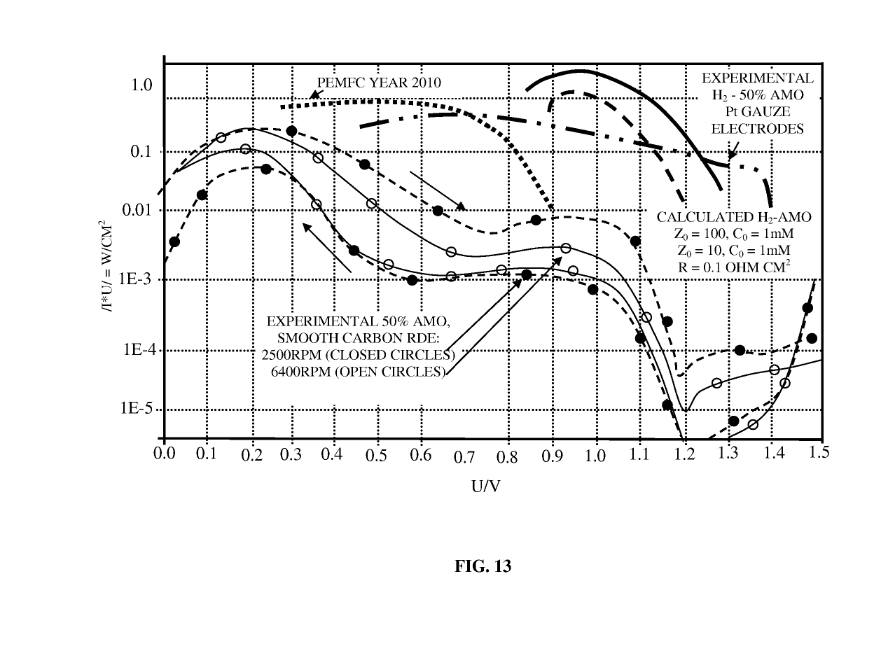

Since the kinetics of all the processes involved in the chemical cycle of the discharge unit 104 and the economic figures for polymer electrolyte membrane fuel cells (PEMFCs) are well known, quantitative predictions on the performance of the discharge unit 104 disclosed herein can be derived. The data for the discharge unit 104 disclosed herein, also referred to as a flow battery or a discharge flow cell, is calculated for a one-dimensional model with a flow-by smooth carbon cathode for a constant solution composition outside of the diffusion boundary layer as well as from the experimental data disclosed in the detailed description of FIG. 13 and using other relevant performance figures from the PEMFCs literature are compared with the Advanced Research Projects Agency-Energy (ARPA-E) targets. The projected performance of the discharge unit 104 and the ARPA-E targets are shown in Table 1 below.

TABLE 1

| | | ARPA-E | Projected |
|---|---|---|---|
| Parameter | Units | Target | Value |
| Manufacturing cost | $/kWh | <100-125 | 140 |
| Effective specific energy | Wh/kg | >150 | 570 |
| Effective energy density | Wh/L | >230 | 900 |
| Effective specific power on | W/kg | >300 | 690 |
| discharge, 80% DOD/30 s | | | |
| Cycle life at 80% depth of | cycles | >1000 | 1000 |
| discharge (DOD) | | | |
| Calendar life | years | >10 | 6 |
| Operating temperature | ° C. | >−30 | −40 |

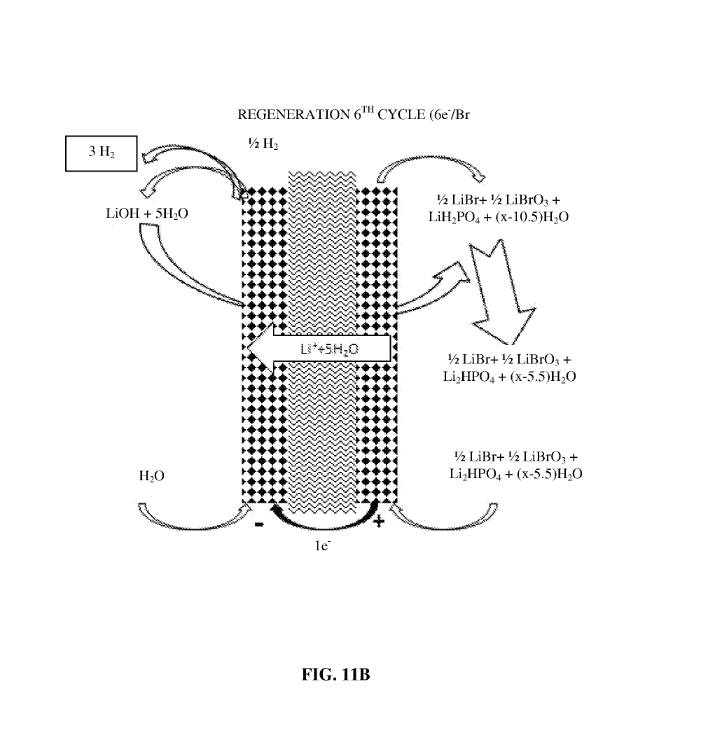

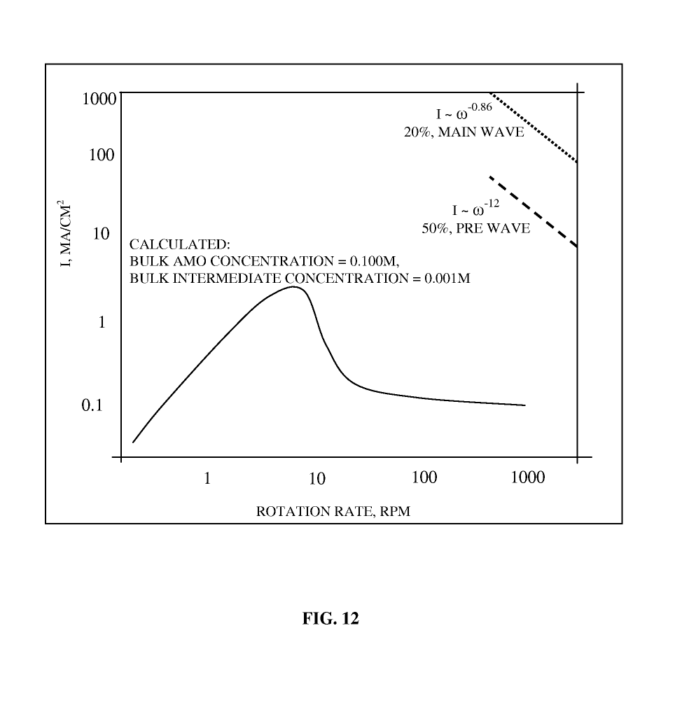

The discharge unit 104 meets the requirements as the primary power source for electric vehicles (EVs). The one-way discharge efficiency of about 85% at the target power of about 0.05 W/cm² is found using a precious metal free smooth glassy carbon rotating disk electrode (RDE) as disclosed in the detailed description of FIG. 12. The discharge unit 104 disclosed herein has a short refueling time in EV applications when combined with off-board regeneration, which is based on the disproportionation 406 of Br₂ electrochemically regenerated from the spent HBr.

In Table 1, the projected temperature refers to a cold-start up and is limited by the aqueous multi-electron oxidant (AMO)'s freezing point. The cost figures are calculated based on the design of modern polymer electrolyte membrane fuel cells (PEMFCs) minus the cost of the Pt catalyst on the positive electrode 205a. The cost figures do not account for the economy-of-scale discount. The parameters refer to the system 100 exemplarily illustrated in FIG. 1, with H₂ storage as a 5% w/w metal hydride and 50% w/w/AMO and 78% discharge efficiency at 0.5 W/cm² power. The power is calculated for a smooth flow-by carbon cathode on the basis of kinetic parameters reported in the literature and by assuming membrane resistance of 0.1 ohm/cm² as exemplarily illustrated in FIG. 13. The durability number is the operational life and not the calendar life. The projected durability of the discharge unit 104 is limited by the degradation of Pt on the hydrogen anode accounting for the aqueous multi-electron oxidant cross-over at open circuit potential (OCP) on the basis of relevant data for the PEMFCs. Purging both the electrodes 205b and 205a with on-board water on shut-downs can increase the projected durability.

The results of system level modeling in the Advanced Research Projects Agency-Energy (APRA-E) metrics show that the most conservative estimate for the energy density of the 5% H₂-50% aqueous multi-electron oxidant (AMO) on-board system is 426 Wh/kg, which is 2.84 times larger than the ARPA-E target of 150 Wh/kg and 6.5 times larger than the corresponding number for lithium iron phosphate (LFP) batteries in Tesla Roadster® of Tesla Motors, Inc. The estimate of the specific energy of the discharge system 101 disclosed herein depends on the type of H₂ storage and varies from 208 Wh/L for 350 bar gas, 339 Wh/L for 5% w/w metal hydride and 400 Wh/L for liquid H₂. For a 150 kWh sport utility vehicle (SUV), the system volume is 750, 970, and 2,000 L for liquid, metal hydride and compressed H₂, respectively, of which only 300 L is the AMO tank. These values fall in between the volumes of the combination gas tank and internal combustion engine (ICE) and the combination of lithium ion battery (LIB) and electric engine. Regardless of the H₂ storage method, the system-level energy density of the discharge system 101 meets the ARPA-E target of 230 Wh/L.

The energy and material cycle exemplarily illustrated in FIG. 4 incorporates an affordable method to regenerate both the hydrogen (H₂) reducer 401 and the aqueous multi-electron oxidant (AMO), for example, HBrO₃ from the discharge fluid, for example, aqueous HBr without reliance on fossil fuels, thus resolving the need for a hydrogen source. Although the gravimetric specific energy of hydrogen is high, the volumetric energy density of hydrogen is low even at the highest practically achievable pressures and hydrogen storage. Both high pressure carbon composite cylinder and metal hydrides tank may satisfy the mass and the volume requirements. In addition, 20% of the required H₂ can be regenerated on board from the discharge fluid using metals, which in turn can be regenerated by electrolysis 406 of MBr₂ off-board:

M(M=Zn,Sn,Fe,etc.)+2HBr→MBr₂+H₂

The safety of the H₂-aqueous multi-electron oxidant (AMO) discharge system 101 is also considered. Since the two reagents, that is, the AMO and hydrogen do not come in contact under normal operating conditions and only small amounts of H₂ and AMO may contact each other without reaction in an accident within the discharge system 101, the safety of H₂ and 50% HBrO₃, is individually considered. On-board hydrogen is safer than gasoline systems due to faster escape in an open space. Bromates are moderately toxic, compared to nitrites and, although suspected carcinogens, are widely used as additives in bread flour in the United States. In an outdoor environment bromates eventually turn into benign bromides. Moreover, bromates are listed as oxidants and are corrosive but not explosive. Bromic acid is classified as an oxidizer, and 50% HBrO₃ has not been reported to explode, and 50% HBrO₃ can be safely concentrated 412 by vacuum-distillation at 80° C. HBrO₃ is similar to HNO₃ although the former does not stain skin. HBr is a well known corrosive agent having a long history of safe use in various applications. The system energy density of the H₂-AMO discharge system 101 disclosed herein is about 6 times larger when compared to the Li-ion battery pack of the Tesla Roaster® and hence allows for the incorporation of additional safety features such as a collision and/or spill-proof enclosure without jeopardizing the driving range and power of the electric vehicle. The risk of using such a corrosive oxidant can be mitigated.

The H₂-aqueous multi-electron oxidant (AMO) discharge system 101 technology disclosed herein has the following advantages: high system energy content, for example, about 426 Wh/kg and about 200-400 Wh/L, which is 6 times greater than that of a lithium ion battery (LIB) pack; high power density, for example, of about 690 W/kg, which exceeds the Advanced Research Projects Agency-Energy (ARPA-E) target more than twice; mechanic refill: can be refilled at a pump in less than 5 min; long range, for example, of about 300 miles per refill with about 120 L storage; aqueous chemistry which is intrinsically safer than Li-ion batteries; low manufacturing cost, for example, of about $120/kWh and about $115/kW; low total cost of ownership (TOC), for example, of about $0.15/mile for a 6 year lifetime of the discharge system 101 and the regeneration system 106; simultaneous stoichiometric regeneration of H₂ and AMO using electricity as the only input and without consuming or generating other chemicals.

FIGS. 5A-5B exemplarily illustrate a table showing different reactions for electrochemical energy storage and energy conversion. The characteristics of the redox reactions comprise, for example, theoretical charge density in (ampere*hour)/kilogram (A*h/kg), standard equilibrium cell potential (Eeq) in volts (V), the reactants' theoretical energy density in watt-hour per kilogram (Wh/kg), the oxidant's solubility (weight percentage %), maximum practical energy density (ED) in Wh/kg, exchange current in milliampere (mA)/square centimeter (cm²), energy efficiency in %, and practical energy efficiency×energy efficiency in Wh/kg. As exemplarily illustrated in FIGS. 5A-5B, some H₂-aqueous multi-electron oxidant (AMO) chemistries can afford four times higher theoretical energy densities than batteries with solid electroactive materials, for example, lithium ion batteries. The practical ratio may be as much as 10 higher packing ratio in a flow battery or the discharge unit 104 in the discharge system 101 exemplarily illustrated in FIG. 1, but not in batteries with solid electroactive materials (SEAM) such as lithium ion batteries. The practical energy density includes water in the concentrated aqueous multi-electron oxidant (AMO). The maximum energy density includes oxidant solubility but not H₂ storage and energy efficiency in %. For oxohalic acids, the projected energy efficiency is defined as the ratio of the equilibrium potentials of halogen/halide and oxohalate/halide.

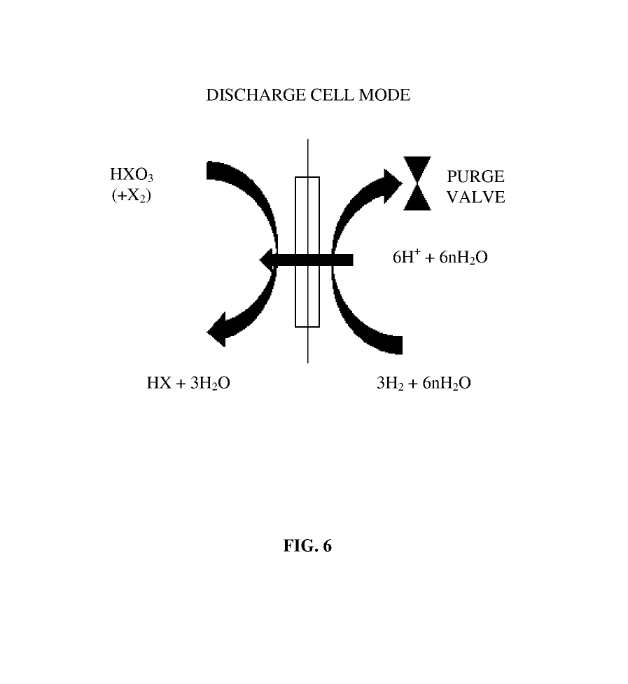

FIG. 6 exemplarily illustrates mass flows in a single electrolytic cell 200 exemplarily illustrated in FIG. 2, of an electrolytic cell stack 105 of the discharge unit 104 exemplarily illustrated in FIG. 1, during discharge. In an embodiment, the reducer is H₂. The aqueous multi-electron oxidant (AMO) is HBrO₃. The standard equilibrium potential for this combination is 1.42 V and the theoretical energy density is, for example, about 1,705 Wh/kg, which is 4.4 times higher than that of lithium iron phosphate/graphite chemistry. HBrO₃ can be used, for example, pumped as an aqueous solution which is stable up to, for example, about 55% w/w concentration (938 Wh/kg). In another embodiment, HIO₃ can be used as the AMO. The equilibrium voltage is 1.19V and the energy density is 1,052 Wh/kg and the room temperature solubility is 74% at 20° C. HIO₃ has faster kinetics, that is, electrolytic cell power, but the intermediate I₂ is solid and reduces at a lower potential thus lowering the efficiency of the energy cycle. The discharge unit 104 is configured as a typical polymer electrolyte fuel cell. A cation exchange membrane, for example, Nafion® of E. I. du Pont de Nemours and Company Corporation is used as the electrolyte 205c. The cation exchange membrane minimizes the crossover or rejects anionic species and assures nearly single hydrogen ion conductivity and high power density. The operating temperature of the discharge unit 104 is maintained above the ambient temperature to facilitate heat rejection and electrode kinetics. The negative electrode 205b, for example, the hydrogen side of the electrolyte-electrode assembly 205 has a standard design and prepared by standard methods known to those skilled in the art of polymer electrolyte fuel cells (PEFCs).

The design of the positive electrode 205a is also similar to polymer electrolyte fuel cell (PEFC) electrodes but the positive electrode 205a has pores for liquid and is paired with a liquid diffusion layer on the back since the reagents and products on the positive electrodes 205a are in the liquid phase in contrast to an air-supplied proton exchange membrane fuel cell (PEMFC). In an embodiment, a parallel flow field is used, although numerous other designs, for example, single, multiple, serpentine, meander, inter-digitated, etc., known to those skilled in the art are employed. In an embodiment, the walls of the flow field of the positive electrode 205a are made of a porous carbon and used without a liquid diffusion layer, or the whole flow field can be made of a solid material and a liquid diffusion layer, for example, made of a porous carbon sheet and can be placed between the flow field and the electrolyte-electrode assembly 205. The positive side of the membrane and the positive wall of the bipolar plate 202 exemplarily illustrated in FIGS. 2-3, can be coated with catalytic layers. The intermediate oxidant, for example, Br₂ can be regenerated by a direct electrochemical process on the positive electrode 205a in an acidic solution. Suitable positive electrodes 205a comprise, for example, one or any combination of carbon, platinum, PbO₂, RuO₂, dimensionally stable anode (DSA), and other oxides, metals and non-metals, including conductive diamond.

FIG. 7 illustrates a method for producing electric power from an aqueous multi-electron oxidant (AMO) and a reducer and for simultaneously generating a discharge fluid. The method disclosed herein provides 701 the discharge system 101 comprising the oxidant tank 102 containing the AMO, the reducer tank 103 containing the reducer, and the discharge unit 104 as exemplarily illustrated and disclosed in the detailed description of FIG. 1. The method for producing electric power facilitates 702 discharge of the discharge unit 104. Discharge occurs by transferring 702a electrons from the positive electrode 205a of the 5-layer electrolyte-electrode assembly 206 exemplarily illustrated in FIG. 2, to the AMO and transferring 702b electrons from the reducer to the negative electrode 205b of the 5-layer electrolyte-electrode assembly 206 exemplarily illustrated in FIG. 2, to produce 702c an electric power or (I*U≠0) or a sustainable electric current, that is, a direct current (DC) in an external electric circuit 203 connected to the terminals of the discharge unit 104 and transferring ions between the positive electrodes 205a and the negative electrode 205b of the 5-layer electrolyte-electrode assembly 206, thus conserving the charge. The discharge is facilitated on the positive electrode 205a of the 5-layer electrolyte-electrode assembly 206, for example, by one or more of electrolysis, electrocatalysis, a solution-phase chemical reaction, a solution-phase comproportionation, a solution-phase redox catalysis, an acid-base catalysis, and any combination thereof.

The discharge unit 104 consumes the aqueous multi-electron oxidant (AMO) and the reducer supplied from their respective storage tanks 102 and 103 to generate the discharge fluid stored in a discharge fluid storage tank (not shown) and electric power in the external electric circuit 203. The discharge fluid comprises, for example, one or more of water, an acid form of the buffer, a base form of the buffer, a halogen, a hydrogen halide, a halogen oxoacid, and any combination thereof. Since the discharge fluid coming out of the discharge unit 104 is not water or not only water, the discharge fluid is not disposed into surroundings but collected in a discharge fluid storage tank or container (not shown) to be regenerated later into the reducer and the AMO. The buffer is in the acid form during the discharge with a pH≦7. The acid form of the buffer is, for example, one or more of phosphoric acid, a dihydrogen phosphate of lithium, Good's buffers, and any combination thereof.

Consider an example where the aqueous multi-electron oxidant (AMO) is bromic acid and the reducer is hydrogen. The processes in the discharge unit 104 are: oxidation of hydrogen on the negative electrode 205b, comproportionation of bromate with bromide in the fluid near the positive electrode 205a, reduction of bromine on the positive electrode 205a, and transport of a hydrogen ion with water from the negative electrode 205b to the positive electrode 205a through a cation exchange membrane. Protons or other positive ions are transferred through the cation exchange membrane from the negative electrode 205b to the positive electrode 205a due to the action of an electric power. Electrons are transferred from the negative electrode 205b to the positive electrode 205a, thus producing electric power, that is, current and voltage in the external electrically conducting connecting circuit, that is, the external electric circuit 203.

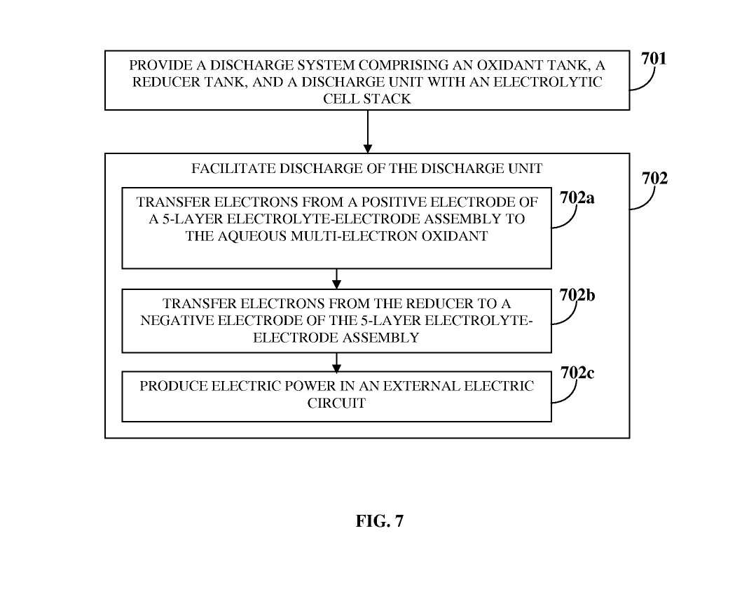

FIG. 8 illustrates a method for regenerating the aqueous multi-electron oxidant (AMO) and the reducer in stoichiometric amounts from a discharge fluid using electric power. The method disclosed herein provides the regeneration system 106 comprising the neutralization reactor 109, the electrolysis-disproportionation (ED) reactor 107, the ion exchange reactor 108, and the concentrating reactor 112 exemplarily illustrated in FIG. 1. The regeneration system 106 neutralizes 801 the discharge fluid, produced by the discharge unit 104 exemplarily illustrated in FIG. 1, with an excess of a base form of a buffer in the neutralization reactor 109 to produce a solution of a salt form of the discharge fluid. The electrolysis-disproportionation proceeds in the ED reactor 107 configured to electrolyze 802 the solution of the salt form of the discharge fluid into an intermediate oxidant at a positive electrode in the ED reactor 107. The regeneration system 106 performs electrolytic decomposition of the discharge fluid, for example, HBr into the reducer, for example, H₂ and the intermediate oxidant, for example, Br₂. The electrolysis process releases the reducer and the base form of the buffer at a negative electrode of the ED reactor 107 while producing a salt form of the AMO at the positive electrode via a series of chemical and electrochemical reactions. The ED reactor 107 is further configured to disproportionate 802 the intermediate oxidant evolving at the positive electrode with an excess of the base form of the buffer to produce the salt form of the AMO, while simultaneously releasing a stoichiometric amount of the base form of the buffer for neutralization. The anion of the buffer is, for example, hydrogen phosphate, dihydrogen phosphate, etc. The cation of the buffer is, for example, lithium, other alkali metal, substituted ammonium, imidazolium, organic cation, etc. Other examples of the buffer are hydroxide, a lithium cation, a magnesium cation, etc. In an embodiment, the buffer is one or more of the Good's buffers. The regeneration system 106 continues 803 the cycle of electrolysis-disproportionation in a single ED reactor 107 of a cascade of ED reactors till the desired degree of conversion is achieved.

The regeneration system 106 also converts the intermediate oxidant, for example, bromine into the aqueous multi-electron oxidant (AMO) in the salt form such as bromate using a chemical process, for example, a homogeneous chemical reaction such as a disproportionation reaction driven by a pH change, or a homogeneous oxidation by a mediator. The regeneration system 106 simultaneously releases a stoichiometric amount of the base form of the buffer for neutralization while, in an embodiment, recycling the reducer, for example, H₂ evolved at the negative electrode and consumed at the positive electrode. Other embodiments for recycling or partially recycling H₂ during the regeneration are possible as disclosed in the detailed description of FIG. 10B, and others should be obvious to those skilled in the art based on the teaching disclosed herein. The ion exchange process proceeds in the ion exchange reactor 108 configured to convert 804 the AMO in the salt form, for example, LiBrO₃ into the AMO in the acid form, for example, HBrO₃. The acid form of the AMO is referred herein as the AMO. The conversion of the salt form of the AMO produced at the positive electrode into the acid form of the AMO is performed by an ion exchange process, for example, an electric field driven orthogonal ion migration across laminar flow (OIMALF) method known to those skilled in ion chromatography, in the ion exchange reactor 108. In an embodiment, the conversion of the salt form of the AMO produced at the positive electrode into the acid form of the AMO is accompanied by a conversion of the base form of the buffer into the acid form of the buffer. The AMO and the reducer are stored in the regeneration system 106 until they are transferred to the discharge system 101 exemplarily illustrated in FIG. 1. The acid form of the AMO is concentrated 805 in the concentrating reactor 112 to remove water produced on the positive electrode during the discharge and to remove water introduced with the buffer during electrolysis-disproportionation. The AMO is regenerated via an electron transfer to the positive electrode with or without a combination with a solution-phase process such as disproportionation; and the reducer is regenerated at the negative electrode of the ED reactor 107. The buffer maintains or stabilizes the pH of the discharge fluid at an optimal level or a constant value, for example, between 7 and 11 or at pH 8 for disproportionation in the ED reactor 107. The buffer in the base form is selected from a group comprising, for example, an alkali metal hydroxide, an alkali metal hydrogen phosphate, an alkali metal salt of one of Good's buffers, phosphoric acid, a dihydrogen phosphate of an alkali metal, and any combination thereof. The alkali metal is, for example, lithium. The base form of the buffer is converted into its acid form during ion exchange.

In an embodiment, the regeneration of the aqueous multi-electron oxidant (AMO) and/or the reducer is facilitated, for example, by an electrocatalyst, a solution-phase redox mediator such as chlorine/chloride, a pH-dependent solution-phase disproportionation, etc., or any combination thereof. In an embodiment, the conversion of the salt form of the AMO into the acid form of the AMO is facilitated by a buffer in the ion exchange reactor 108. In another embodiment, a chloride mediator facilitates regeneration of the AMO from the discharge fluid. In another embodiment, the regeneration of the AMO and/or the reducer from the discharge fluid is facilitated by adding a buffer to the discharge fluid. The electrolysis-disproportionation (ED) reactor 107 is configured to operate in one of multiple modes comprising, for example, a batch mode, a single pass mode, and a cyclic mode. The regeneration system 106 is configured either for cyclic or cascade operation.

The electrolysis-disproportionation (ED) reactor 107 converts a discharged product such as bromide, into a salt form of the aqueous multi-electron oxidant, for example, bromate. The ion exchange reactor 108 converts the aqueous multi-electron oxidant such as bromate from the salt form into the acid form. The ED reactor 107 neutralizes the discharge fluid such as HBr, with a base such as Li₂HPO₄:

HBr+Li₂HPO₄,=LiBr+LiH₂PO₄,

and electrolyzes the resulting solution into hydrogen (H₂) and the intermediate oxidant such as Br₂:

anode: LiBr−e⁻=Li⁺+½Br₂;

cathode: LiH₂PO₄+e⁻+Li⁺=Li₂HPO₄+½H₂

The base is regenerated in the catholyte in the course of the hydrogen evolution reaction. The intermediate oxidant such as bromine further disproportionates via a reaction with the base, for example, as follows:

3Br₂+6Li₂HPO₄+3H₂O=LiBrO₃+5LiBr+6LiH₂PO₄.

The process of electrolysis-disproportionation continues in a cyclic fashion or a cascade fashion until all or almost all bromide is converted into bromate. In the next stage, the bromate is converted into bromic acid in the ion exchange reactor 108, for example, an OIMALF reactor. The base such as lithium dihydrogen phosphate is, for example, also converted into an acid such as phosphoric acid and for example, used with the aqueous multi-electron oxidant without separation.

In an embodiment, the intermediate oxidant, for example, the halogen, is regenerated via an electron transfer to the positive electrode, and the reducer such as hydrogen is regenerated at the negative electrode of the electrolyzer 107a of the electrolysis-disproportionation (ED) reactor 107. In another embodiment, the intermediate oxidant disproportionates during the process of regeneration by consuming a base and provides the final aqueous multi-electron oxidant, for example, a halate in the form of a salt. The base required for the disproportionation of the intermediate oxidant can be supplied externally or can be produced in the course of the cathodic counter reaction in the electrolyzer 107a of the ED reactor 107. A buffer is added to either the catholyte chamber or the anolyte chamber or in both the catholyte chamber and the anolyte chamber of electrolyzer 107a in order to stabilize the pH at the level optimal for the disproportionation. A suitable pH of the buffer is between, for example, 7 and 11. A suitable buffer is, for example, a solution of Li₂HPO₄ and LiH₂PO₄ in various ratios and concentrations. Another suitable buffer is one or more of the Good's buffers. During the disproportionation reaction, in the presence of a buffer or a base containing a cation other than hydrogen, a salt form of the aqueous multi-electron oxidant, for example, LiBrO₃ is produced.

The intermediate product, that is, the salt of the aqueous multi-electron oxidant (AMO) is converted into the acid form such as the aqueous multi-electron oxidant (AMO) in the ion exchange reactor 108, for example, the orthogonal ion migration across laminar flow (OIMALF) reactor using one or a combination of electrolysis, ion exchange on solids, ion exchange in a fluid, and an electric-field driven OIMALF process. The ion exchange occurs after the electrolysis-disproportionation (ED) loop or cascade as exemplarily illustrated in FIGS. 10A-10B. The ED loop is a cyclic process involving oxidation of the salt form of the discharged oxidant on the positive electrode of the electrolyzer 107a of the ED reactor 107 into the intermediate oxidant such as Br₂; a disproportionation reaction that converts the intermediate oxidant such as Br₂ into the salt form of the AMO such as BrO₃⁻, and into the salt form of the discharged oxidant such as Br⁻; oxidation of the salt form of the discharged oxidant on the positive electrode of the electrolyzer 107a into the intermediate oxidant, etc.

In an embodiment, the regeneration of the aqueous multi-electron oxidant from the discharge fluid occurs by reverse transformation of a cathodic discharge product in the discharge fluid and without oxygen consumption or evolution. In another embodiment, the regeneration of the aqueous multi-electron oxidant from the discharge fluid comprises neutralizing an acid of the discharge fluid, for example, via an ion exchange such as orthogonal ion migration across laminar flow (OIMALF). The regeneration system 106 then converts the neutralized discharge solution into an intermediate oxidant and the reducer by means of electrolysis. The intermediate oxidant is further converted into the AMO via pH dependent solution phase disproportionation and ion exchange such as orthogonal ion migration across laminar flow processes. The regeneration process on the positive electrode of the electrolyzer 107a of the electrolysis-disproportionation (ED) reactor 107 is facilitated by using one or a combination of an electrocatalyst, a solution-phase catalyst, an ion exchange on solids, an ion exchange in a liquid, a pH-dependent disproportionation, and an orthogonal ion migration across laminar flow in one ED reactor 107 or separate reactors in series and/or in parallel. For H₂—HBrO₃ regeneration, different embodiments of the methods or routes of electrochemical regeneration of hydrogen and bromic acid from aqueous hydrogen bromide are disclosed herein. Direct electrolysis such as with PbO₂ and RuO₂-based anodes and mediated electrolysis such as with Cl₂-mediator are also implemented.

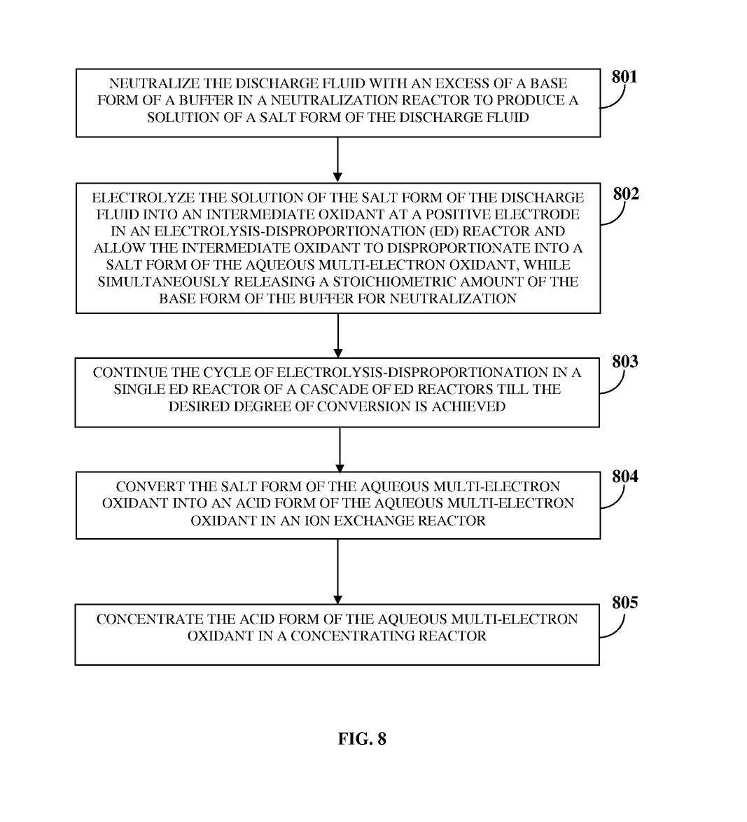

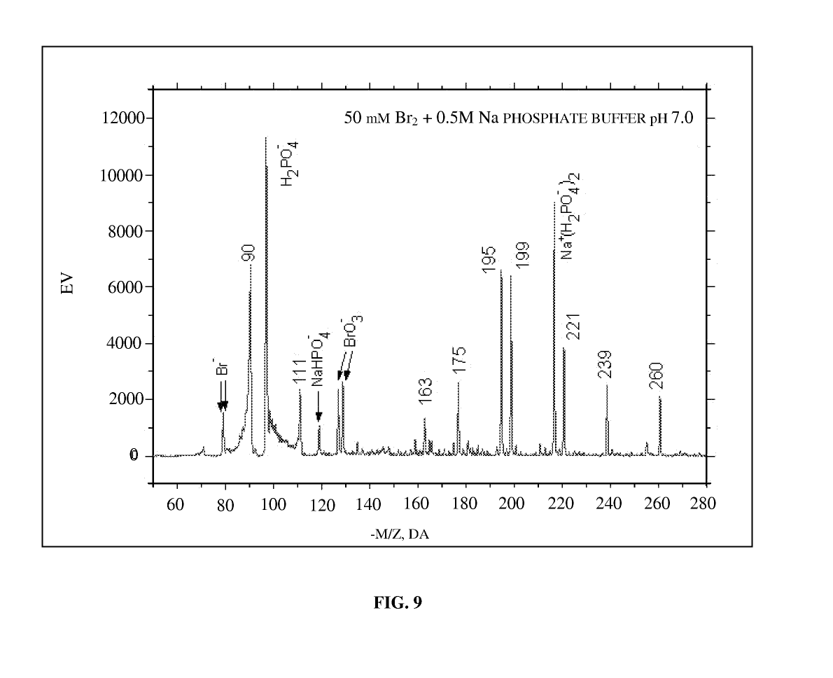

FIG. 9 exemplarily illustrates a negative-ion electrospray ionization-mass spectrometry spectrum of a 0.5M sodium phosphate pH 7.0 buffer solution with 50 mM of Br₂ added. Bromide and bromate are the only detectable negative Br species with 2 Da 1:1 doublets. These data affirm that bromine disproportionates only into bromide and bromate in a pH 7 buffer. The kinetics of the bromine disproportionation has been studied mostly in near neutral media 4≦pH≦8, where the rates of various steps fall in the range convenient for experimental measurements. The disproportionation of Br₂ in water may go all the way to bromate and even to perbromate. The first step occurs at near neutral 4≦pH≦8 via the following pathway:

Br₂+H₂O=HBrO+H⁺+Br⁻ (13)

Br₂+OH⁻=HBrO+Br⁻ (14)

Herein, bromine disproportionates into bromide and hypobromite in two parallel reactions with water and with another base such as hydroxide, that is, via a general base mechanism. The equilibrium constant at 25° C. for equation (13) at 0.5M ionic strength is 6.1×10⁻⁹ M². The first order rate constant for the forward reaction for equation (13) is 97 s⁻¹, while for the reverse comproportionation reaction with H⁺ it is 1.6×10¹° M⁻² s⁻¹. The bromine disproportionation has not been studied computationally, but molecular dynamics show that the homologous chlorine reaction in water clusters proceeds as a bimolecular Cl⁺ transfer between Cl₂ and H₂O. The chlorine disproportionation in acidic solutions also follows a general acid-base catalysis route, first order in Cl₂ and in the general base, while the reverse comproportionation reaction is first order in HOCl, Cl⁻ and in the general acid.

The hypobromite formed in equation (13) undergoes a further disproportionation which is strongly pH dependent. At a low pH bromine and bromate are formed:

5HOBr [symbol] 2Br₂+BrO₃⁻+2H₂O+H⁺ pH<4 (15)

The bimolecular rate constant with respect to the total Br(I) is approximately 2.2×10⁻³ M⁻¹ s⁻¹ at pH 0 extrapolated and increases at higher pH due to the participation of a deprotonated hypobromite in the rate limiting step. At a higher pH, bromide and bromate are formed:

3HOBr [symbol] 2Br⁻+BrO₃⁻+3H⁺ pH>8 (16)

and the rate of the reaction decreases with pH above the pKₐ of hypobromous acid of 8.8, although the kinetic equation retains the second order in total Br(I) and the general base catalysis is operative. Both reactions (15) and (16) occur in parallel at the intermediate 4≦pH≦8 where the formal second-order rate constant is the highest. Thus, the optimal pH for the regeneration process

3Br₂+6OH—=BrO₃⁻+5Br⁻+3H₂O (17)

is 7-10, preferably 8-9. The reaction is slower at higher pH since an intermediate hypobromite is more stable, and at a lower pH, the equilibrium shifts towards Br₂. These considerations based on a literature analysis are confirmed in ESI-MS data, for example, using a Bruker Esquire 3000 quadrupole ion trap mass spectrometer, which shows the feasibility of the regeneration process as per equation (17).

FIGS. 10A-10B exemplary illustrate an electrolysis-disproportionation (ED)-orthogonal ion migration across laminar flow (OIMALF) method for regenerating an aqueous multi-electron oxidant (HXO₃) and a reducer (H₂) from the discharge fluid (HX+H₂O) with MOH as the base. FIG. 10A exemplarily illustrates a method for regenerating halic acid and hydrogen from discharged hydrogen halide in the batch mode of the ED loop. FIG. 10B exemplarily illustrates a method for regenerating halic acid and hydrogen from discharged hydrogen halide in a flow-through cyclic mode of the ED loop. The regeneration system 106 is equipped with the ion exchange reactor 108, in addition to the electrolysis-disproportionation (ED) reactor 107, that converts salts into acids, for example, an aqueous solution of lithium bromate and lithium hydrogen phosphate into an aqueous solution of bromic acid and phosphoric acid using a flow-through batch process utilizing OIMALF, a process similar to an eluent suppression process. The OIMALF process of converting salts into acids avoids chemical separation and ion exchange regeneration steps. The ion exchange reactor 108 outputs 1001 the reducer as exemplarily illustrated in FIG. 10A.

The regeneration system 106 converts the discharge fluid back into the AMO and the reducer via two steps using at least two reactors: the ED reactor 107 and the ion exchange reactor 108 with the mixing reactor or the neutralization reactor 109 and two separation reactors, for example, 1006 and 1007 as exemplarily illustrated in FIG. 10B, if needed and not counted as parts of the other devices. In an embodiment, the ED reactor 107 is configured and operated as a batch reactor or a flow-through reactor. In the batch ED reactor, also referred to as a stirred reactor, the liquid in the positive electrode compartment is stirred to achieve a uniform composition. The batch ED reactor operates in the start-stop batch regime till the desired degree of conversion of bromide into bromate is achieved.

In a flow-through ED reactor, also referred to as a laminar reactor, the liquid flows in one direction and has a non-uniform composition. A series of a single neutralization reactor 109, a single flow-through ED reactor 107, and a single H₂/base separation reactor 1006 can operate in the cyclic regime till the desired degree of conversion of bromide into bromate is achieved. The feedback in the cycle is the line 1009 that returns the base from the H₂ separation reactor 1006 at the end of the electrolysis-disproportionation (ED) loop to the mixing reactor or the neutralization reactor 109 in the beginning of the ED loop. The H₂ is accumulated in the H₂ container during this cycle.

A cascade of a series of a single neutralization reactor 109, a single flow-through the ED reactor 107, and a single H₂/base separation reactor 1006 can operate in the cascade regime, wherein the discharge fluid HX is first neutralized with an excess of a base generated earlier in the ion exchange reactor 108, for example, the OIMALF reactor. The first flow-through ED reactor 107 then converts some Br⁻ into BrO₃⁻ on the positive electrode while releasing H₂ and base on the negative electrode. The H₂ goes into an H₂ storage container (not shown), and the base from the separation reactors 1006 and 1007 is returned to the mixing reactor of the neutralization reactor 109 preceding this H₂ separation reactor 1006 in the series. The partially regenerated oxidant fluid, that is, LiBr+LiBrO₃ in some ratio, instead of going into one preceding mixing reactor of the neutralization reactor 109 as in the cyclic mode, goes into the second mixing reactor in the cascade, where LiBr+LiBrO₃ is neutralized by the base produced in the second mixing reactor and so on. The number of repeated mixing reactor-ED-separation reactor series in the cascade is, for example, between 5 and 8, and is determined by desired power, cost, degree of conversion, etc.

The regeneration process comprises the steps of neutralization in the neutralization reactor 109, electrolysis-disproportionation in the ED reactor 107, separation of the reducer, that is, H₂ gas from MXOn in water in the separation reactor 1006, and ion exchange via OIMALF in the ion exchange reactor 108 as disclosed in the detailed description of FIG. 8. The regeneration system 106 takes HX+3H₂O from the discharge fluid and produces 3H₂+HXO₃, while recycling within itself MOH+2H₂O. The separation reactor 1006 separates the liquid solution with the base from the hydrogen gas reducer. The base component of the buffer is represented as OH⁻.

The ED reactor 107 has an electrolysis unit or an electrolyzer 107a with an electrolyte-electrode assembly (not shown) which is similar to the 5-layer electrolyte-electrode assembly 206 of the discharge unit 104 exemplarily illustrated in FIG. 3, with two endplates 301. In the neutralization reactor 109, the discharge fluid from the discharge fluid storage tank (not shown) is mixed with the solution of the buffer in the base form coming out of the gas-liquid separation reactors 1006 and 1007 through the return lines 1009, 1002, and 1003, and then sent to the positive compartment of the ED reactor 107. The neutralized discharge fluid MX is electrooxidized into the intermediate oxidant X₂ in the positive compartment. The intermediate oxidant X₂ reacts with the base form of the buffer to produce a salt form of the AMO, for example, LiBrO₃. On the negative electrode of the ED reactor 107, hydrogen gas is evolved upon electrolysis, and a buffer base, for example, hydrogen phosphate is formed in the negative electrode. The buffer base loses protons in the hydrogen evolution reaction and becomes deprotonated. The deprotonated base from the negative compartment is mixed with the discharge fluid in the mixing reactor or the neutralization reactor 109 prior to or directly in the positive compartment of the ED reactor 107. On the positive electrode, an intermediate oxidant such as bromine is evolved during electrolysis and reacts with the base introduced from the negative compartment yielding, for example, a halate and a halide via a disproportionation reaction.

The electrolysis-disproportionation (ED) process can proceed as a single pass process with a three-way valve 1004 for a sufficiently long ED reactor 107 and sufficiently high amount of the buffer in the base form added in the neutralization reactor 109. In an embodiment, the ED process can run in a cyclic mode with two three-way valves 1004 and 1005 in the loop, which is useful for a shorter ED reactor 107, which increases the regeneration time but saves on capital expenses. The three-way valves 1004 and 1005 are exemplarily illustrated in FIG. 10B in positions for the single pass mode of operation of the ED reactor 107. The three-way valves 1004 and 1005 send the AMO in the salt form, that is, MXO₃, for ion exchange via OIMALF in the ion exchange reactor 108 to produce the acid form of the AMO, that is, HXO₃. The halide is oxidized into halogen on the positive electrode of the ED reactor 107 and disproportionates in a reaction with the base in the next ED cycle.

The ED reactor 107 can be configured and operated in a batch mode or in a flow through mode. The flow through mode can be a cycle with one or more units or a cascade with 2 or more units. When a sufficient degree of conversion, that is, ratio of bromate concentration to the total concentration of Br in all forms is achieved in the ED reactor 107, after a certain charge, that is, time or number of cycles passed, the liquid from the positive electrode chamber of the ED reactor 107 goes into the ion exchange reactor 108 where, in the exemplary case of Li₂HPO₄ base form of the buffer, the bromate is converted into bromic acid, lithium hydrogen phosphate buffer is converted into phosphoric acid in the middle chamber, hydrogen in consumed in the positive chamber, and base (Li2HPO4) solution is regenerated in the negative chamber along with hydrogen. The base solution is used to neutralize the incoming HX from the discharge unit 104 exemplarily illustrated in FIG. 1. The separation reactors 1006 and 1007 are used to separate the gases from the liquids.

Halates are produced by disproportionation of a halogen in the presence of a base. The process of disproportionation of halogens with an MOH base is described by the following equation:

3X₂+6MOH=MXO₃+5MX+3H₂O.

In the electrolysis-disproportionation (ED) reactor 107, exemplarily illustrated in FIGS. 10A-10B, if the liquid in the positive electrode chamber and the liquid in the negative electrode chamber are allowed to mix, the halogen produced on the positive electrode can react with the base produced on the negative, yielding, for example, a halate and a halide. The halide is oxidized on the anode, thus initiating the new cycle of the loop:

MX+H₂O+electrolysis=(0.5H₂+MOH) negative electrode chamber+0.5X₂ positive electrode chamber,

3X₂+6MOH=5MX+MXO₃+H₂O after mixing in the positive electrode chamber,

where the disproportionation described in the second equation can be performed either in a flow-through process or a batch process. The net equation of the regeneration process, that is, the ED process is:

6MX+3H₂O=MXO₃+3H₂

with the electrolysis-disproportionation loop 109 to 1007 as exemplarily illustrated in FIGS. 10A-10B. The reduction of XO₃⁻ on the negative electrode in the electrolyzer 107a is prevented by using a cation-selective membrane. In an embodiment, a membraneless reactor can also be used if the negative electrode comprises, for example, Ni capable of selective reduction of water into hydrogen without reducing XO₃⁻, or if the electrolyte layer 205c is not a solid membrane but a laminar flow electrolyte. The concentrating reactor 112 removes water introduced with the buffer during electrolysis-disproportionation. A portion of the water is transferred to the neutralization reactor 109 via the water return line 1008 exemplarily illustrated in FIG. 10B.

The choice of the counter-cation in the regeneration schemes of FIG. 8 and FIGS. 10A-10B depends on the solubility of the counter-cation's halide, halate, and buffer salts such as hydrogen phosphate, dihydrogen phosphate, etc., since circulating a small volume of a liquid and minimizing the energy and capital expenses of water removal in making a concentrated aqueous multi-electron oxidant (AMO) solution is required. These considerations are relaxed in the case of an off-board regeneration system 106 as compared to an on-board regeneration system 106 exemplarily illustrated in FIG. 1. Lithium bromide (160 g/100 g of water at 20° C.) and bromate (179 g/100 g of water at 20° C.) have high solubility but lithium hydroxide does not (12.8 g/100 g of water at 20° C.). However, Li₂HPO₄ can be used in place of LiOH providing an additional advantage of pH buffering capacity. Li salts with a suspension of hydroxide or with addition of a complexing agent such as 15-crown-5 (15C5), benzo-15-crown-5 (B15C5), dicyclohexano-18-crown-6 (DC18C6), 18-crown-6 (18C6), 12-crown-4 (12C4), dibenzo-18-crown-6 (DB18C6), and their more water-soluble derivatives may also be used. For K⁺, bromate solubility is low, for example, about 6.91 g/100 g of water at about 20° C. Na⁺ salts have intermediate solubilities, for example, of about 36.4 g/100 g for bromate, and about 90.5 g/100 mL from bromide water at about 20° C. The M does not have to be a monovalent cation. For example, magnesium bromate has a very high solubility (70 g/100 g of water at 0° C., 150 g/100 g of water at 60° C.). Calcium bromate has also a good solubility (55 g/100 g of water at 40° C.) that shows only a weak dependence on temperature. Also, Good's buffers have high solubility often above 2M.

FIGS. 11A-11B exemplary illustrate a cyclic operation of an electrolysis-disproportionation (ED) reactor 107 with bromic acid as an aqueous multi-electron oxidant (AMO) and lithium hydrogen phosphate as a base form of a buffer. FIGS. 11A-11B exemplarily illustrate a method for regenerating bromic acid and hydrogen from discharged hydrogen bromide in the cyclic mode with a flow-through ED reactor. The balance of water dragged with ions is not shown. A buffer can be used instead of the hydroxide or in addition to the hydroxide. This approach allows for minimizing the spatial and temporal variations of pH outside of the range between 7 and 9. For example, a solution comprising Li⁺ cation and any of the forms of deprotonated phosphoric acid can be used as a buffer. FIGS. 11A-11B exemplarily illustrate a method to execute the electrolysis-disproportionation (ED) regeneration step based on a cyclic operation of the discharge unit 104 with a cation exchange membrane or in a row of, for example, 6 cells connected in series and a lithium phosphate buffer as an example. For purposes of illustration, the detailed description refers to the bromate chemistry, the Li⁺ cation, and a phosphate buffer; however the scope of the method and the system 100 disclosed herein is not limited to the bromate chemistry, the Li⁺ cation, and the phosphate buffer but can be extended to include other aqueous multi-electron oxidants (AMOs), cations, and buffers including Good's buffers.

FIG. 12 exemplarily illustrates calculated and experimentally measured limiting currents on a rotating disk electrode, showing an electroreduction of bromine generated from bromate and bromide in aqueous solutions of bromic acid of various concentrations. The current is due to the reduction of bromine and its value is determined by the rate of the comproportionation of bromate with electrogenerated bromide near the electrode surface. A direct electrochemical reduction of bromate at room temperature occurs with a significant overvoltage on all electrode materials, and a bromate reduction on an electrode can be facilitated via a homogeneous comproportionation with bromide into highly electrochemically active bromine:

In the catholyte: 5HBr+HBrO₃=3H₂O+3Br₂ (18)

On the cathode: Br₂+6e⁻=6Br⁻ (19)

The comproportionation reaction (18) is known to be first order in [BrO₃⁻] and [Br⁻] and second order in [H⁺] at pH below 2. An additional term with a second order in bromide is apparent at high bromide concentrations. The actual mechanism involves several serial and parallel steps that show general acid catalysis effects, and the mechanism is similar to the homologous chlorine and iodine processes. Chloride accelerates reaction (18). The effect of the addition of chlorine species on both the discharge and regeneration processes is also disclosed herein since chloride increases the energy and power densities of the system 100 with Br₂ as the intermediate oxidant due to a complex interplay between the aqueous chemistries of the two halogens. The electroreduction of Br₂ as per equation (19) is a first order process with a high exchange current even on carbon electrodes which are used in Zn—Br₂ and NaSₓ—Br₂ batteries.

The calculated dependence of the limiting current on the rotation rate in a 0.1M aqueous multi-electron oxidant (AMO) solution is represented in FIG. 12 as a solid line, the experimental data on a glassy carbon rotating disk electrode for the main wave in approximately 20% AMO solution is represented as a dotted line, and the prewave in approximately 50% AMO solution is represented as a dashed line. Currents over 0.5 A/cm² are obtained on a smooth carbon electrode. The limiting current shows a decrease with the rotation rate due to the loss of the intermediate bromine into the solution, when the thickness of the diffusion boundary layer is smaller than the thickness of the kinetic boundary layer. The dependence of the limiting current on a log of the rotation rate in a 0.1M HBrO₃ solution is also exemplarily illustrated in FIG. 12.

While the theoretical energy density of the H₂/HBrO₃ system 100 is, for example, about 1,951 Wh/kg, the limited stability of bromic acid solution with the concentration above 55% w/w, makes 938 Wh/kg, that is, 3.25 times higher than the theoretical value for the lithium iron phosphate (LFP) chemistry, a more realistic estimate. Taking into account the 5% w/w H₂ content for high-pressure storage and the flow design, about 426 Wh/kg is obtained as a realistic target value at the system level, which is 6 times more than the corresponding number for the LFP battery pack, for example, in Tesla Roadster® of Tesla Motors, Inc.

FIG. 13 exemplary illustrates a graphical representation of a power-voltage curve calculated for a H₂-50% w/w HBrO₃ discharge unit 104 and measured with a glassy carbon rotating disk electrode, with a platinum gauze electrode and a corresponding curve for a commercial proton exchange membrane fuel cell running on hydrogen and air. The reduction of bromate on the positive electrode is modeled for one dimensional (1D) diffusion normal to the electrode and for constant thicknesses of the kinetic and hydrodynamic boundary layers. As used herein, the term “diffusion” refers to mass transport due to a concentration gradient.

In FIG. 13, which exemplary illustrates the calculated power versus voltage plots for a hydrogen-bromate discharge unit 104, the term “Z₀” refers to the ratio of the hydrodynamic boundary layer thickness to the kinetic boundary layer thickness and under the conditions of the experiment, the latter is equal to approximately 1.5 μm. The term “C₀” exemplarily illustrated in FIG. 13 refers to the bulk concentration of free intermediate oxidant such as bromine. A typical curve for a H₂-air polymer electrolyte membrane fuel cell (PEMFC) is also shown in FIG. 13 for comparison. The membrane resistance for the solid line is equal to 0.1 Ohm/cm² and the membrane resistance for the dotted line is equal to 0.25 Ohm/cm². The lines with circles represent experimental data in 50% HBrO₃ aqueous multi-electron oxidant (AMO) solution. The solid lines and the dashed lines represent experimental data with the glassy carbon rotating disk electrode (GCRDE) at different rotation rates, and the dashed-double dotted line represents experimental data in a proton exchange membrane (PEM) type flow cell, for example, a Fuel Cell Store™ #1071025 with Pt gauze electrodes on both sides, powered by H₂ and 50% HBrO₃

The experimental data of FIG. 13 with glassy carbon (GC) electrodes in an aqueous solution of HBrO₃ shows three regions in the power-voltage curve—a cathodic pre-wave at +1.15 V versus a standard hydrogen electrode (SHE) with a 42 mV/decade Tafel slope, a main cathodic wave at +0.7 V versus SHE with a 208 mV/decade Tafel slope, and an anodic wave. Both cathodic waves show a decrease in the limiting current at higher rotation rates as i˜1/w and at lower aqueous multi-electron oxidant (AMO) concentrations as i˜C_{AMO}³. The more positive wave on GC is attributed to the predicted reduction of the intermediate Br₂ since the positive wave on GC occurs at the appropriate potential and has a low Tafel slope, close to 60 mV/dec that is usually observed, whereas the low potential wave is likely due to an intermediate with a lower exchange current such as BrO⁻ or BrO₂⁻, formed during the comproportionation before Br₂. The small but unambiguous anodic wave positive to E° (Br₂/2Br⁻) with a very high formal Tafel slope of 332 mV/dec is likely due to the oxidation of bromide which is slowly formed via the reversible disproportionation of bromine present in equilibrium with HBrO₃. A discharge power of 5 mW/cm² at 70% efficiency with respect to E° of BrO₃⁻/Br⁻ is achieved with a smooth carbon electrode and dilute 20% AMO.

The 1 W/cm² target can be achieved by using a high area porous electrode, increasing the concentration of the aqueous multi-electron oxidant (AMO) and by adding additional proton donors such as phosphoric acid, to the AMO stock. Unlike the case of the glassy carbon rotating disk electrode (GCRDE), the onset of bromate reduction on Pt, exemplarily illustrated in FIG. 12, occurs at 1.42 V versus reversible hydrogen electrode (RHE) at pH˜0, which is more positive than the E° (Br₂/Br⁻)=1.066 V. This is attributed to the direct reduction of bromate on Pt in acid. Despite the possibility of having a higher efficiency discharge unit 104 exemplarily illustrated in FIG. 1, the preliminary economic analysis suggests against the use of Pt 0.2 mg/cm² in the cathode of the discharge unit 104, in automotive applications due to an increased upfront cost which will not amortize over 3 years, which is the projected Pt cathode durability, by the lower operational cost and energy efficiency. A Pt or another catalyst can be used on the positive electrode 205a exemplarily illustrated in FIG. 2 in other high-end applications such as in military applications and aerospace applications. Oxide catalysts such as RuO₂ and its derivates are suitable for the use on the positive electrode 205a of the discharge unit 104.

### Example 1

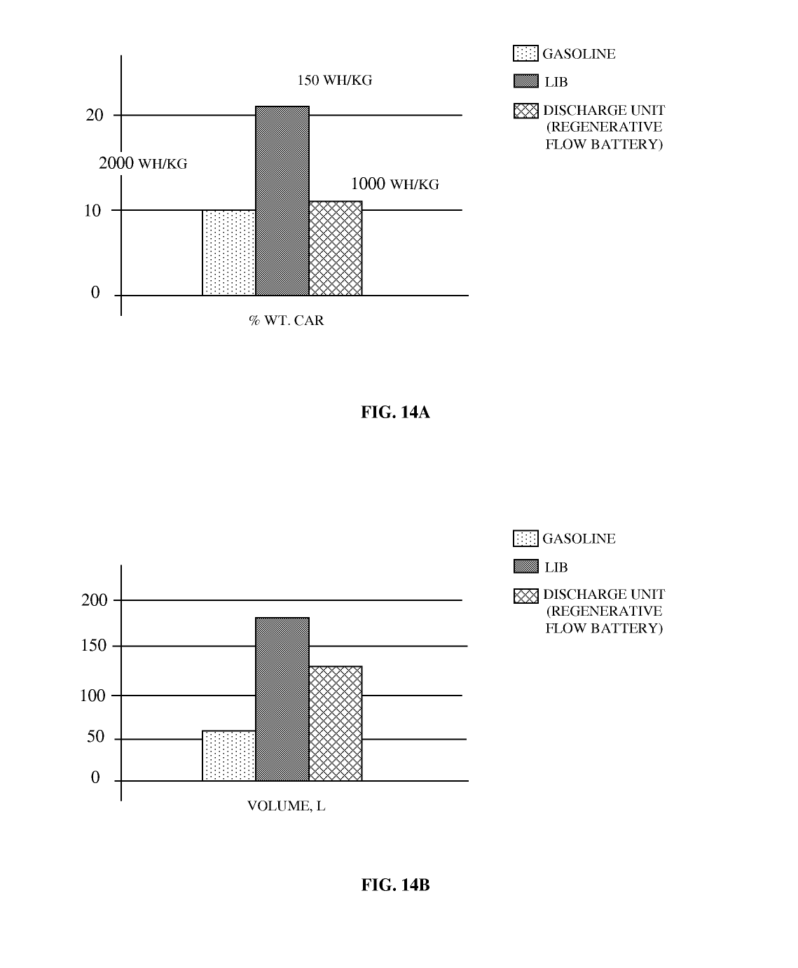

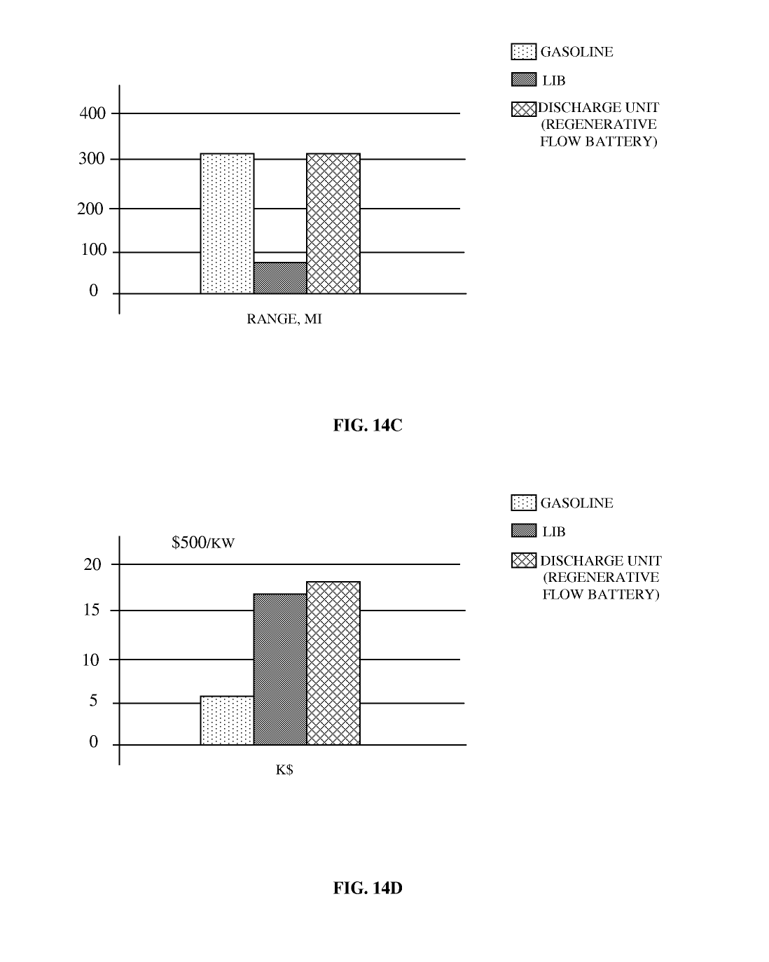

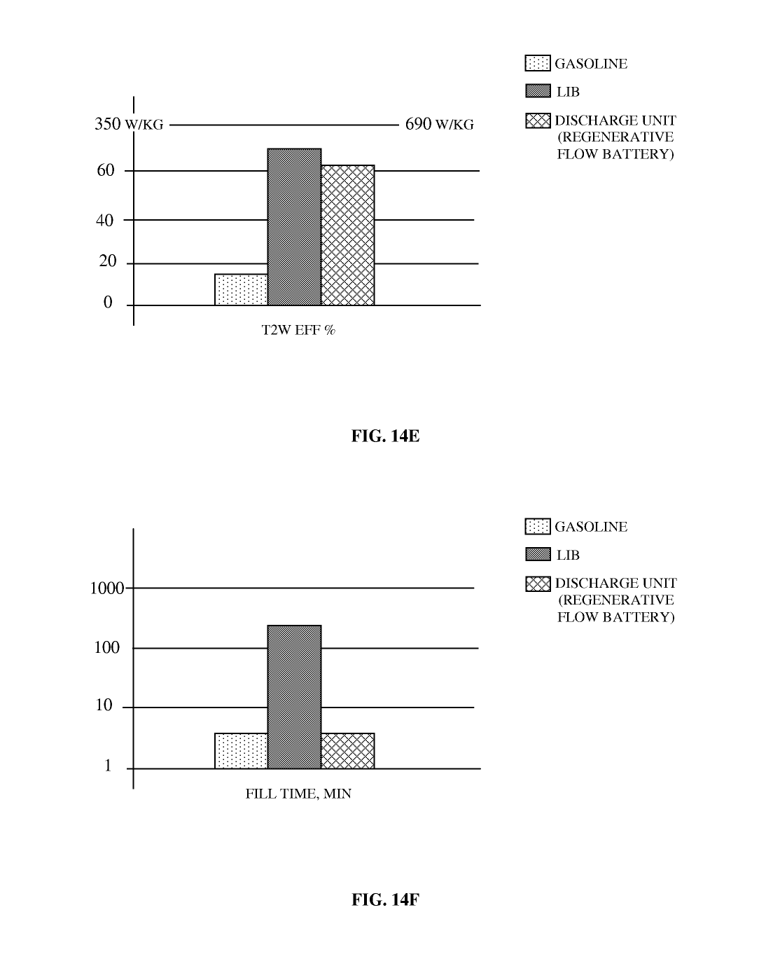

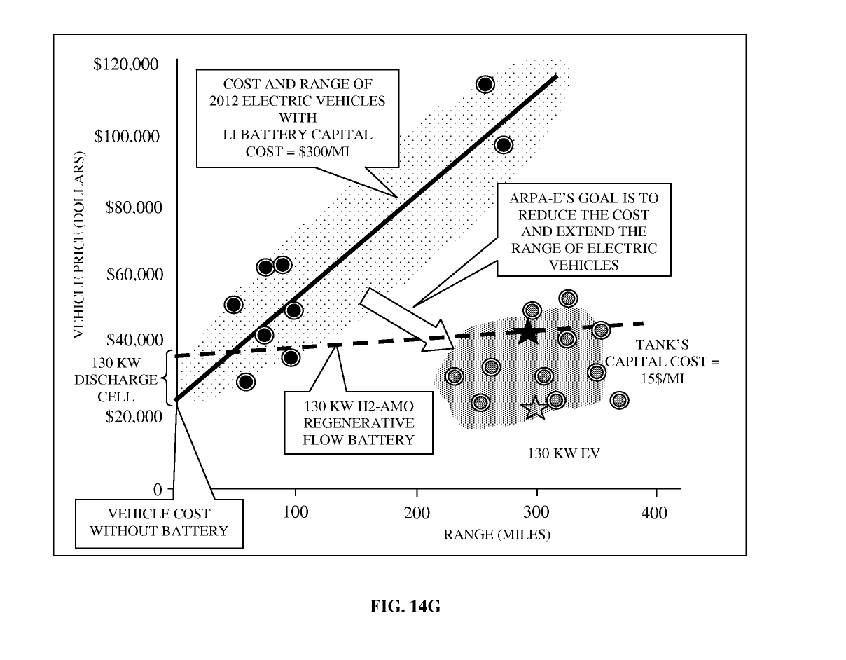

FIGS. 14A-14G exemplarily illustrate graphical representations showing a comparison of three on-board power sources at a nominal power of 130 kW: a gasoline-internal combustion engine, a lithium ion battery (LIB), and an H₂-aqueous multi-electron oxidant (AMO) discharge unit 104 or flow battery exemplarily illustrated in FIG. 1, as well as the Advanced Research Projects Agency-Energy (ARPA-E) targets. The AMO is 50% w/w aqueous HBrO₃. The Toyota RAV4® EV of Toyota Jidosha Kabushiki Kaisha TA Toyota Motor Corporation is chosen as an example of a sport utility vehicle to illustrate the capabilities of the discharge unit 104. A sport utility vehicle (SUV) is selected because it is a large vehicle that presents a greater challenge for electrification than a small urban vehicle. The data are available for Toyota RAV4® in both gasoline and electric vehicle lithium ion battery (LIB) versions. All calculations are based on the rated power of about 130 kW=174 hp. The size of the storage unit in the vehicle using the discharge unit 104 of the discharge system 101 exemplarily illustrated in FIG. 1, is adjusted to give the same driving range as the gasoline power system, rather than the electric version. H₂ is stored in the vehicle using the discharge system 101 as a metal hydride to minimize the H₂ tank volume.

In the vehicle using the discharge system 101 disclosed herein, both the reagent, for example, bromate and the product such as bromide of the discharge are anions, which minimize their cross-over through a cation-exchange membrane such as Nafion® and other poly perfluorosulfonic acid (pPFSA) membranes and prevent a parasitic internal discharge. Also, the electrode reaction of bromine/bromide does not require an expensive catalyst and the electrode reaction occurs with an acceptable rate even on carbon electrodes. It is also estimated that the capital cost of the discharge unit 104 can be as low as 120 $/kW which is less than a half of the lithium-ion battery cost in the Nissan Leaf® of Nissan Jidosha Kabushiki Kaisha DBA Nissan Motor Co. Ltd., and the Toyota RAV4®. The lithium ion battery (LIB) takes up about 20% of the vehicle weight while the discharge unit 104, also referred to as a “regenerative flow battery”, takes about 10% of the vehicle weight, similar to, for example, the internal combustion engine (ICE)-gas system as exemplarily illustrated in FIG. 14A. In the Advanced Research Projects Agency-Energy (ARPA-E) metrics, the energy density of the on-board discharge unit 104 is, for example, about 500 Wh/kg, which is about 3.3 times larger than the ARPA-E target of 150 Wh/kg.

The volume of the discharge unit 104 is, for example, twice the volume of the gas tank including the internal combustion engine (ICE) and half of the lithium-ion battery (LIB) and the electric engine as exemplarily illustrated in FIG. 14B. The energy density of the discharge unit 104 is, for example, 900 Wh/L, which is 4 times larger than the Advanced Research Projects Agency-Energy (ARPA-E) target of 230 Wh/L. Both the gasoline power system and the discharge unit 104 can provide a driving range of about 300 miles as exemplarily illustrated in FIG. 14C, while Toyota RAV4 EV has only 92 miles, according to the environment protection authority (EPA) criteria, which comes from its energy of about 41.8 kWh. The manufacturing cost of the discharge unit 104 is about $15,000 based on the current prices proton exchange membrane fuel cells (PEMFCs) produced in low volumes, or about 140$/kWh as exemplarily illustrated in FIG. 14D, and is more than the manufacturing cost for the ICE, which is about $5,000, but is close to the Advanced Research Projects Agency-Energy (ARPA-E) target of <140/kWh, and is three times lower than the cost per mile drive of the LIB system. The projected tank- to-wheel efficiency of the discharge unit 104 under realistic operating conditions is slightly lower than that of lithium ion batteries (LIBs) but much higher than that of internal combustion engines (ICEs) as exemplarily illustrated in FIG. 14E. Both the gasoline power system and the discharge unit 104 can be refilled mechanically within minutes, while Toyota RAV4® EV needs about 5 hours for electric recharge as exemplarily illustrated in FIG. 14F. The standard discharge efficiency of the discharge unit 104 is about 78% and such efficiency can be a practical target at about 0.5 W/cm². For the power of about 1 W/cm², the finite rate of the comproportionation and the non-negligible membrane resistance make 65% a more realistic target.

Platinum on the H₂ electrode is used at the same loading as the PEMFC but the loading is between 1/10 and 1/20 of what is used on the air electrode in the PEMFCs, and the loading has been shown to be sustainable economically, and is not a large contributor to the cost. FIG. 14G exemplarily illustrates the projected competitive positions of the H₂-aqueous multi-electron oxidant (AMO) discharge unit 104 on the Advanced Research Projects Agency-Energy (ARPA-E) price-range plot for different vehicle power sources. The discharge unit 104 disclosed herein can meet the range, cost, cost and safety targets for fully electric vehicles (FEVs) defined by the ARPA-E's Robust Affordable Next Generation Electric Vehicle (RANGE) program as exemplarily illustrated in FIG. 14G.

### Example 2

The comparison of a gasoline engine, a lithium ion battery, and two hydrogen-bromate batteries with different methods of hydrogen storage, that is, 700 bar compressed and 9% w/w metal hydride is provided in the table below.

| | | H₂ storage | | | 50% AMO | |
|---|---|---|---|---|---|---|
| | | 350 bar | liquid | 5% MH | 5.74M | |
| theoretical limit | g/L | 25 | 70 | 125 | 1.48 | sol. |
| | | | | | | Density |
| 100 kg, 300 kW real | g/L | 10 | 26 | 20 | | |
| systems | | | | | | |
| theoretical limit | Ah/L | 670 | 1,875 | 3,350 | 923 | solution |
| charge per mass of | Ah/kg | 26,800 | 26,786 | 26800 | 623.7 | solution |
| pure H₂ | | | | | | |
| real system | w % | 5 | 5 | 5 | | |
| real system | Ah/kg | 1,340 | 1,340 | 1,340 | 623.7 | |
| real system | Ah/L | 268 | 697 | 536 | 923 | AMO |
| | | | | | | sol. |
| vol. % for storage | H2 | 77.45 | 57.0 | 63.3 | | |
| system | | | | | | |
| wt. % for storage | H2 | 2.277 | 2.28 | 2.27 | | |
| system | | | | | | |
| volume/charge | mL/Ah | 3.73 | 1.44 | 1.87 | 1.08 | |
| mass/charge | g/Ah | 0.0373 | 0.0373 | 0.0373 | 1.60 | |
| 4 h drive RAV4 = 520 kWh | kg | 388 | 388 | 388 | 834 | 2.356 |
| 4 h drive RAV4 = 520 kWh | L | 1,940 | 746 | 970 | 563 | |
| system energy density | Wh/L | 208 | 397 | 339 | | |
| specific energy | Wh/kg | 426 | 426 | 426 | | |
| 5% w/w H₂ | | | | | | |

The parameters used for lithium ion batteries (LIBs) are 230 Wh/L, 128 Wh/kg, and $0.47/Wh. The parameters used for H₂ storage are 50 g/L compressed 125 g/L MH. The HBrO₃ solution density is assumed as 1.49 g/cm3, the same as for 48% w/w aqueous HBr. The cost of 50% HBr=$2000/ton=$2/kg.

### Example 3

Reactions of a bromine electrode discharge using a vanadium redox mediator in the first step and an electrode reaction in the second step are provided below:

HBrO₃+5V⁺³+5H⁺=½Br₂+5V⁺⁴+3H₂O;

5V⁺⁴+1e−=5V⁺³;

½Br₂+1e⁻=Br⁻.

### Example 4

A bromine/bromide couple is used as a mediator for a bromate reduction “r” on discharge as shown below:

HBrO₃+5Br⁻+5H⁺=3Br₂+3H₂O; in solution;

3Br₂+6e⁻=6Br⁻; on the electrode.

### Example 5

A chlorine/chloride couple is used as the mediator for bromide/bromate on charge as shown below:

Cl⁻−1e⁻=½Cl₂; on the electrode;

½Br₂+2.5Cl₂+3H₂O=HBrO₃+5HCl in solution.

### Example 6

The conversion of hydrobromic acid to bromic acid using a resin-type ion exchange reactor is shown below, where M refers to a cation such as an alkali or an alkali earth metal cation, and “solid” refers to an ion exchanging material such as a resin:

M⁺(solid)+HBr(spent)=H⁺(solid)+MBr resin regeneration

MBr+6MOH−6e⁻=MBrO₃+3H₂O+6M⁺ positive electrode

3H₂O+6e⁻+6M⁺=3H₂+6MOH negative electrode

MBrO₃+H⁺(solid)=HBrO₃+M⁺(solid) ion exchange on the resin

The above approach for regenerating the aqueous multi-electron oxidant from the spent discharge fluid may result in the incomplete exchange of M+ for H+ under stoichiometric conditions, which results in an overuse of the acid regenerant and of the energy needed to produce the acid regenerant.

### Example 7

H₂-aqueous multi-electron oxidant (AMO) discharge redox flow battery: In an embodiment, in H₂—HBrO₃ discharge flow batteries, modified single and multiple stack type proton exchange membrane fuel cells (PEMFCs) are employed. The electrolyte-electrode assemblies are fabricated using a polyperfluorosulfonic acid (pPFSA) membrane, with a conventional negative electrode layer 205b exemplarily illustrated in FIG. 2, comprising Pt, C, and pPFSA, and a conventional gas diffusion layer (GDL) used for H₂ oxidation on the negative anode side. The positive cathode design, however, is different from the proton exchange membrane (PEM) air cathode, since neither bromate nor bromide are soluble in the pPFSA, which completely surrounds the Pt/C electrocatalyst in modern thin-film PEMFC catalytic layers. A porous flow-through or flow-by media, for example, porous carbon or carbon cloth, is used for the positive electrode 205a in a H₂—HBrO₃ discharge flow battery.

Under realistic operating conditions, a slower yet above stoichiometric flow rate leads to a higher cell power in contrast with fuel cells and conventional redox flow batteries. This is due to a larger fraction of bromine escaping the kinetic boundary into the solution bulk as the diffusion boundary layer gets thinner. This suggests that the cell operation at high power does not require significant energy expenses on pumping and that, in contrast to fuel cells, a near stoichiometric supply of the aqueous multi-electron oxidant may provide an optimal performance in terms of the power, energy efficiency, and system size. Also, a quick depletion of bromate in the ignition regime and the higher viscosity of the aqueous multi-electron oxidant (AMO) compared to air implies a preference for short channels, which, in combination with a parallel-channel flow field and slow flow rates, also leads to a lower pressure drop. Also, the absence of the gas phase in the cathode stream, the large heat capacity, and the high water content of the AMO supply simplify the design, manufacture, and operation of the cathode side as well as of the whole discharge unit 104 and the discharge system 101.

### Example 8

Power and efficiency of the hydrogen-bromate discharge unit 104: In order to estimate the power and voltage of the hydrogen-bromate discharge unit 104 during the discharge, the following model is used: The discharge unit 104 comprises a single electrolyte-electrode assembly 205 exemplarily illustrated in FIG. 2. Pure humidified hydrogen is supplied to the anode. The anode polarization losses and reagent cross-over are ignored. The cell or membrane ohmic resistance is set to 0.25 Ohm/cm². The cathode is smooth and is supplied with 50% w/w/HBrO₃ containing a few mM of Br₂, Co=[Br₂]ₒ, to initiate the electroreduction cycle. Electrochemical polarization of the cathode is ignored, that is, bromine/bromide exchange current is large compared to the applied currents.

The homogeneous kinetics of the comproportionation is incorporated through the use of kinetic boundary layer thickness, L₀=(D_{bromide}/5 k_{con} C_{bromate})^{1/2}=1.5 μm, where k_{con} is the appropriate rate constant for the homogeneous comproportionation. At currents above 1 A/cm², further correction becomes important, i.e. L=Lo/(1−(izₒ/5D_{bromate}C_{bromate}))^{1/2}. The effect of convection is incorporated through the use of the diffusion boundary layer thickness, zₒ Zₒ=zₒ/L. Its value is selected on the basis of common values of the respective quantities for the rotating disk and channel electrodes in aqueous electrolytes, that is, 15 μm and 150 μm. Diffusion coefficients for bromide and bromine are set to 1.5×10⁻⁵ cm²/s and 1.0×10⁻⁵ cm²/s, respectively. Activity coefficients of all species are set to 1.

A more detailed analysis leads to the following formula for the polarization curve for bromate comproportionation-electroreduction on a smooth electrode:

Exp{2(E−E°)F/RT}={[Br₂]ₒ+(iL/FD_{bromine})(0.1Zₒ−0.6thZₒ)}(FD_{bromide}/iLthZₒ)²

The corresponding plots for power are exemplarily illustrated in FIG. 13. The hydrogen-bromate discharge unit 104 can achieve under very realistic conditions, even with a smooth carbon electrode, a power, for example, of about 0.005 W/cm² at around 1.0 V, which corresponds to the energy efficiency, for example, of about 68% with respect to the standard electrode potential bromate/bromide, that is, about 1.48 V for a 0.1 Ohm/W/cm² membrane resistance. Such performance compares favorably with the performance of state-of-the-art hydrogen-air fuel cell, yet it can be achieved with about a 10 times smaller Pt loading and with electric regeneration of the reducer and the aqueous multi-electron oxidant. Under realistic operating conditions, the concentration of free bromine has little effect on the cell performance, whereas a stronger convection decreases the cell power in contrast with conventional fuel cells. This is due to a faster escape of intermediate Br₂, homogeneously produced in the vicinity of the electrode, into the bulk of the solution at smaller hydrodynamic boundary layer thicknesses. Such an effect is not observed in conventional fuel cells and flow batteries since the electroactive reagent is delivered from the bulk of the solution rather than formed near the electrode. Also, the kinetic layer thickness, which determines the minimal meaningful pore diameter in the porous electrode, is L=1.5 μm in 50% w/w HBrO₃, and a thicker 6L=9 hydrodynamic boundary layer is needed for the ignition to occur.

The 1D model disclosed herein assumes a constant solution composition outside of the hydrodynamic boundary. The model disclosed herein shows that a low near-stoichiometric flow rate would be appropriate for the discharge unit operation with reduced energy losses entailed. The parallel flow field with a channel length longer that the ignition length but shorter than the depletion length with a flow rate slightly above the stoichiometric can provide the maximal power while simultaneously reducing pumping losses.

### Example 9

In the orthogonal ion migration across laminar flow (OIMALF) outlet solution, the aqueous multi-electron oxidant (AMO) such as HBrO₃ is too dilute for direct use in high energy density systems and the AMO needs to be concentrated. Water evaporation, vacuum distillation, pervaporation are suitable means of concentrating the AMO solution. Heat exchangers are used to transfer heat from the concentrated product to dilute input solution if the water removal is performed at an elevated temperature. The energy expenses of concentrating dilute AMO produced in the OIMALF step should be compared with the energy of a H₂-AMO battery. In the case of bromic acid, the stored electric power is:

1,705 Wh/kg*0.135 kg/mol=230 Wh/mol=(1 Wh=3.6kJ)=829 kJ/mol

The evaporation of excess water is also possible, more efficiently with heat exchangers, but it leads to the loss of volatile bromine species. In the case of reverse osmosis (RO) process of concentrating the aqueous multi-electron oxidant (AMO) solution, the osmotic pressure difference between the dilute and concentrated solutions of AMO such as bromic acid can be estimated via the Morse equation. Molality is assumed the same as molarity and dissociation is complete:

Π=iMRT=2*(3.88−0.5)mol/L*10³ L/m³*300K*8.3145 J K⁻¹ mol⁻¹=16.8 MPa=168 bar

This pressure falls within the range of commercial cascade reverse osmosis units, thus, such a process is technically feasible. The minimal energy expense for reverse osmosis (RO) concentrating can be estimated as 1.742 kg of water per 1 mole of HBrO₃ needs to be removed. This corresponds to 1.742 10⁻³ m³*16.8 10⁶ Pa=2.93 104 J=29.3 kJ/mol HBrO₃. This is only 3.3% of the battery energy per 1 mole of bromic acid. This number is the lower limit at the infinitely slow rate of water permeation and the number will be higher in practice. For example, sea water desalination requires usually 5 times more energy than the theoretical value. Using the factor of 5, about 16.5% battery energy is obtained which is acceptable in practice.

### Example 10

The molal solubilities, that is, moles of solute per kg of water of some compounds of interest in the electrolysis-disproportionation (ED)-orthogonal ion migration across laminar flow (OIMALF) process at 20° C. and 60° C. are provided in the table below:

| | moles of solute per kg of solvent | | | | | |
|---|---|---|---|---|---|---|
| | bromide | bromide | bromate | bromate | Hydroxide | Hydroxide |
| cation | 20° C. | 60 C.° | 20° C. | 60° C. | 20° C. | 60° C. |
| Li⁺ | 1.84 | 2.57 | 1.33 | 1.99 | 0.53 | 0.58 |
| Na⁺ | 0.88 | 1.15 | 0.24 | 0.41 | 2.73 | 4.35 |
| K⁺ | 0.55 | 0.72 | 0.04 | 0.14 | 2.00 | 2.74 |
| NMe₄⁺ | 7.79E−04 | n/a | n/a | n/a | Mp 67 C., 50% = 5H₂O | |
| Ba²⁺ | 0.37 | 0.41 | 1.65E−03 | 5.77E−03 | 2.27E−02 | 0.12 |
| Sr²⁺ | 0.41 | 0.61 | 0.09 | 0.105 | 1.46E−02 | 0.07 |
| Ca²⁺ | 0.72 | 1.39 | 0.777 | n/a | 2.33E−03 | n/a |
| Mg²⁺ | 0.55 | 0.61 | 0.207 | n/a | 1.71E−04 | n/a |

The data in the table above suggests that Li cation provides a high molal solubility for bromide and bromate. The limited solubility of LiOH is irrelevant since it does not appear in the laminar flow of the orthogonal ion migration across laminar flow (OIMALF) reactor where solids can disrupt the process. Also, if a buffer such as hydrogen phosphate-dihydrogen phosphate is used, LiOH will react with the buffer.

### Example 11

In an embodiment, in the case of a redox couple with both components being anions, for example, oxohalate and halide, the cross-over of the oxidant couple to the negative electrode 205b exemplarily illustrated in FIG. 2, can be lowered with a cation exchange membrane. In the case of bromic acid, the discharge process on the negative electrode 205b is as shown below:

Br₂+2e⁻+2H⁺=2HBr on the electrode.

HBrO₃+5HBr=Br₂+3H₂O in solution;

The concentration of the neutral intermediate Br₂ is maintained sufficiently low, so that its cross-over to the negative electrode 205b makes a negligible contribution compared to the current of the electrolytic cell 200. The ratio of the standard redox potentials of bromate/bromide and bromine/bromide predicts, for example, only about 25% loss of efficiency when performing comproportionation mediated rather than direct discharge of bromic acid at the equilibrium potential. The regeneration of HBrO₃ and H₂ from HBr or, in general, an oxoacid from halide can be performed off-board. Direct electrolytic regeneration can be performed on an anode such as PbO₂ or a dimensionally stable anode (DSA) in an acidic medium.

In an embodiment, a solution-phase mediator, for example, a redox couple is used to expedite the rates of an otherwise slow electrode reaction and thus to increase the system power and efficiency. A redox couple that undergoes electron exchange with both an electrode and a reduced or an oxidized form of the aqueous multi-electron oxidant can be used to accelerate the rates of charge or discharge, thereby improving efficiency. Different redox mediators can be employed in the charge and discharge processes. In an embodiment, Cl₂/2Cl— can be used as a solution-phase mediator in the electrochemical regeneration process. Since oxidations, for example, electro-oxidation of a halide to a halate, are more facile in alkaline solutions, performing regeneration at high pH and then converting the salt into acid, for example, by means of the orthogonal ion migration across laminar flow (OIMALF) process are considered.

In an embodiment, pH-dependent disproportionation and pH-dependent comproportionation reactions involving halogens and their compounds are used to facilitate the regeneration of the aqueous multi-electron oxidants. The rate(s) and the equilibrium constant(s) of the disproportionation reaction(s) in some cases may show a dependence of the solution pH. The rate(s) and the equilibrium constant(s) of the comproportionation reaction(s) in some cases may show dependence of the solution pH.

In an embodiment, the aqueous multi-electron oxidant (AMO) can be regenerated by reacting the halide with ozone or by photolytic oxidation on a suitable semiconductor such as TiO₂. In another embodiment, a mediator is used for oxidation at the positive electrode during regeneration. The requirements for a suitable mediator in the halide oxidation are a standard redox potential of about 0.1V-0.4V more positive that the standard redox potential of the halate, the electrode reaction of the mediator having a high exchange current, the homogeneous reaction between the mediator and the halate being fast, the mediator couple not involving cationic species capable of crossing the membrane, etc. Chlorine is, for example, a mediator for iodate or iodide at all pH levels but chlorine evolution requires an electrocatalyst, for example, dimensionally stable anode (DSA) for the chloride oxidation which may be expensive. Chlorine is a mediator for bromide oxidation into bromate only in neural and alkaline media.

Ozone is a suitable mediator for oxidation or a charge reaction, though with less than 50% energy efficiency for oxidizing halides into halates and perhalates or corresponding acids. This regeneration process can be performed in acidic media by electrolysis using a proton exchange membrane (PEM) electrolyzer or a similar device. The co-evolved H₂ can be used later as a reducer in the discharge unit 104 exemplarily illustrated in FIG. 1, while the ozone reacts with the spent hydrogen halide in a separate vessel to yield the halic acid oxidant. In an embodiment, the ozone for regeneration can be produced by a gas discharge according to commercialized methods. Other suitable mediators comprise, for example, transition metal ion and their compounds such as negatively charged polyoxometallates to prevent their cross-over through the cation exchange membrane. In an embodiment, a direct electrolytic oxidation of halides, for example, bromide to bromate is performed, for example, with a PbO₂, RuO₂, dimensionally stable anode (DSA) or a conductive diamond electrode.

### Example 12

In an embodiment, the discharge unit 104 is a modified version of a polymer electrolyte fuel cell. A membrane electrode assembly (MEA) uncoated on the positive side is used in the discharge unit 104. The gas diffusion layer on the positive side is replaced with a hydrophilic porous carbon cloth. The flow field on the positive side of a carbon bipolar plate 202 exemplarily illustrated in FIG. 2, is of a parallel-channels type. In another embodiment, the discharge unit 104 is equipped with an MEA coated with a Pt-free or Pt-nanoparticles-modified carbon fiber layer replacing a catalyst layer in the conventional polymer electrolyte membrane fuel cell (PEMFC), thereby reducing the ohmic resistance between the points where the bromate reduction occurs and the hydrogen electrode. A grid with interdigitated millimeter deep channels in one direction and with thinner channels in the perpendicular direction can be used for the positive electrode flow field.

In another embodiment, for the positive electrode 205a exemplarily illustrated in FIG. 2, a hydrophilic porous electrode (HPE) replacing the non-porous thin-film cathodic layer in the conventional 5-layer proton exchange membrane (PEM)-membrane electrode assembly (MEA) design with or without a carbon-ionomer layer (CIL) coating on the cathode side of the membrane is designed. Such an HPE can either be used as a flow-through with an inter-digitated or with a flow-by or parallel channel flow field. A pore diameter above 12 L that is 18 μm is beneficial, and the layer thickness or pore length does not need to be much larger. A suitable channel width can be larger than the inter-channel spacing, and a parallel channel flow field with relatively short channels is longer than the ignition length, and shorter than the depletion length with a low pressure drop and a near stoichiometric flow rate.

Suitable carbonaceous materials for the porous electrode are available commercially. One suitable carbon cloth is, for example, pyrolysed PAN AvCarb 1071 HCB 80045-001 with about 350 μm thickness, about 7.5 μm fiber diameter, about 19.3/cm warp, about 18.5/cm weft, and about 10⁻³ ohm·cm conductivity. A thinner unidirectional carbon fabric, for example, about 152 μm thickness is available from Fibre Glast Developments Corporation. Some suitable carbon cloth are, for example, potential hydrophilic carbon cloth with approximately 18 μm diameter for the hydrophilic porous electrode (HPE), commercial carbon cloth as thin as 700 μm, cloth made of electrospun carbon fibers as thin as 20 nm, Zoflex® of Xilor, Inc., weaved carbon down to 400 um, etc. Surface modification such as sulfonation of carbon can be used to improve the hydrophilicity.

A conventional bipolar stack polymer electrolyte membrane fuel cell (PEMFC) with a hydrophilic porous layer on the membrane electrode assembly (MEA) cathode is used. Since the aqueous multi-electron oxidant (AMO), in contrast to air, is ionically conducting, shunt currents in a bipolar stack have to be considered. Methods for minimizing shunt currents are known and include: increasing ionic resistance between the electrolytic cells 200 in a stack 300 exemplarily illustrated in FIGS. 2-3, for example, by increasing the length and decreasing the width of the flow channels 202a connecting the electrolytic cells 200, reducing the number of single electrolytic cells 200 in series, decreasing the resistances of manifold and channel and increasing the power of single electrolytic cell 200, placing shunt resistors in the electrolyte paths, and any combination thereof. The operating temperature of the discharge unit 104 is between 0° C. and 100° C., preferably between 10° C. and 60° C.

### Example 13

A steady-state one-dimensional model was developed for a comproportionation-mediated discharge of bromate with a Nernstian hydrodynamic boundary layer of a fixed thickness. Such a model is an adequate first-order approximation for the discharge at the rotating disk and at channel flow electrodes. For a sufficiently high rate of the comproportionation reaction ensured by high concentrations of bromate and protons in bulk solution, there are three different regimes determined by the ratio diffusion to kinetic boundary layer thicknesses as exemplarily illustrated in FIG. 13. The latter decreases as the disproportionation rate gets larger, for example, at lower pH and higher bulk AMO concentration and it is equal to 1.5 μm in 50% w/w HBrO₃.

Lo=(D_{bromide}/5 k_{con}C_{bromate})^{1/2}=1.5 μm (20)

When the diffusion boundary layer is thin compared to the kinetic boundary layer, that is, at high flow or stiffing rates, the intermediate bromide formed via electroreduction of the initial bromine escapes the hydrodynamic boundary layer before the intermediate bromide comproportionates with bromate to form more bromine near the electrode. In this pre-ignition regime, the limiting current is the same as it would be in a solution with only bromine and no bromate present. When the diffusion boundary layer is thick compared to the kinetic boundary layer, that is, at low flow and/or rotation rates, the intermediate bromide has enough time to react with bromate near the electrode producing more bromine as exemplarily illustrated in FIG. 13, resulting in an ignition regime with the limiting current determined by the mass-transport of bromate rather than of bromine as in the pre-ignition regime.

An additional confirmation of the comproportionation mechanism disclosed herein is obtained through a direct observation of a brown colored bromine in the kinetic layer near the rotating disk electrode (RDE). The brown cloud attached to the electrode is the intermediate bromine formed during the comproportionation of bromate with electro-generated bromide as in equation (18). The current is negative that is cathodic. The visible thickness of the colored layer and the measured current at constant potential decreases with the electrode rotation rate.

In the intermediate regime, the limiting current decreases with flow and/or rotation rate as exemplarily illustrated in FIG. 12, due to the escape of the intermediate bromine. The ignition regime observed at low mass-transport rates is particularly interesting for practical applications as it affords an extraordinary high generated peak electric power even on a smooth carbon electrode, that is, over 0.5 A/cm² and 0.5 W/cm², as exemplarily illustrated in FIG. 13, at low consumed pumping power in contrast to other fuel cells and redox flow batteries. The fast kinetics of the bromine/bromide electrode reaction assures that the energy efficiency of the discharge unit 104 at high power is over 60%.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

I claim:

1. A method for producing electric power from an aqueous multi-electron oxidant and a reducer and for simultaneously generating a discharge fluid, said method comprising:
providing a discharge system comprising a discharge unit, said discharge unit comprising an electrolytic cell stack, said electrolytic cell stack comprising a plurality of electrolytic cells, wherein each of said electrolytic cells comprises a 5-layer electrolyte-electrode assembly; and
facilitating discharge of said discharge unit, comprising:
transferring electrons from a positive electrode of said 5-layer electrolyte-electrode assembly to said aqueous multi-electron oxidant; and
transferring electrons from said reducer to a negative electrode of said 5-layer electrolyte-electrode assembly to produce said electric power in an external electric circuit connected to terminals of said discharge unit and to generate said discharge fluid on consumption of said aqueous multi-electron oxidant and said reducer.

2. The method of claim 1, wherein said aqueous multi-electron oxidant comprises one or more of halogens, halogen oxoacids, water, and an acid form of a buffer.

3. The method of claim 2, wherein said halogens comprise chlorine, bromine, and iodine.

4. The method of claim 2, wherein said halogen oxoacids are one or more compounds having a formula HₚX_{q}Oᵣ, wherein X is one of a plurality of said halogens and 1≦p, q, r≦6.

5. The method of claim 2, wherein said buffer is in said acid form during said discharge with a pH≦7, and wherein said acid form of said buffer is one or more of phosphoric acid, a dihydrogen phosphate of lithium, Good's buffers, and any combination thereof.

6. The method of claim 1, wherein said discharge fluid comprises one or more of water, an acid form of said buffer, a base form of said buffer, a halogen, a hydrogen halide, a halogen oxoacid, and any combination thereof.

7. The method of claim 1, wherein said reducer is hydrogen.

8. The method of claim 1, wherein said 5-layer electrolyte-electrode assembly of said discharge unit comprises:
a positive electrode with a positive diffusion layer, said positive electrode supplied with said aqueous multi-electron oxidant during said discharge;
a negative electrode with a negative diffusion layer, said negative electrode supplied with said reducer during said discharge; and
an electrolyte layer interposed between said positive electrode and said negative electrode.

9. The method of claim 8, wherein said electrolyte layer of said 5-layer electrolyte-electrode assembly is composed of a material capable of ionic conduction but not of electronic conduction.

10. The method of claim 8, wherein said electrolyte layer of said 5-layer electrolyte-electrode assembly is composed of one or more of an ionomer, an ionically conducting liquid retained in pores of a solid matrix, a solid ion conductor, a solid proton conductor, and a liquid under laminar flow.

11. The method of claim 8, wherein said electrolyte layer of said 5-layer electrolyte-electrode assembly is composed of a material with a cationic conduction exceeding an anionic conduction of said material.

12. The method of claim 1, wherein said each of said electrolytic cells of said electrolytic cell stack of said discharge unit is configured to share a bipolar plate with an adjacent one of said electrolytic cells, wherein one side of said bipolar plate is configured to contact a positive side of one of said electrolytic cells and another side of said bipolar plate is configured to contact a negative side of said adjacent one of said electrolytic cells, and wherein said electrolytic cell stack is flanked by endplates.

13. The method of claim 1, further comprising:
facilitating discharge reactions on a positive electrode of said 5-layer electrolyte-electrode assembly of said discharge unit using one of lead oxide, ruthenium dioxide, and a platinoid electrocatalyst; and
facilitating discharge reactions on a negative electrode of said 5-layer electrolyte-electrode assembly of said discharge unit using a platinoid electrocatalyst.

14. The method of claim 1, further comprising facilitating a charge transfer between a positive electrode of said 5-layer electrolyte-electrode assembly and said aqueous multi-electron oxidant using a redox mediator, wherein said redox mediator is a halogen and a halide couple.

15. The method of claim 1, wherein said discharge is facilitated on a positive electrode of said 5-layer electrolyte-electrode assembly by one or more of electrolysis, electrocatalysis, a solution-phase chemical reaction, a solution-phase comproportionation, a solution-phase redox catalysis, an acid-base catalysis, and any combination thereof.

16. The method of claim 1, further comprising accelerating a rate of said discharge via a pH-dependent solution-phase comproportionation of said aqueous multi-electron oxidant with a final product of a reduction of said aqueous multi-electron oxidant.

17. The method of claim 1, further comprising regenerating a certain amount of an intermediate oxidant in said discharge unit from said discharge fluid by reversing a polarity of an electric current flowing through said discharge unit during said discharge.

18. A method for regenerating an aqueous multi-electron oxidant and a reducer in stoichiometric amounts from a discharge fluid using electric power, said method comprising:
neutralizing said discharge fluid with an excess of a base form of a buffer in a neutralization reactor to produce a solution of a salt form of said discharge fluid;
electrolyzing said solution of said salt form of said discharge fluid into an intermediate oxidant at a positive electrode in an electrolysis-disproportionation reactor, wherein said electrolysis releases said reducer and said base form of said buffer at a negative electrode of said electrolysis-disproportionation reactor, while producing a salt form of said aqueous multi-electron oxidant at said positive electrode via disproportionation of said intermediate oxidant evolving at said positive electrode with an excess of said base form of said buffer, and simultaneously releasing a stoichiometric amount of said base form of said buffer for said neutralization; and
converting said salt form of said aqueous multi-electron oxidant produced at said positive electrode into an acid form of said aqueous multi-electron oxidant in an ion exchange reactor.

19. The method of claim 18, further comprising concentrating said acid form of said aqueous multi-electron oxidant in a concentrating reactor to remove water produced on said positive electrode and to remove water introduced with said buffer during said electrolysis and said disproportionation.

20. The method of claim 18, wherein said aqueous multi-electron oxidant is selected from a group consisting of halogens, halogen oxides, halogen oxoacids, and any combination thereof, wherein said halogens comprise chlorine, bromine, and iodine.

21. The method of claim 18, wherein said reducer is hydrogen.

22. The method of claim 18, wherein said discharge fluid comprises one or more of water, an acid form of said buffer, a base form of said buffer, a halogen, a hydrogen halide, a halogen oxoacid, and any combination thereof, wherein said halogen is one of chlorine, bromine, and iodine.

23. The method of claim 18, wherein said conversion of said salt form of said aqueous multi-electron oxidant produced at said positive electrode into said acid form of said aqueous multi-electron oxidant is performed by an electric field driven orthogonal ion migration across laminar flow in said ion exchange reactor.

24. The method of claim 18, wherein said conversion of said salt form of said aqueous multi-electron oxidant produced at said positive electrode into said acid form of said aqueous multi-electron oxidant is accompanied by a conversion of said base form of said buffer into an acid form of said buffer.

25. The method of claim 18, further comprising stabilizing pH of said discharge fluid to an optimal level for said disproportionation using a buffer in said electrolysis-disproportionation reactor.

26. The method of claim 25, wherein said buffer in a base form is selected from a group comprising an alkali metal hydroxide, an alkali metal hydrogen phosphate, an alkali metal salt of one of Good's buffers, phosphoric acid, and any combination thereof.

27. The method of claim 18, wherein said electrolysis-disproportionation reactor is configured to operate in one of a plurality of modes, said modes comprising a batch mode, a single pass mode, and a cyclic mode.

28. The method of claim 18, further comprising regenerating a certain amount of said intermediate oxidant in a discharge unit from said discharge fluid by reversing a polarity of an electric current flowing through said discharge unit during discharge of said discharge unit.
